(19) United States
(12) Patent Application Publication
(10) Pub. No.: US 2024/0074434 A1
(43) Pub. Date: Mar. 7, 2024

(54) COMPOSITION INCLUDING EFFERVESCENT AGENTS, BIOSTIMULANT, NUTRIENT, AND PESTICIDE

(71) Applicants: JEFFREY HANSON ROBBINS, San Diego, CA (US); ARIEL NEHEMIAH TENENBAUM, San Diego, CA (US)

(72) Inventors: JEFFREY HANSON ROBBINS, San Diego, CA (US); ARIEL NEHEMIAH TENENBAUM, San Diego, CA (US)

(21) Appl. No.: 18/383,203

(22) Filed: Oct. 24, 2023

Related U.S. Application Data
(63) Continuation-in-part of application No. 16/382,537, filed on Apr. 12, 2019, now Pat. No. 11,247,944.
Application No. 16/382,537 is a continuation-in-part of application No. 16/382,591, filed on Apr. 12, 2019, now Pat. No. 11,254,619.
Application No. 16/382,591 is a continuation-in-part of application No. 17/552,277, filed on Dec. 15, 2021.
Application No. 17/552,277 is a continuation-in-part of application No. 17/667,880, filed on Feb. 9, 2022.
Application No. 17/667,880 is a continuation-in-part of application No. 18/102,003, filed on Jan. 26, 2023.
Application No. 18/102,003 is a continuation-in-part of application No. 18/377,386, filed on Oct. 6, 2023.

(51) Int. Cl. A01N 25/18; A01N 63/20; A01N 63/22; A01N 63/23; A01N 63/25; A01N 63/27; A01N 63/38; C05B 17/00

(52) U.S. Cl. CPC A01N 25/18; A01N 63/20; A01N 63/22; A01N 63/23; A01N 63/25; A01N 63/27; A01N 63/38; C05B 17/00

(57) ABSTRACT

A composition is disclosed including combining a carbonate or bicarbonate compound, an acid, a biostimulant, a nutrient, and a pesticide. The composition may be processed into a tablet, powder, meal, pellets, or granules and produce effervescence when a liquid, such as water or a water-based liquid is mixed with the composition.

This application is a continuation in part of pending application Ser. No. 18/377,386 filed on Oct. 6, 2023 which is a continuation in part of pending application Ser. No. 18/102,003 filed on Jan. 26, 2023 which is a continuation in part of pending application Ser. No. 17/667,880 filed on Feb. 9, 2022 which is a continuation in part of application Ser. No. 16/382,591 filed on Apr. 12, 2019 issued as patent Ser. No. 11/254,619 and application Ser. No. 16/382,537 filed on Apr. 12, 2019 issued as patent Ser. No. 11/247,944 each of which are hereby incorporated by reference in their entirety.

### BACKGROUND OF THE INVENTION

### 1. Field of the Invention

The present invention relates to effervescent products, and more particularly, to a composition with effervescent agents, a biostimulant, a nutrient, a pesticide, and a method of making the same.

### 2. Background

Numerous fungi, bacteria, and other microorganisms that influence organism growth are known. Fungi may colonize plant roots and aid in the solubilization of macronutrients and micronutrients. More recently, a group of bacteria found in the root zone of plants collectively known as growth promoting rhizobacteria have been shown to improve yield, vigor, and in some cases confer disease resistance in plants. Animal gut microbiota may improve resistance to pathogens, improve metabolism, and control immune functions. Fungi, bacteria, and other organisms along with substances isolated from said organisms are sometimes referred to as biostimulants.

The combination of nutrients and pesticides together with biostimulants may lead to a combined effect that is greater than the sum of their effect individually. For example, existing products are available that include biostimulants, nutrients, and pesticides. However, known products that have biostimulants, nutrients, and pesticides do not adequately mix, dissolve, or disperse when added to a liquid. Additionally, the resulting mixture, when applied, does not maximize even distribution or absorption by an organism, substrate, or environment.

Accordingly, there is a need for a composition, that includes effervescent agents, a biostimulant, a nutrient, and a pesticide, that is rapidly dissolvable, increases absorption, and improves effectiveness.

### SUMMARY

A composition is disclosed comprising potassium bicarbonate, an acid, a biostimulant, a nutrient, and a pesticide. The composition may be processed into a tablet, powder, meal, pellets, or granules and produce effervescence when a liquid, such as water or a water-based liquid is mixed with the composition.

In another aspect, a composition is disclosed comprising a carbonate compound, a bicarbonate compound, and other base, an acid, a biostimulant, a nutrient, a pesticide, and other sub stance.

An amount of the effervescent agents including the carbonate compound, the bicarbonate compound, or other base and the acid, is between about 2% by mass to about 99.99% by mass. An amount of the biostimulant is between about 0.01% by mass to about 98% by mass. An amount of the nutrient is between about 0.01% by mass to about 98% by mass. An amount of the pesticide is between about 0.01% by mass to about 98% by mass. An amount of the other substance is between about 0.01% by mass to about 98% by mass. An amount of the acid is between about 1% by mass to about 98.99% by mass. An amount of the carbonate compound is between about 1% by mass to about 98.99% by mass. An amount of the bicarbonate compound is between about 1% by mass to about 98.99% by mass. An amount of the other base is between about 0.01% by mass to about 98.99% by mass. An amount of the carbonate compound, the bicarbonate compound, or other base in combination is between about 1.01% by mass to about 98.99% by mass.

In one aspect, there is disclosed a method for fabricating a composition, comprising combining a carbonate compound, a bicarbonate compound, and other bases, an acid, a biostimulant, a nutrient, a pesticide, and other substances. The combining step may further comprise adding one of a lubricant, a binding agent, and a medium. The method may further include processing the composition into one of a tablet, powder, meal, pellets, and granules. The method may further include mixing or dissolving the composition in a liquid, wherein the liquid is one of water and a water-based liquid.

### BRIEF DESCRIPTION OF THE FIGURES

The invention may be better understood by referring to the following FIGURES. The components in the figures are not necessarily to scale, emphasis instead being placed upon illustrating the principles of the invention. In the FIGURES, like reference numerals designate corresponding parts throughout the different views.

FIG. 1 shows a method for fabricating a composition with effervescent agents, a biostimulant, a nutrient, and a pesticide in accordance with an embodiment.

### DETAILED DESCRIPTION

Each of the additional features and teachings disclosed below can be utilized separately or in conjunction with other features and teachings to a method for fabricating a composition with effervescent agents, a biostimulant, a nutrient, and a pesticide (CEBNP). Representative examples of the present invention, which utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detailed description may not be necessary to practice the invention in the broadest sense and are instead taught merely to particularly describe representative examples of the present teachings.

Moreover, the various features of the representative examples and the dependent claims may be combined in ways that are not specifically and explicitly enumerated to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for original disclosure, as well as for the purpose of restricting the claimed subject matter.

It is expressly understood that the term “organism” means a plant, a fungi, an animal, a chromista, a protozoa, an archaea, a bacteria, or a virus.

It is expressly understood that the term “substrate” means the surface or material on or from which an organism lives, grows, or obtains nourishment.

It is expressly understood that the term “environment” means the surroundings or conditions in which an organism lives or operates.

It is expressly understood that the term “biostimulant” means a substance, a probiotic, an antibiotic, or an organism that may stimulate, enhance, benefit, diminish, or impede the nutrient uptake, the nutrient-use efficiency, the nutrient efficacy, the growth, the health, the cellular activity, the hormonal activity, the tolerance to abiotic stress, the tolerance to biotic stress, the tolerance to environmental stress, the disease resistance, the pest resistance, the quality, or the yield of an organism, a substrate, or an environment.

It is expressly understood that the term “nutrient” means a substance that provides an organism, a substrate, or an environment with the nourishment essential for growth or maintenance of life.

It is expressly understood that the term “pesticide” means a substance that prevents, destroys, repels, controls, regulates, or mitigates an organism, a substrate, an environment, or the effects thereof.

It is expressly understood that the term “acid” means an acid or substance that contains an acid that can react with a base. An acid may be an acid yielding compound. An add may be a molecule or other entity that can donate a proton or accept electron pair in reactions. An acid may be described by Arrhenius, Brønsted-Lowry, and Lewis definitions of acids.

It is expressly understood that the ten “base” means a base or substance that contains a base that can react with an acid. A base may be an alkali compound. A base may be a molecule or other entity that can accept a proton or donate an electron pair in reactions. A base may be described by Arrhenius, Brønsted-Lowry, and Lewis definitions of bases.

In one embodiment, the composition may provide a CEBNP in a premeasured formulation that requires no agitation or stirring for mixing or dissolution in water. In one embodiment, the CEBNP may mix, dissolve, or disperse rapidly. In yet another embodiment, the CEPNP may mix, dissolve, or disperse slowly. In one embodiment, a CEBNP may be in the form of any solid, including any powder, meal, pellet, granule, or tablet. Binding agents, lubricants, mediums, or other substances may be used in forming a dry composition. In one embodiment, a CEBNP containing a carbonate compound or a bicarbonate compound, an acid, a biostimulant, a nutrient, and a pesticide may be formed.

In one embodiment, the effervescent agents may be the combination of a carbonate compound, a bicarbonate compound, other base, and an acid. In one embodiment, the acid may include sodium, be substantially sodium-free, sodium-free, organic or inorganic with sufficient strength to react with a carbonate, bicarbonate or other base to yield carbon dioxide (CO2) or other gas. Additionally, the effervescent agents may contribute significantly to the overall nutrient composition and effectiveness of the biostimulant, nutrient, or pesticide.

In one embodiment, the acid may include citric acid, tartaric acid, oxalic acid, inorganic acid salts, ammonium bisulfate, potassium bisulfate, monohydrogen phosphate, and dihydrogen phosphate. Other acid yielding compounds or substances may be used. A combination of acid yielding compounds or substances may be used.

In one embodiment, the carbonate, bicarbonate, or other base may include sodium carbonate, ammonium carbonate, potassium carbonate, sodium bicarbonate, ammonium bicarbonate, and potassium bicarbonate. Other carbonates, bicarbonates, other compounds, or substances may be used. A combination of carbonates, bicarbonates, other compounds, or substances may be used.

The biostimulant may include an organism, hormone, biosurfactant, probiotic, antibiotic, stimulant, and other substance. The biostimulant may be a natural or synthetic substance. The Biostimulant may be a naturally occurring or genetically modified organism or may be a substance derived from a naturally occurring or genetically modified organism. A microorganisms may be incorporated on a suspendible, water-insoluble or water-soluble substrate such as dextrose, clay, or any other medium suitable for carrying said microorganism. The biostimulant may also be a nutrient, pesticide, acid, carbonate, bicarbonate, other base, or other substance. Multiple biostimulants and blended biostimulants may be incorporated into the CEBNP.

The biostimulant may include a metabolite from an organism, extract from an organism, genetically modified organism, hydrolysate from an organism, plant symbiont, fungi, yeast, spores, mycorrhiza, mycorrhizae, mycorrhizal propagule, fungal propagule, ectomycorrhizal fungal propagule, endomycorrhizal fungal propagule, ectomycorrhiza, endomycorrhiza, arbuscular mycorrhiza, free-living fungi, Ascomycota, Basidiomycota, Glomeromycota, Gigasporaceae, Glomeraceae, Acaulospora spp., Ambispora spp., Archaeospora spp., Cetraspora spp., Claroideoglomus spp., Dentiscutata spp., Diversispora spp., Entrophospora spp., Fenneliformis spp., Gibberella spp., Gigaspora spp., Glomus spp., Laccaria spp., Paraglomus spp., Pisolithus spp., Quatunica spp., Racocetra spp., Rhizoglomus spp., Rhizophagus spp., Rhizopogon spp., Saccharomyces spp., Scleroderma spp., Scutellospora spp., Septoglomus spp., Suillus spp., Trichoderma spp., bacteria, plant growth promoting rhizobacteria (PGPR), nitrogen fixing bacteria, phosphorous solubilizers, rhizobacteria, Rhizobia, Rhizobium, diazotrophic bacteria, Acetobacter spp., Actinomyces spp., Allorhizobium spp., Anabaena spp., Arthrobacter spp., Azorhizobium spp., Azospirillum spp., Azotobacter spp., Bacillus spp., Beijerinckia spp., Bradyrhizobium spp., Burkholderia spp., Chroococcidiopsis spp., Clostridium spp., Frankia spp., Geobacillus spp., Gluconacetobacter spp., Herbaspirillum spp., Klebsiella spp., Lacticaseibacillus spp., Lactiplantibacillus spp., Lactobacillus spp., Lactococcus spp., Mesorhizobium spp., Mycobacterium spp., Nostoc spp., Oscillatoria spp., Paenibacillus spp., Pantoea spp., Phormidium spp., Priestia spp., Pseudomonas spp., Rhizobium spp., Rhodobacter spp., Rhodopseudomonas spp., Schinkia spp., Serratia spp., Streptococcus spp., Streptomyces spp., Synechocystis spp., nematodes, plant growth regulators, enzymes, amino acids, hormones, phytohormones, abscisic acid, salicylic acid, ethylene, strigolactones, brassinosteroids, jasmonates, gibberellins, gibberellin inhibitors, auxins, cytokinins, vitamins, organic acids, fatty acids, lipids, phenols, polyphenols, allelochemicals, alkaloids, tannins, lactones, quinones, steroids, peptides, polyamines, and carotenoids.

The nutrient may be a natural product such as solution grade fish meal, kelp powder, or other natural nutrient source. The nutrient may be processed to a particle size small enough to allow for suspension or dissolution in water. The nutrient may be processed to a particle size small enough to avoid clogging irrigation systems, sprayers, pipes, hoses, fixtures, watering cans, water bottles, drinking devices, cups, glasses, manufacturing equipment, process equipment, and other applicators. Alternatively, the nutrient may be in synthetic form, such as ammonium nitrate, diammonium phosphate, potassium nitrate, urea, or any other synthetic nutrient. The nutrient may be in a readily water-soluble form or suspendible in liquid. The nutrient may also be a biostimulant, pesticide, acid, carbonate, bicarbonate, other base, or other substance. Multiple nutrients and blended nutrients may be incorporated into the CEBNP.

The nutrient may include an organic fertilizer, bio fertilizer, chemical fertilizer, synthetic fertilizer, organic salt, inorganic salt, mineral fertilizer, macronutrient, primary nutrient, nitrogen source, phosphorous source, potassium source, secondary nutrient source, calcium, magnesium, sulfur, micronutrient source, boron, cobalt, copper, iron, manganese, molybdenum, zinc, beneficial substance, aluminum, chlorine, nickel, selenium, silicon, sodium, ethylenediaminetetraacetic acid (EDTA), disodium ethylenediamine tetra acetate, and ethylenediamine-N,N′-bis(2-hydroxyphenylacetic acid) (EDDHA).

The pesticide may be a chemical, antimicrobial, biopesticide, or other substance. The pesticide may be a natural or synthetic substance. The pesticide may be an organism or substance derived from an organism. The organism may be genetically modified. The pesticide may be fermentation solids, solids, spores, proteins, protein toxins, active toxins, or insecticidal toxins derived from an organism. The pesticide may also be a biostimulant, nutrient, acid, carbonate, bicarbonate, other base, or other substance. Multiple pesticides and blended pesticides may be incorporated into the CEBNP.

The pesticide may include an acaricide, algaecide, antifoulant, antimicrobial, attractant, avicide, bactericide, biochemical pesticide, biocide, biopesticide, botanical, chemical pesticide, desiccant, disinfectant, entomopathogenic fungus, fumigant, fungicide, herbicide, insect growth regulator, insecticide, metabolite, microbial pesticide, miticide, molluscicide, nematicide, neonicotinoid, organic pesticide, ovicide, pheromone, plant defoliant, plant extract, plant growth regulator, plant-incorporated-protectant (PIP), repellant, rodenticide, sanitizer, slimicide, sterilant, and synthetic pesticide.

Existing formulations of biostimulants, nutrients, and pesticides may also be used in formulations of the CEBNP. The biostimulant, nutrient, and pesticide may be supplied independently or together in the form of a blended biostimulant, nutrient, and pesticide product. Each component can be supplied independently or together with one or more other components. A blended biostimulant, nutrient, and pesticide product may be water-soluble, water-insoluble or suspendible in liquid.

In some embodiments, the CEBNP may be packaged. In one example, the CEBNP may be portioned and filled into varying sized resealable bags. Alternatively, the CEBNP may be packed into small single-use packets that may be packed as individuals or filled into boxes of various quantities. The CEBNP may further be refined into pellets and granules or manufactured into tablets that may be packed individually into single-use packets that may be packed as individuals or in boxes of various quantities. Alternatively, CEBNP may be packed into multi-celled register hanger cards, tubes, or other display packaging. The CEBNP may also be packed into resealable bags of varying sizes. The packaging may be air tight, moisture sealed, and may include a desiccant. The packaging may also include aluminum, foil, polyethylene, polypropylene, polyvinyl, PVC, plastic, bioplastic, biodegradable materials, cardboard, cornstarch, seaweed, mushroom, or cellulose for the CEBNP.

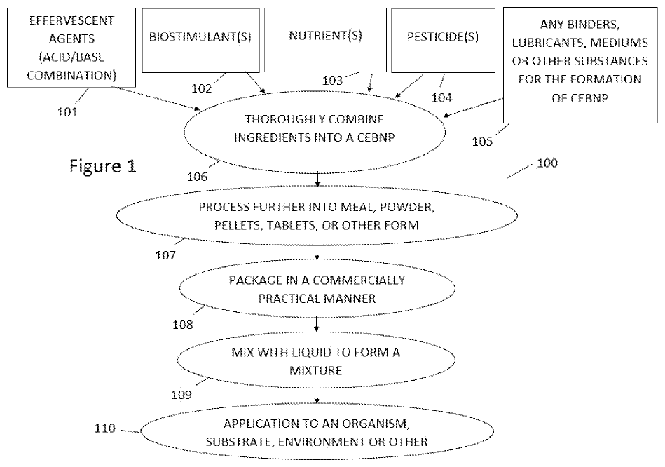

FIG. 1 is a flow chart for a method 100 for fabricating a CEBNP in accordance with an embodiment. At steps 101-105, effervescent agent(s) 101, biostimulant(s) 102, nutrient(s) 103, pesticide(s) 104, and/or binding agents, lubricants, mediums or other substances 105 are collected. At step 106, the ingredients from steps 101-105 may be combined into a CEBNP. At step 107, the CEBNP may be processed to form meal, powder, pellets, granules, tablets, or other form. At step 109, the CEBNP may be mixed or dissolved in a liquid, such as water or a water-based liquid, and at step 110 the resulting mixture may be applied to or used by an organism, a substrate, or an environment. At step 110 the resulting mixture may be applied to soil, seeds plants, or the like.

It is expressly noted that the steps in FIG. 1 may be performed in any order and certain steps may be omitted. For example, a commercially available CEBNP may be formed and packaged at step 108. The resulting mixture at step 109 and the application of the mixture at step 110 may occur at the time of application of the mixture.

In some embodiments, the amount of effervescent agents including the carbonate compound, bicarbonate compound, or other base and an acid may be between about 2% by mass to about 99.99% by mass. In some embodiments, the amount of biostimulant may be about 0.01% by mass to about 98% by mass. In some embodiments, the amount of nutrient may be about 0.01% by mass to about 98% by mass. In some embodiments, the amount of pesticide may be about 0.01% by mass to about 98% by mass. In some embodiments, the amount of other substance may be about 0.01% by mass to about 98% by mass. In one embodiment, the amount of acid may be about 1% by mass to about 98.99% by mass. In other embodiments, the amount of carbonate compound may be about 1% by mass to about 98.99% by mass. In other embodiments, the amount of bicarbonate compound may be about 1% by mass to about 98.99% by mass. In other embodiments, the amount of other base may be about 0.01% by mass to about 98.99% by mass. In yet other embodiments, the amount of carbonate compound, bicarbonate compound, or other base in combination may be about 1.01% by mass to about 98.99% by mass. It is expressly noted that all value ranges or indications of groups of entities disclose every possible intermediate value or intermediate entity for original disclosure, as well as for the purpose of restricting the claimed subject matter.

Below are several examples of one or more embodiments of the invention for the CEBNP with any other ingredients described herein using the methods described in FIG. 1. Each of the percentages below is expressed in percentages by mass. In each example, a liquid, such as water or a water-based liquid, may be added to the CEBNP.

It is expressly noted that all value ranges or indications of groups of entities disclose every possible intermediate value or intermediate entity for original disclosure, as well as for the purpose of restricting the claimed subject matter.

### Example 1

25% Potassium Bicarbonate
25% Citric Acid
45% 20-20-20 (NPK) Nutrient Fertilizer
5% Bacteria and Trichoderma on Dextrose

### Example 2

50.1% Bicarbonate
5% Acid Yielding Compound
30% Ammonium Sulfate Nitrate, Diammonium Phosphate, Potassium Nitrate, and Urea
10% Iron, Calcium, Sulfur, Manganese, Copper, Zinc, Boron, Molybdenum, and Cobalt
4.9% Hormones and Biosurfactants

### Example 3

40.1% Bicarbonate
35% Citric Acid
20% Nitrogen Source Nutrient, Phosphorus Source Nutrient, Potassium Source Nutrient
4.9% Bacteria including Bacillus spp., Paenibacillus spp., Azotobacter spp., or Pseudomonas spp

### Example 4

35% Potassium Bicarbonate
35% Citric Acid, Tartaric Acid, and Oxalic Acid
25% 20-20-20 (NPK) Nutrient Fertilizer
5% Fungi including Glomus spp., Paraglomus, spp., Gigaspora spp., Rhizopogon spp., Pisolithus spp., Suillus spp., Laccaria spp., Scleroderma spp., Saccharomyces spp., or Trichoderma

### Example 5

25% Ammonium Bicarbonate
25% Citric Acid, Ammonium Bisulfate, Potassium Bisulfate, Monohydrogen Phosphate, and Dihydrogen Phosphate
40% 20-20-20 (NPK) Nutrient Fertilizer 10% Beneficial Microorganism Gardening Product

### Example 6

15% Potassium Bicarbonate
10% Sodium Bicarbonate
25% Citric Acid
50% 20-20-20 (NPK) Nutrient Fertilizer with Biostimulant

### Example 7

30.1% Bicarbonate
25% Citric Acid, Tartaric Acid, Oxalic Acid, Ammonium Bisulfate, Potassium Bisulfate, Monohydrogen Phosphate, and Dihydrogen Phosphate
29.9% Nitrogen Nutrient Fertilizer
15% Bacteria and Trichoderma on Dextrose

### Example 8

85% Potassium Bicarbonate
7% Citric Acid, Tartaric Acid, Oxalic Acid, Ammonium Bisulfate, Potassium Bisulfate, Monohydrogen Phosphate, and Dihydrogen Phosphate
5% Phosphorus and Nitrogen Nutrient Fertilizer
3% Bacteria and Trichoderma on Dextrose

### Example 9

20.1% Potassium Bicarbonate
24.9% Citric Acid
50% Solution Grade Fish Powder Nutrient Fertilizer
5% Live Microorganisms, Plant Hormones, Biosurfactants, Neem

### Example 10

50.1% Bicarbonate
24.9% Citric Acid
20% All-Purpose Plant Nutrients with Micro-Nutrients
5% Bacteria including Bacillus spp., Paenibacillus spp., Azotobacter spp., or Pseudomonas spp.
5% Fungi including Glomus spp., Paraglomus, spp., Gigaspora spp., Rhizopogon spp., Pisolithus spp., Suillus spp., Laccaria spp., Scleroderma spp., Saccharomyces spp., or Trichoderma

### Example 11

60.1% Bicarbonate
24.9% Citric Acid
15% Bacteria including Bacillus thuringiensis, Bacillus subtilus

### Example 12

65.1% Bicarbonate, Carbonate, Other Base
14.9% Acid
20% Biostimulant, Nutrient, Pesticide, Other Substance

### Example 13

55.1% Bicarbonate, Carbonate, Other Base
19.9% Acid Substance
25% Biostimulant, Nutrient, Pesticide, Other Substance

### Example 14

45.1% Bicarbonate, Carbonate, Other Base
24.9% Acid
30% Biostimulant, Nutrient, Pesticide, Other Substance

### Example 15

35.1% Bicarbonate, Carbonate, Other Base
29.9% Acid
35% Biostimulant, Nutrient, Pesticide, Other Substance

### Example 16

25.1% Bicarbonate, Carbonate, Other Base
34.9% Acid
40% Biostimulant, Nutrient, Pesticide, Other Substance

### Example 17

46% Potassium Bicarbonate
29% Citric Acid
25% Biostimulant, Nutrient, Pesticide

### Example 18

2% Effervescent Agents: Acid and Bicarbonate, Carbonate, or Other Base
98% Biostimulant

### Example 19

2% Effervescent Agents: Acid and Bicarbonate, Carbonate, or Other Base
98% Nutrient

### Example 20

2% Effervescent Agents: Acid and Bicarbonate, Carbonate, or Other Base
98% Pesticide

### Example 21

2% Effervescent Agents: Acid and Bicarbonate, Carbonate, or Other Base
98% Other Substance

### Example 22

99.99% Effervescent Agents: Acid and Bicarbonate, Carbonate, or Other Base
0.01% Biostimulant

### Example 23

99.99% Effervescent Agents: Acid and Bicarbonate, Carbonate, or Other Base
0.01% Nutrient

### Example 24

99.99% Effervescent Agents: Acid and Bicarbonate, Carbonate, or Other Base
0.01% Pesticide

### Example 25

99.99% Effervescent Agents: Acid and Bicarbonate, Carbonate, or Other Base
0.01% Other Substance

In some embodiments, the components of the above examples may be combined with any variety of binders, lubricants, mediums, or other substances required for a stable, effervescent composition. In some embodiments, the above examples may be in dry form that may mix or dissolve in approximately five minutes or less when adding a liquid, such as water or a water-based liquid. In some embodiments, the composition in dry form may mix or dissolve in approximately one minute or less. In one embodiment, the composition in dry form may mix or dissolve in approximately five minutes or more. In yet another embodiment, the composition in dry form may mix or dissolve in approximately one hour or more.

In one embodiment, the amount of liquid, such as water or water-based liquid, to mix or dissolve the dry composition may be approximately one ounce or more. In other embodiments, the CEBNP may be designed for mixing or dissolution in a volume of liquid substantially equivalent to a standard cup, 8 oz.-128 oz. container, mason jar, watering can, spray bottle, irrigation tank, 128 oz. container or larger, larger volumes of water for process or industrial purposes, or other applicator or receptacles used for home, agricultural, garden applications, industrial, manufacturing, and other processes. In other embodiments, the CEBNP may be mixed with a liquid and the resulting mixture may be applied to or used by an organism, a substrate, or an environment

It is expressly noted that all value ranges or indications of groups of entities disclose every possible intermediate value or intermediate entity for original disclosure, as well as for the purpose of restricting the claimed subject matter.

In some embodiments, the acid may include acetic acid, adipic acid, amino acids, arsenic acid, arsenious acid, ascorbic acid, benzoic acid, boric acid, carbonic acid, chloric acid, chromic acid, citric acid, citric acid anhydride, ethanoic acid, formic acid, heteropolyoxometallates, hydrobromic acid, hydrochloric acid, hydrofluoric acid, hydrogen selenide, hydrogen sulfate ion, hydrogen sulfide, hydroiodic acid, isocyanic acid, lactic acid, maleic acid, malic acid, malonic acid, methanoic acid, molybdic acid, nicotinic acid, niobic acid, nitric acid, nitrous acid, orthophosphoric acid, oxalic acid, oxides of titania, zirconia, and niobia, perchloric acid, phosphoric acid, potassium dihydrogenphosphate, p-toluene sulfonic, selenic acid, selenous acid, silicic acid, silicic acid (with SiO2(a) precipitation), silico-aluminates (zeolites, alumina, silico-aluminophosphate), sodium dihydrogenphosphate, sodium fumarate, solid Brønsted acids, succinic acid, succinic acid anhydride, sulfated zirconia, sulfonated polystyrene, sulfuric acid, sulfurous acid, sulphamic acid, and tartaric acid.

In some embodiments, the carbonate may include aluminium carbonate, ammonium carbonate, ammonium sesquicarbonate, ammonium uranyl carbonate, arginine carbonate, barium carbonate, basic copper carbonate, beryllium carbonate, bismuth subcarbonate, borate carbonate, caesium carbonate, calcium carbonate, caliche, carbonate chloride, carbonate oxalate, carbonatobis(ethylenediamine)cobalt(III) chloride, carbonic acid, cerium(III) carbonate, cobalt(II) carbonate, copper(II) carbonate, fluorocarbonate, iron(II) carbonate, lanthanum carbonate, lead carbonate, lithium carbonate, L-lysine carbonate, magnesium carbonate, manganese(II) carbonate, mesoporous magnesium carbonate, nickel(II) carbonate, potassium carbonate, potassium sequicarbonate, radium carbonate, rubidium carbonate, siderite, silicon carbonate, silver carbonate, sodium carbonate, sodium glycine carbonate, sodium percarbonate, sodium sesquicarbonate, strontium carbonate, sulfate carbonate, thallium(I) carbonate, thiocarbonate, uranyl carbonate, and zinc carbonate.

In some embodiments, the bicarbonate may include potassium bicarbonate, ammonium bicarbonate, sodium bicarbonate, caesium bicarbonate, calcium bicarbonate, lithium bicarbonate, and magnesium bicarbonate.

In some embodiments, the other base may include carbonic anhydrase, ammonium hydroxide, barium hydroxide, beryllium hydroxide, cadmium hydroxide, calcium hydroxide, chromium(III) hydroxide, cobalt(II) hydroxide, copper(II) hydroxide, iron(II) hydroxide, lead(II) hydroxide, magnesium hydroxide, mercury(II) hydroxide, nickel(II) hydroxide, potassium acetate, potassium hydroxide, silicoaluminophosphate, sodium acetate, sodium borate, sodium hydrogen phosphate, sodium hydroxide, sodium metasilicate, strontium hydroxide, trisodium phosphate, zinc hydroxide, sodium sesquicarbonate, potassium sequicarbonate, ammonium sesquicarbonate, and sesquicarbonate.

In some embodiments, the other substance may include absorbant, anticaking agent, binder, carrier, clay, diluent, disintegrant, dispersant, drying agent, filler, flow material, gliding agent, lubricant, release agent, surfactant, wetting agent, 2-(4-isopropyl-4-, methyl-5-oxo-2-imidazolin-2-yl)-, methyl ester, 2,2′ Dihydroxydiethyl ether, 2-ethyl hexyl acid phosphate, 3-(3-Hydroxypropyl) Heptamethyltrisiloxane, 6-(4-isopropyl-4-methyl-5-oxo-2-imidazolin-2-yl)-, methyl ester, acid earth, agar, akadama, alcohol ethoxylate, alginate, alkoxylated polyol, Alkoxylated tri silane/3-(2-methoxy ethoxy)propyl-methyl-bis(trimethylsilyloxy)silane, alkyl ammonium salt, alkyl ether sulfate, alkyl polyethoxy ether, alkyl polyglycoside, alkyl polyoxyethylene ether, alkyl sulfate, alkylaryl polyoxyalkane ether, alkylarylpolyethoxyethanol phosphate, alkylarylpolyoxyethylene glycol, alkylbenzene sulfonate, alkylphenol ethoxylate, allophane, alpha olefin sulfonate, amine oxide, ammonium lauryl sulfate, ammonium sulfate, amphoteric surfactant, amyl acid phosphate-EP, anauxite, animal oil, anionic surfactant, arcillite, aromatic petroleum solvent, attapulgite, beidellite, Bentone MA (Na0.4Mg2.7Li0.3Si4O10(OH)2), bentonite, biochar, biotite, blended diol, boric acid, C10 branched alcohol ethoxylate, C11 alcohol ethoxylate, POE-5, C11 alcohol ethoxylate, POE-7, C11 alcohol ethoxylate, POE-9, C11.4 alkylbenzene sulfonic acid, linear, C12-13 alcohol ethoxylate blend, C12-14 lauryl alcohol ethoxylate, POE-7, C12-14 lauryl alcohol ethoxylate, POE-8, C12-15 alcohol ethoxylate, POE-7, C14-15 alcohol ethoxylate, POE-7, C9-11 alcohol ethoxylate blend, C9-11 alcohol ethoxylate, POE-6, C9-11 alcohol ethoxylate, POE-8, C9-11 and C12-13 alcohol ethoxylate blend, C9-11 and C12-15 alcohol ethoxylate blend, calcined clay, calcium bentonite, calcium montmorillonite, calcium silicate, calcium smectite, caprylyl capryl glucoside, carrageenan, cationic surfactant, Ceteareth-25, chlormequat chloride, clay, Cloisite Na+ ((Na,Ca)0.33(Al,Mg)2Si4O10(OH)2), cocamidopropyl betaine, coco glucoside, coco sulfate, cocoamide DEA, complex fatty tertiary amine, corn oil, cottonseed oil, crop oil concentrate, croscarmellose sodium, crospovidone, cyclodextrin, cycocel, decyl glucoside, Delelite LVF ((Si,Al)8(Al,Fe,Mg)4O20(OH)4,Xn,m(H2O)), dextrin, dextrose, diatomaceous earth, dickite, dimethylpolysiloxane, disodium 2-sulfolaurate, disodium cocoamphodiacetate, disodium cocoyl glutamate, disodium laureth sulfosuccinate, esterified seed oil, esterquat, Ethoxylated Acetate/125997-17-3, ethoxylated derivative, ethoxylated sorbitan fatty acid ester, ethyl ester of corn seed oil, ethyl ester of rapeseed oil, ethyl ester of soybean seed oil, ethyl ester of sunflower seed oil, ethyl ester of vegetable seed oil, ethylated seed oil, fatty acid, fatty alcohol sulphate, Fuller's earth, gelatin, gellan gum, glauconite, glucoether, glyceryl caprate, glyceryl caprylate, glyceryl palmitostearate, graphene oxide nanoparticle, gum arabic, halloysite, Halloysite (Al2Si2O5(OH)4×2H2O), Halloysite MP1 (Al2Si2O5(OH)4×2H2O), heavy kaolin, hectorite, hexadecyltrimethylammonium-saturated Arizona montmorillonite, hydrogel-clay nanocomposite, hydroxypropyl cellulose, illite, Imazamethabenz-methyl m-Toluic acid, inorgano-organo-modified clay, kaolin, kaolinite, kaolinite nanocomposite (α-Fe2O3-kaolinKAc), kaolinite-serpentine group, lactose, laponite, lauramidopropyl betaine, lauramidopropylamine oxide, lauramine oxide, lauryl glucoside, lauryl lactyl lactate, alcohol ethoxylate phosphate ester, lepidolite, light kaolin, lignite, linear alcohol, linear alkylbenzene sulphonate, L-leucine, locust bean gum, magnesium aluminum silicate, magnesium lauryl sulfate, magnesium lauryl sulphate, magnesium smectite, magnesium stearate, maltodextrin, mannitol, ME-100 (Na2×Mg3-xSi4O10(FyOH1-y)2), metakaolin, methoxy-modified kaolinite, methoxy-pectin, methyl cellulose, methyl soyate, methylated canola oil, methylated seed oil, mica, microcrystalline cellulose, microorganism carrier, mix of alginate, bentonite and starch, modified fatty acid, modium montmorillonite, mono alkyl quaternary system, montmorillonite, muscovite, mythyl ester of corn seed oil, mythyl ester of rapeseed oil, mythyl ester of soybean seed oil, mythyl ester of sunflower seed oil, mythyl ester of vegetable seed oil, nacrite, nano-biocomposite, nanoclay, Nanomer PGV (M+y(Al2-yMgy)(Si4)O10(OH)2×nH2O), natural char micro-particle (NCMP), natural char nano-particle (NCNP), nitrogen-surfactant blend, nonionic surfactant, nontronite, Nonyl Phenol Ethoxylate/NP 9-NP 10, nonyl-phenol alcohol, octadecanoic acid, octylphenol ethoxylate, olive oil, organoclay, organomodified clay, organo-silicate, organo-silicone, palygorskite, paraffin base petroleum hydrocarbon, parafinic oil, paragonite, peanut oil, phlogopite, phosphate ester, phosphate esters of polyoxyethanol, phyllosilicate, plantapon 611L UP, plantapon LGC Sorb, Poly(oxy-1,2-ethanediyl), .alpha.-[(1,1,3,3-tetramethylbutyl)phenyl]-.omega.-hydroxy, polyacrylamide, polyalkyleneoxide modified heptamethyltrisiloxane, polyalkyleneoxide modified polydimethylsiloxane, polyethoxylated derivative, polyethylene glycol, Polyethylene Glycol Diacetate/27252831, Polyethylene Glycol Monallyl Acetate/27252875, polymeric nanoparticle coating, polymerized fatty acid, polymerized resin, polyol fatty acid ester, polyoxyalkylene fatty ester, polyoxyethlene sorbitan fatty acid ester, polyoxyethlylene stearate, polysaccharide and clay mineral combination, polysaccharide carrier, polyvinyl alcohol, polyvinylpyrolidone, potassium bentonite, potassium silicate, potassium sorbate, prill, p-Toluic acid, pyrophyllite, quaternary ammonium salt, rapeseed oil, reacted amine, saponite, sepiolite, sextrose, silica, silicon dioxide, smectite clay, soap, sodium alkylbenzene sulfonate, linear, sodium bentonite, sodium benzoate, sodium C14-16 olefin sulfonate, sodium C14-C16 olefin sulfonate 40% solution, sodium coco sulphate, sodium cocoyl glutamate, sodium cocoyl isethionate, sodium docusate, sodium dodecylbenzene sulfonate, sodium dodecylbenzene sulfonate-linear, sodium laureth sulfate, 2 moles EO, sodium lauryl sulfate, sodium lauryl sulfoacetate, sodium lauryl sulphate, sodium methyl-2-sulfolaurate, sodium octane sulfonate, sodium silicate, sodium smectite, sodium starch glycolate, sodium stearate, sodium stearyl fumarate, sodium xylene sulfonate, sorbic acid, sorbitan fatty acid ester, sorbitol, soybean oil, starch, starch derivative, stearic acid, sulfated fish oil, talc, tall oil fatty acid, TEA ester quat, vegetable oil, vegetable seed oil, wyoming montmorillonite, xanthan gum, zeolite, aromatic, color agent, flavor, taste modifier, acesulfame potassium, advantame, aspartame, colorant, dye, lake, neotame, pigment, saccharin, sucralose, sucrose, sweetener, natural or synthetic, essence, extract, color, or oil of vanilla, citrus, lemon, orange, grape, lime, grapefruit, apple, pear, peach, strawberry, raspberry, cherry, plum, pineapple, apricot, or other herb, fruit, vegetable, flower, plant, meat, fish, animal, food, or flavor, natural or synthetic, essence, extract, color, or oil of cinnamon, chocolate, vanilla, wintergreen, peppermint, spearmint, clove, bay, anise, eucalyptus, thyme, cedar, nutmeg, sage, almond, cassia, or other herb, fruit, vegetable, flower, plant, meat, fish, animal, food, or flavor, color agents including red, orange, yellow, green, cyan, blue, magenta, purple, white, black, gray (American English), grey (Commonwealth English), silver, pink, maroon, brown, beige, tan, peach, lime, olive, turquoise, teal, navy blue, indigo, violet, carmel, and color combinations thereof, natural flavors extracted from (spices, fruit or fruit juice, vegetables or vegetable juice, edible yeast, herbs, bark, buds, root leaves, or plant material, dairy products, including fermented products, meat, poultry, fish, seafood, or eggs).

In some embodiments, the nutrient may be a nitrogen source including a nitrogen salt, acidulated fish tankage, activated sewage product, alfalfa meal, amino acid, aminoureaformaldehyde, ammonium salt, ammonium citrate, ammoniated calcium nitrate, ammonium calcium nitrate double salt, ammoniated superphosphate, ammonium nitrate, ammonium nitrate-sulfate, ammonium oxalate, ammonium phosphate, ammonium phosphite, ammonium polysulfide, ammonium sulfate nitrate, ammonium thiosulfate, anydrous ammonia, animal manure, aqua ammonia, bat guano, brewers grain, brewers yeast, calcium ammonium nitrate, calcium nitrate, calcium nitrate urea, corn gluten meal, corn steep liquor, cottonseed meal, crude, inert, or slow-acting nitrogenous material, cyanamide (lime nitrogen), dicyandiamide (cyanoguanidine), dimethylenetriurea (DMTU), distillers grain, dried blood, ferric ammonium sulfate, feather meal, ferrous ammonium sulfate, dry fish tankage (dry fish scrap, dry ground fish, dry fish meal), dry garbage tankage, hoof and horn meal, hydrolyzed feather meal, isobutylidene diurea, kapok seed meal, magnesium nitrate, melamine, methylene urea (polymethylene urea), methylenediurea, nitrate of potash (potassium nitrate), nitrate of soda, nitrate of soda and potash (sodium and potassium nitrate), sodium nitrate, nitrate salt, potassium nitrate, nitrophosphate, oilseed meal, oxamide, peat, polymer coated urea (PCU), process tankage, protein hydrolysate, sheep manure, wool waste, soybean meal, sulfate of ammonia (ammonium sulfate), sulfur coated urea, tankage, triazone, UAN/calcium solution, urea, urea salt, urea ammonium nitrate solution (UAN-x), urea phosphite, ureaform fertilizer material, urea-formaldehyde product, urea-triazone solution, and wheat middling.

In some embodiments, the nutrient may be a phosphorus source including a phosphate, acidulated bone, ammoniated superphosphate, ammonium phosphate, ammonium phosphate sulfate, ammonium polyphosphate, basic lime phosphate (lime-based superphosphate), basic phosphate slag, bone meal, calcined phosphate, calcium metaphosphate, citrate soluble phosphate, DAP, diammonium phosphate, phosphoric acid, dicalcium phosphate, dipotassium phosphate (dibasic potassium phosphate), dried whey sludge, ground raw bone, hydroxylapatite, magnesium ammonium phosphate, magnesium potassium phosphate, MAP, monoammonium phosphate (monobasic potassium phosphate), phosphate, phosphate salt, phosphorus salt, phosphate rock, polyphosphate, orthophosphate, pyrophosphate, tripolyphosphate, tetrapolyphosphate, potassium polyphosphate, precipitated phosphate, soft phosphate with colloidal clay, superphosphate, superphosphoric acid, tripotassium phosphate (tribasic potassium phosphate), urea phosphate, ammonium metaphosphate, ammonium phosphate-nitrate, spent bone black, phosphatic limestone, magnesium phosphate, nitric phosphate, superphosphate enriched, potassium phosphate, monopotassium phosphite, Phosphite, sodium phosphite pentahydrate, hydrogenphosphonate, organic esters of hydrogen phosphite, pyrophosphite, inorganic phosphite, phosphite(Phi; H2PO3-), phosphorous acid, potassium phosphite, fosetyl-Al (Aluminum tris O-ethyl phosphonate), calcium phosphite, and phosphonate.

In some embodiments, the nutrient may be a potassium source including potash, double sulfate of potash and magnesia (langbeinite), greensand, kainit, kelp, laminariales, phaeophyceae, seaweed, manure salt, potassium chloride, mine run potash salt, muriate of potash, nitrate of potash, potassium nitrate, nitrate of soda and potash (sodium nitrate and potassium nitrate), sodium nitrate, potassium nitrate, potash, potassium acetate, potassium citrate, monopotassium citrate, potassium hydrogen phosphate dihydrate, potassium hydroxide, potassium phosphite, dipotassium phosphite, potassium sulphite, potash salt, potassium salt, potassium thiosulfate, potassium metaphosphate, metaphosphoric acid, sulfate of potash (potassium sulfate), sulfate of potash-magnesia, and tobacco stem.

In some embodiments, the nutrient may be a secondary nutrient source including CALCIUM, agricultural liming material, agricultural slag, air-slaked lime, quicklime, calcium acetate, calcined brucite, calcium amino acid complex, calcium glycinate, calcium chloride, hydrochloric acid, calcium glucoheptonate, glucoheptonic acid, calcium gluconate, gluconic acid, calcium EAHP, chelate of any soluble calcium salt and ethanol, 2-amino-2-hydroxy-1,2,3-propanetricarboxylate, calcium salt, calcium lignosulfonate, calcium (II) salt, lignosulfonic acid, calcium polysaccharide, polysaccharide long chain carbohydrate, calcium thiosulfate, dolomite, ground limestone, calcic limestone, dolomitic limestone, ground shell marl, ground shell, gypsum, landplaster, crude calcium sulfate, high calcic liming material, high magnesium liming material, hydrated lime, calcium hydroxide, magnesium oxide, magnesium hydroxide, magnesium EAHP, magnesium sulfate, marl, pelletized limestone, pulverized limestone, quick lime, burnt lime, caustic lime, lump lime, unslaked lime, waste lime (gas-house lime, tanner's lime, acetylene lime-waste, lime-kiln ashes, calcium silcate), calcium oxide, calcium nitrate, calcium chloride, MAGNESIUM, brucite, magnesium hydroxide, calcined brucite, magnesium oxide, high magnesic liming material, magnesium amino acid complex, magnesium (II) with an amino acid, magnesium glycinate, magnesium gluconate, gluconic acid, magnesium EAHP, chelate of any soluble magnesium salt and ethanol, 2-amino-2-hydroxy-1,2,3-propanetricarboxylate, magnesium salt, magnesium sulfate, epsom salt, kieserite, calcined kieserite, Magnesium nitrate hexahydrate, SULFUR, ammonium sulfate nitrate, ammonium thiosulfate, calcium thiosulfate, dimethyl sulfone, double sulfate of potash and magnesium, gypsum, magnesium sulfate, magnesium thiosulfate, potassium thiosulfate, sulfate of ammonia, sulfate of potash, sulfate of potash-magnesia, sulfur, and sulfur salt.

In some embodiments, the nutrient may be a micronutrient source including BORON, borax, sodium tetraborate, potassium tetraborate, hydrated borax, sodium borate, potassium borate, anhydrous borax, boron ethanolamine, boron fits, colemanite, calcium borate, anyhydrous colemanite, hydrated colemanite, disodium octaborate, dipotassium octaborate, hydrated disodium octaborate, hydrated dipotassium octaborate, anhydrous disodium octaborate, liquid boron product, boric acid, sodium borate derivative, potassium borate derivative, sodium borate-containing mineral, potassium borate-containing mineral, hydrated sodium borate derivative, hydrated potassium borate derivative, ulexite, hydrated ulexite, sodium-calcium borate material, potassium-calcium borate material, anhydrous ulexite, boron salt, sodium pentaborate, COBALT, cobalt EAHP, chelate of any soluble cobalt salt and ethanol, 2-amino-2-hydroxy-1,2,3-propanetricarboxylate, cobalt salt, cobalt sulfate, hydrated cobalt sulfate, cobalt salt, COPPER, copper (I) chloride (cuprous chloride), hydrated copper (I) chloride, copper salt of hydrochloric acid, anhydrous copper (I) chloride, copper (I) oxide (cuprous oxide, red copper oxide), copper (II) carbonate (cupric carbonate, copper carbonate), copper salt, copper (II) salt, copper (II) chloride (cupric chloride, copper chloride), hydrated copper (II) chloride, anhydrous copper (II) chloride, copper (II) citrate (copper citrate, cupric citrate), copper (II) IDS, copper (II) chelate of iminodisuccinic acid, copper (II) nitate (cupric nitrate, copper nitrate), copper (II) oxide (cupric oxide, black copper oxide), copper (II) sulfate (copper sulfate, cupric sulfate), hydrated copper (II) sulfate, anhydrous copper (II) sulfate, copper amino acid complex, copper glycinate, copper EDTA, copper (II) chelate of ethylenediaminetetraacetic acid, copper frit, copper glucoheptonate, glucoheptinic acid, copper humate, organic comple of copper (II) with humic acid, copper lignosulfonate, copper EAHP, chelate of any soluble copper salt and ethanol, 2-amino-2-hydroxy-1,2,3-propanetricarboxylate, copper oxychloride, copper (II) hydroxide, copper oxy sulfate, sulfuric acid, copper polysaccharide, organic compound of copper with polysaccharide long chain carbohydrate, copper sucrate, organic complex of copper (II) with short chain monosaccharide aldehyde-type reducing sugar, organic complex of copper (II) with short chain disaccharide aldehyde-type reducing sugar, IRON, ferrous ammonium sulfate (iron (II) ammonium sulfate), hydrated ferrous ammonium sulfate, anhydrous ferrous ammonium sulfate, iron (II) carbonate (ferrous carbonate, iron carbonate), iron (II) salt of carbonic acid, iron (II) IDS, iron (II) chelate of iminodisuccinic acid, iron (II) sulfate (ferrous sulfate), hydrated iron (II) sulfate, anhydrous iron (II) sulfate, iron (II) salt, iron (III) salt, iron (III) chloride (ferric chloride, iron chloride), hydrated iron (III) chloride, anhydrous iron (III) chloride, iron (III) nitrate (ferric nitrate, iron nitrate), iron (III) salt, nitric acid, iron (III) oxide (ferric oxide, red iron oxide), iron (III) sulfate (ferric sulfate), hydrated iron (III) sulfate, anhydrous iron (III) sulfate, iron amino acid complex, complex of iron (II) with an amino acid product, iron glycinate, iron citrate, iron (III) chelate of citric acid, iron DTPA, iron (III) chelate of diethylenetriaminepentaacetic acid, iron EDDHA, iron (III) chelate of ethylenediamine di-(o-hydroxyphenylacetic acid, iron EDDHSA, iron (III) chelate of ethylenediamine di-(2-hydroxyl-5-sulfophenylacetic) acid, iron EDTA, iron (III) chelate of ethylenediaminetetraacetic acid, iron frits, iron glucoheptonate, iron (II) gluconate, iron HBED, iron (III) chelate of bis(2-hydroxybenzyl)ethylenediamine diacetic acid, iron HEDTA, iron (III) cehlate of hydroxyethylethylenediaminetriacetic acid, iron humate, iron salt, iron lignosulfonate, iron EAHP, chelate of any soluble iron salt and ethanol, 2-amino-2-hydroxy-1,2,3-propanetricarboxylate, iron oxysulfate, iron polysaccharide, organic compound of iron with polysaccharide long chain carbohydrate, iron sucrate, organic complex of iron (II) with a short chain monosaccharide aldehyde-type reducing sugar, organic complex of iron (II) with a short chain disaccharide aldehyde-type reducing sugar, magnetic rock, magnetite, Ferrous sulfate, ferrous citrate, MANGANESE, manganese (II) carbonate (manganese carbonate, manganous carbonate), manganese (II) salt, manganese (II) chloride (manganous chloride, manganese chloride), hydrated manganese (II) chloride, anhydrous manganese (II) chloride, manganese (II) IDS, manganese (II) chelate of iminodisuccinic acid, manganese (II) nitrate (manganese nitrate, manganous nitrate), manganese salt, manganese (II) oxide (manganous oxide), manganese (II) sulfate (manganous sulfate, manganese sulfate), hydrated manganese (II) sulfate, anhydrous manganese (II) sulfate, manganese (IV) oxide (manganese oxide), manganese (IV) salt, manganese (II) thiosulfate, manganese amino acid complex, complex of manganese (II) with amino acid product, manganese glycinate, manganese citrate, manganese EDTA, manganese (II) chelate of ethylenediaminetetraacetic acid, manganese frits, manganese glucoheptonate, manganese (II) gluconate, manganese humate, manganese lignosulfonate, manganese EAHP, chelate of any soluble manganese salt and ethanol, 2-amino-2-hydroxy-1,2,3-propanetricarboxylate, manganese oxysulfate, manganese polysaccharide, manganese with polysaccharide long chain carbohydrate, manganese sucrate, organic complex manganese (II) with short chain monosaccharide aldehyde-type reducing sugar, organic complex manganese (II) with short chain disaccharide aldehyde-type reducing sugar, MOLYBDENUM, ammonium molybdate, hydrated ammonium molybdate, anyhydrous ammonium molybdate, molybdic acid, molybdenum salt, molybdic oxide, sodium molybdate, hydrated sodium molybdate, anhydrous sodium molybdate, potassium molybdate, hydrated potassium molybdate, anhydrous potassium molybdate, Sodium molybdate, ammonium molybdenum, ZINC, zinc amino acid complex, zinc salt, zinc (II) salt, zinc glycinate, zinc carbonate, zinc chloride, hydrated zinc chloride, anhydrous zinc chloride, zinc citrate, zinc EDTA, zinc chelate of ethylenediaminetetraacetic acid, zinc ferrite, mixture of zinc and iron oxide, zinc frits, zinc glucoheptonate, zinc (II) gluconate, zinc humate, zinc IDS, chelate of iminodisuccinic acid, iminodisuccinic acid, zinc lignosulfonate, zinc EAHP, chelate of any soluble zinc salt and ethanol, 2-amino-2-hydroxy-1,2,3-propanetricarboxylate, zinc nitrate, zinc NTA, zinc chelate of nitrilotriacetic acid, acetic acid, zinc oxide, zinc oxysulfate, zinc polysaccharide, organic compound of zinc with polysaccharide long chain carbohydrate, zinc sucrate, organic complex of zinc (II) with a short chain monosaccharide aldehyde-type reducing sugar, organic complex of zinc (II) with a short chain disaccharide aldehyde-type reducing sugar, zinc sulfate, hydrated zinc sulfate, anhydrous zinc sulfate, and zinc-ammonia complex (zinc ammonia complex).

In some embodiments, the nutrient may be a beneficial substance including a MULTINUTRIENT, basalt, biochar, compost, compost extract, insect frass, marine evaporate, organic matter extract, polyhalite, BENEFICIAL SUBSTANCES OR COMPOUND, aluminum sulfate, aluminum salt, calcium silicate, wollastonite, calcium magnesium silicate, hydrophobic fulvic acid, DAX-8 resin, potassium silicate, sodium silicate, uncalcined diatomaceous earth, volcanic ash, OTHER SUBSTANCES, chelate, chelated plant nutrient, chelating agent, EDTA, ethylenediamineteracetic acid, NTA, nitrilo-triacetic acid, IDS, iminodisuccinic acid, DMPSA, 2-(3,4-dimethyl-1H-pyrazol-1-yl) succinic acid, 2-(4,5-dimethyl-1H-pyrazol-1-yl) succinic acid, 3,4-dimethylpyrazole succinic, duromide, hydrogel, Maleic-Itaconic Copolymer Ammonium Salt, Maleic-Itaconic Copolymer Calcium Salt, Maleic-Itaconic Copolymer Sodium Salt, N-(n-butyl) thiophosphoric triamide (NBPT), N-(n-propyl) thiophosphoric triamide (NBPT), Nitrapyrin [2-chloro-6-trichloromethyl) pyridine], nitrification inhibitor, nitrogen stabalizer, polyacrylamide, polyhalite, pronitridine, urease inhibitor, zeolites, trinexapac-ethyl, nitrobenzene, stearyl alcohol, succinic acid, malic acid, butyric acid, mannitol, perlite, and Hydrolysate of, Hydrolyzed extract of, Digestate of, Digested extract of, Fermented, Fermented extract of the following list (alfalfa, blood, bone, bonito fish, brewers grain, canola, cod fish, corn, cottonseed, cricket, distillers grain, feather, fish, garbage, grain, hoof and horn, insect, kapok, kelp, larvae, mackerel fish, manure, mealworm, meat, oilseed, rapeseed, sardine fish, sewage, sewage, soy, soy protein concentrate, soy protein isolate, cruciferin, napin, tobacco stem, wheat middling, whey, white fish, wool waste, worm, or zean) in solution or dried, Kelp, algae, alignate, ascophyllum nodosum, brown algae, durvillaea potatorum, laminarin, red algae extract, seaweed, seaweed extract, ulva, Algae, caulerpa racemosaon, eukaryotic microalgae, microalgae, sargassum wightii, turbinaria ornate, Alginate, alginic acid, algin, sodium alginate (NaC6H7O6), potassium alginate (KC6H7O6), calcium alginate (CaCl2H14O12), Plant Derived Product, alfalfa seed meal, botanical extract, buffer coir, castor pomace, chitin, cocoa shell meal, cocoa tankage, coir, corn steep liquor powder, corn hydrolysate, cottonseed meal, de-oiled mustard seed meal, forest products, oilseed extract, plant derived hydrolysate, seed meal, soy hydrolysate, soy meal, soybean meal, sphagnum peat moss, starch, tung pomace, rapeseed hydrolysate, canola hydrolysate, fermented oilseed extract, Sugar, Dextrose, Sucrose, Lactose, Fructose, Molasses, Agave Nectar, Barley Malt Syrup, Black Strap Molasses, Brown Rice Syrup, Brown Sugar, Cane Juice, Cane Molasses, Cane Sugar, Coconut Sugar, Corn Syrup, Corn Syrup Solid, Dried Molasses, Evaporated Cane Juice, Evaporated Corn Sweetener, Fermented Molasses, High Fructose Corn Syrup, Honey, Invert Sugar, Malt Syrup, Maltodextrin, Maple Syrup, micronized molasses, Molasses Powder, Palm Sugar, Raw Sugar, Rice Syrup, Silicon Dioxide, Soy Lecithin, Sugar beet molasses, Sugarcane molasses, Sulfured molasses, Sweet sorghum syrup, Turbinado Sugar, Unsulfured Cane Molasses, Unsulfured molasses, Unsulphered blackstrap molasses, Wheat Starch, White Granulated Sugar, Polysaccharide, Cellulose, Glycogen, Starch, Inulin, Hyaluronic Acid, Heparin, Chondroitin-4-sulfate, Gamma globulin, Animal Product, animal based hydrolysate, animal substance, bat Guano, biosolid, digestate, biosolids digestate, bird guano, blood meal, bone meal, casein hydrolysate, chitosan, cow manure digestate, anaerobic or aerobic microbial digestate, egg powder, feathermeal, fish hydrolysate, guano, lanolin, manure, mayonnaise, meat meal, seabird guano, sewage, vermicompost, vermicompost extract, worm casting, Mined Product, gypsum, clay, rock phosphate, lime, dolomitic lime, hydrated lime, silica, silicic acid, monosilicic acid (H4SiO4), slate, gelatin, and glauconite.

In some embodiments, the biostimulant may be an enzyme or other substance including an enzymatic extract, Phosphatase, PAH1, PAH2, Chitinase, Protease, cellulase, isochorismate synthase, phenylalanine ammonia-lyase, Isopropyl-β-D-Thiogalactopyranoside, lysozyme, Macerozyme, Pectinase, Zeatin reductase, discadenine synthase, NO synthase, nitrite reductase, nitrate reductase, mitochondrial cytochrome c oxidase, gibberellin 2-oxidase, gibberellin oxidase, gibberellin oxidase, lactonase, BamHI restriction enzyme, terpene synthases (TPSs), cytochrome P450 monooxygenases (P450s), and 2-oxoglutarate-dependent dioxygenases (2ODDs), PALs, BA2H, and ICS1/2.

In some embodiments, the biostimulant may be an amino acid or other substance including protein, protein hydrolysate, Alanine, Amino Acids Protein Hydrolysate, Arginine, Asparagine, Aspartic Acid, barnase, Betaines, Carboxyl group, Cysteine, DELLA protein, Glutamic acid, Glutamine, Glycine, glycine betaine, Histidine, Hydroxyproline, Isoleucine, L-Alanine, L-Argine, L-Aspartic Acid, L-Cystine, Leucine, L-Glutamic Acid, L-Glutamic Acid, L-Glycine, L-Glycine, L-Histidine, L-Isoleucine, L-Leucine, L-Lysine, L-Methionine, L-Phenylalanine, L-Proline, L-Serine, L-Threonine, L-Tryptophan, L-Tyrosine, L-Valine, Lysine, Methionine, Phenylalanine, Proline, Serine, Threonine, Trimethylglycine, Tryptophan, Tyrosine, and Valine.

In some embodiments, the biostimulant may be a hormone or other substance including ABSCISIC ACID; (2Z,4E)-5-[(1S)-1-Hydroxy-2,6,6-trimethyl-4-oxocyclohex-2-en-1-yl]-3-methylpenta-2,4-dienoic acid[3]; (2Z,4E)-(S)-5-(1-Hydroxy-2,6,6-trimethyl-4-oxo-2-cyclohexen-1-yl)-3-methyl-2,4-pentanedienoic acid; Dormic acid; Dormin, SALICYLIC ACID, 2-Hydroxybenzoic acid[1], Nitric oxide, Oxidonitrogen(·)[2] (additive), Nitrogen oxide, Nitrogen monoxide, Nitrogen(II) oxide, Oxonitrogen, Karrikin, KAR1, KAR2, KAR3, KAR4, KAR5 and KAR6, Triacontanol, melissyl alcohol, myricyl alcohol, Triacontan-1-ol, 1-Triacontanol, n-Triacontanol, ETHYLENE, Dihydrozeatin, Brassinolide, (22R,23R)-2α,3α,22,23-Tetrahydroxy-6,7-seco-5α-campestano-6,7-lactone, (1R,3a S,3b S,6aS,8 S,9R,10aR,10b S,12aS)-1-[(2S,3R,4R,5S)-3,4-Dihydroxy-5,6-dimethylheptan-2-yl]-8,9-dihydroxy-10a,12a-dimethylhexadecahydro-6H-indeno[4,5-d][2]benzoxepin-6-one, 2,3,22,23-Tetrahydroxy-β-homo-7-oxaergostan-6-one, Isobutylamine, 2-Methylpropan-1-amine, Ortho-Topolin, Meta-Methoxytopolin, 1-Methylcyclopropene, cycloalkene, Ortho-Methoxytopolin, carotenoid derivates, 2,4,5-Trichlorophenoxyacetic Acid Potassium Salt, 2,4-dichlorophenoxyacetic acid (2,4-D), 2,4-Epibrassinolide, 4-Aminobenzoic Acid, para-Aminobenzoic acid, p-Aminobenzoic acid, PABA, Vitamin B10, Vitamin Bx, Bacterial vitamin H1, 4-Iodophenoxyacetic Acid, Acetosyringone, 1-(4-Hydroxy-3,5-dimethoxyphenyl)ethan-1-one, Adenine Sulfate, Adenine, 9H-Purin-6-amine, 6-Aminopurine, Ancymidol, Carbenicillin Disodium Salt, Cefotaxime Sodium Salt, Daminozide, 4-(2,2-Dimethylhydrazin-1-yl)-4-oxobutanoic acid, N-(Dimethylamino)succinamic acid; Butanedioic acid mono (2,2-dimethyl hydrazine); Succinic acid 2,2-dimethyl hydrazide, Flurprimidol, Iodoacetamide, 2-Iodoacetamide, Iodoacetic Acid Sodium Salt, Oryzalin, Phloroglucinol, Benzene-1,3,5-triol, phloroglucine, 1,3,5-benzenetriol, 1,3,5-trihydroxybenzene or cyclohexane-1,3,5-trione, Thidiazuron, Amiprophos Methyl, Duchefa Thidiazuron, Epibrassinolide, Myo-Inositol, (1R,2S,3r,4R,5S,6s)-Cyclohexane-1,2,3,4,5,6-hexol, cis-1,2,3,5-trans-4,6-Cyclohexanehexol, Cyclohexanehexol, Mouse antialopecia factor, Nucite, Phaseomannite, Phaseomannitol, Scyllite (for the isomer scyllo-inositol), Vitamin B8, Putrescine dihydrochloride, Spermidine trihydrochloride, Spermine, N1,N4-Bis(3-aminopropyl)butane-1,4-diamine, ATONIK Compound Sodium Nitrophenolate, N6-(delta 2-Isopentenyl)-adenine, Maleic Hydrazide, 1,2-dihydropyridazine-3,6-dione, Propyl Dihydrojasmonate, Prohexadione Calcium, 1-methylcyclopropene, Thidiazuron, Paclobutrazol, (2RS,3RS)-1-(4-chlorophenyl)-4,4-dimethyl-2-(1,2,4-triazol-1-yl)pentan-3-ol, Naphthalene, 2-Naphthoxyacetic Acid, 1-Naphthylacetic Acid, Forchlorfenuron CPPU KT-30, Forchlorfenuron CPPU, Forchlorfenuron, Catecholamine, Triazole, Capsaicin, Chorismate, Phenylalanine, Isochorismate, Cinnamate, Ortho-courmarate, Benzoic acid, Salicylic acid, WOX5, STRIGOLACTONE, synthetic SL analog GR24, 5-Deoxy strigol, 4-Deoxyorobanchol, Strigol, Orobanchol, Carlactone, Sorgomol, Sorgolactone, 2-Epiorobanchol, Solanacol, Strigyl acetate, Fabacyl acetate, 7-Oxoorobanchol, GR245DS, GR24ent-5DS, GR244DO, GR24ent-4DO, BRASSINOSTEROID, polyhydroxy steroid, Extract from the plant Lychnis viscaria, 24-Epibrassinolide (EBL), 28-homo-brassinolide, isolate from Aegle marmelos Correa (Rutaceae), campesterol, (22R, 23R, 24S)-2α-3α, 22, 23-tetrahydroxy-24-methyl-6, 7-s-5α-cholestano-6, 7-lactone, 24-epibrassinolide (24-epiBL), Sitosterol, JASMONATE, jasmonic acid, Jasmonic acid methyl ester, Putrescine Dihydrochloride, Spermidine, Methyl dihydrojasmonate, Methyl Jasmonate, Jasmonoyl-isoleucine, Coronatine, 18-amino-acid peptide signal systemin, GIBBERELLIN, terpene, (3S,3aS,4S,4aS,7S,9aR,9bR,12S)-7,12-Dihydroxy-3-methyl-6-methylene-2-oxoperhydro-4a,7-methano-9b,3-propenoazuleno[1,2-b]furan-4-carboxylic acid, 4-Iodo 3-Dehydro Gibberellic Acid, Biotin-Linked Polyclonal Antibody to Gibberellic Acid (GA), BSA Conjugated Gibberellic Acid (GA), ent-Gibberellane, ent-Kaurene, ent-kaurenoic acid, GA1, GA2, GA3, GA3 extracted from Gibberella fujikuroi fungus, GA4, GA5, GA6, GA7, GA8, GA9, GA10, GA11, GA12, GA13, GA14, GA15, GA16, GA17, GA18, GA19, GA20, GA21, GA22, GA23, GA24, GA25, GA26, GA27, GA28,GA29, GA30, GA31, GA32, GA33, GA34, GA35, GA36, GA37, GA38, GA39, GA40, GA41, GA42, GA43, GA44, GA45, GA46, GA47, GA48, GA49, GA50, GA51, GA52, GA53, GA54, GA55, GA56, GA57, GA58, GA59, GA60, GA61, GA62, GA63, GA64, GA65, GA66, GA67, GA68, GA69, GA70, GA71, GA72, GA73, GA74, GA75, GA76, GA77, GA78, GA79, GA80, GA81, GA82, GA83, GA84, GA85, GA86, GA87, GA88, GA89, GA90, GA91, GA82, GA93, GA94, GA95, GA96, GA97, GA98, GA99, GA100, GA101, GA102, GA103, GA104, GA105, GA106, GA107, GA108, GA109, GA110, GA111, GA112, GA113, GA114, GA115, GA116, GA117, GA118, GA119, GA120, GA121, GA122, GA123, GA124, GA125, GA126, GA127, GA128,GA129, GA130, GA131, GA132, GA133, GA134, GA135, GA136, GA137, GA138, GA139, GA140, GA141, GA142, GA143, GA144, GA145, GA146, GA147, GA148, GA149, GA150, GA151, GA152, GA153, GA154, GA155, GA156, GA157, GA158, GA159, GA160, GA161, GA162, GA163, GA164, GA165, GA166, GA167, GA168, GA169, GA170, GA171, GA172, GA173, GA174, GA175, GA176, GA177, GA178, GA179, GA180, Gibberellic Acid, Gibberellic acid [77-06-5], Gibberellic Acid A3 [77-06-5], Gibberellic Acid A3 [GA3] [56-81-5], Gibberellic Acid A3, HPLC Grade [77-06-5], Gibberellic Acid Acetate, Gibberellic Acid Acetate [7648-02-4], Gibberellic Acid Acetoxymethyl Ester, Gibberellic acid methyl ester, Gibberellic Acid Methyl Ester [510-50-9], Gibberellic Acid Methyl Ester 2-p-Toluenesulfonate, Gibberellic Acid Methyl Ester 2-p-Toluenesulfonate [35413-59-3], Isogibberellic Acid, Isogibberellic Acid [19123-67-2], OVA Conjugated Gibberellic Acid (GA), Polyclonal Antibody to Gibberellic Acid (GA), Steviol, GIBBERELLIN INHIBITOR, Ancymidol, Chlormequat, Chlormequat chloride (CCC), Paclobutrazol (PBZ), Prohexadione-Calcium, Uniconazole, AUXIN, 1-naphthaleneacetic acid, 2,4,5-trichlorophenoxyacetic acid (2,4,5-T), 2,4-dichlorophenoxyacetic acid (2,4-D), 3,6-dichloro-2-methoxybenzoic acid, 4-Amino-3,5,6-trichloropicolinic acid, 4-Amino-3,5,6-trichloropyridine-2-carboxylic acid, 4-chloroindole-3-acetic acid, Dicamba, indole acetamine, Indole butyric acid, indole-3-acetaldehyde, indole-3-acetaldoxime, indole-3-acetic acid, indole-3-acetonitrile, indole-3-butyric acid, Indole-3-Butyric Acid Potassium Salt, Indole-3-Carboxylic Acid, indole-3-propionic acid, indole-3-pyruvic acid, indolebutyric acid, methyl-IAA, Naphthaleneacetic Acid Potassium Salt, p-Chlorophenoxyacetic acid (4-CPA), phenoxyacetic acid, phenylacetic acid, Picloram, ß-indolylacetic acid, Trp-dependent indole-3-acetic acid, CYTOKININ, 4-CPPU, 6-(4-hydroxy-3-methylbut-trans2-enylamino)-purine, 6-Benzyladenine, 6-benzylaminopurine, 6-Benzylaminopurine Riboside, 6-Dimethylallylaminopurine, 6-Dimethylallylaminopurine Riboside, Adenine-type cytokinin, cis Zeatin, Dihydrozeatin (DHZ), Diphenylurea, Kinetin, meta-topolin, N6-(D2-Isopentenyl)Adenine, N6-dimethlaminopurine, N6-furfuryladenine 6KT Kinetin, N6-isopentenylaminopurine, N6-methylaminopurine, Phenylurea-type cytokinin, Thidiazuron, trans-zeatin, trans-Zeatin Riboside, Zeatin, isopentenyladenine (iP), isopentenyladenine tZ, Adenine-type cytokinin, Nucleoside-type cytokinin, Nucleotide-type cytokinin, Phenylurea-type cytokinin, “6-BA, 6-benzyl adenine; DPU, diphenylurea; iP, N6-(42-isopentenyl)-adenine; iPR, iP riboside; iPRDP, iP riboside, 5′-diphosphate; iPRMP, iP riboside 5′-monophosphate; iPRTP, iP riboside 5′-triphosphate; KT, kinetin; TDZ, thidiazuron; tPRDP, trans-zeatin-diphosphate; tPRTP, trans-zeatin-triphosphate; tZ, trans-zeatin; tZR, trans-zeatin riboside; tZRMP, trans-zeatin-riboside 5′-monophosphate.”, PEPTIDE, Polypeptide, glutathione, TRH, Angiotensin II, Bradykinen, Oxytocin, Somatostatin, Endothelin, Melittin, Glucagon, Insulin, peptide CLE25, Arabidopsis peptide, Phytosulfokine, Systemin, TomHypSysI, TomHypSysII, TomHypSysIII, TobHypSysI, TobHypSysII, RALF, AtPep1, POLARIS, PSK α, PSK β, 4 KD peptide, PSY1, CLV3, FON4, CLE40, TDIF/CLE41/44, RGF1/CLEL8/GLV11, CEP1, GrCLE1, GmRIC1, GmRIC2, MtCLE12, MtCLE13, ENOD40, EPF 1, EPF 2, CHAL/EPFL6, STOMAGEN, EPFL4, EPFL6/CHAL, IDA, CLE45, EPFL2, GAD1, TPD1, CLE8, CLE19, SCR/SP11, LURE, Chemocyanin, SCAs, CLE45, EC1, ESF1, POLYAMINES, Alkyl polyamine, Spermidine, Diethylenetriamine, Triethylenetetramine, Macrocyclic polyamine, Tris(2-aminoethyl)amine, caffeine, 1,3,7-Trimethylpurine-2,6-dione, Cannabinoid, phytocannabinoid tetrahydrocannabinol (THC) (Delta9-THC or Delta8-THC), Cannabidiol (CBD), THC (delta-9-tetrahydrocannabinol), Tetrahydrocannabinol (THC), Theophylline, Theobromine, and L-theanine.

In some embodiments, the biostimulant may be a vitamin or other substance including Antioxidant, Vitamin A, Vitamin B, Niacin, Folate, Folic acid, Thiamin, Riboflavin, Pantothenic acid, Biotin, B1, B6, B12, Vitamin C, Vitamin D, Vitamin E, Vitamin K, beta-carotene, lutein, lycopene, and selenium.

In some embodiments, the biostimulant may be an organic acid or other substance including carbonaceous shale, citric acid, complex organic mixture, fulvic acid, humalite, humate, humic acid, humic shale, humic substance, humin, humus, leonardite, oxidized lignite, oxidized subbituminous coal, peat, phosphorous acid, and sapropel.

In some embodiments, the biostimulant may be a fatty acid, lipid, or other substance including FATTY ACID, Arachidonic acid, Docosahexaenoic acid, Eicosapentaenoic acid, linoleic, Linolenic acid, Oleic acid, Palmitic acid, Stearic acid, α-linolenic, LIPID, triacylglycerol, phospholipid, and sterol.

In some embodiments, the biostimulant may be a phenol, polyphenol, or other substance including Orthophenyl phenol, butylated hydroxytoluene, 4-Nonylphenol, Phenolphthalein, Xylenol, Flavonoid, Anthocyanidin, aglycones of anthocyanin, Cyanidin, Delphinidin, Malvidin, Pelargonidin, Peonidin, Petunidin, Anthoxanthin, Flavone, 2-phenylchromen-4-one, Luteolin, Apigenin, Tangeritin, Flavonol or 3-hydroxyflavone, 3-hydroxy-2-phenylchromen-4-one, Quercetin, Kaempferol, Myricetin, Fisetin, Galangin, Isorhamnetin, Pachypodol, Rhamnazin, Pyranoflavonols, Furanoflavonols, Flavanone, 2,3-dihydro-2-phenylchromen-4-one, Hesperetin, Naringenin, Eriodictyol, Homoeriodictyol, Flavanonol, Flavanonol or 3-Hydroxyflavanone or 2,3-dihydroflavonol, 3-hydroxy-2,3-dihydro-2-phenylchromen-4-one, Taxifolin (or Dihydroquercetin), Dihydrokaempferol, Flavan, flavan-3-ols (flavanols), flavan-4-ols and flavan-3,4-diols., Catechin (C), Gallocatechin (GC), Catechin 3-gallate (Cg), Gallocatechin 3-gallate (GCg), Epicatechins (Epicatechin (EC)), Epigallocatechin (EGC), Epicatechin 3-gallate (ECg), Epigallocatechin 3-gallate (EGCg), Theaflavin-3-gallate, Theaflavin-3′-gallate, Theaflavin-3,3′-digallate, Thearubigin, Proanthocyanidins are dimers, trimers, oligomers, or polymers of the flavanol, Isoflavonoid, Genistein, Daidzein, Glycitein, Isoflavanes, Isoflavandiols, Isoflavenes, Coumestans, Pterocarpans, quercetin, kaempferol, catechin, anthocyanin, Phenolic acid, phenol carboxylic acid, hydroxybenzoic acid, 2-Hydroxybenzoic acid (salicylic acid, o-hydroxybenzoic acid), 3-Hydroxybenzoic acid (m-hydroxybenzoic acid), 4-Hydroxybenzoic acid (p-hydroxybenzoic acid), p-Hydroxybenzoic acid glucoside, Methylparaben (Methyl-p-hydroxybenzoic acid), Dihydroxybenzoic acid, 2,3-Dihydroxybenzoic acid (Hypogallic acid); 2,4-Dihydroxybenzoic acid; 2,5-Dihydroxybenzoic acid (Gentisic acid); 2,6-Dihydroxybenzoic acid; 3,4-Dihydroxybenzoic acid (Protocatechuic acid); 3,5-Dihydroxybenzoic acid, Ethyl protocatechuate; Orsellinic acid, Trihydroxybenzoic acid, Gallic acid; Phloroglucinol carboxylic acid, Bergenin; Norbergenin; Theogallin; Chebulic acid, Ethyl gallate; Eudesmic acid; Methyl gallate; Syringic acid, Phenolic acid, benzoic acid; cinnamic acid, 3,4-dihydroxy benzoic acid, p-hydroxy benzoic acid, vanillic acid, caffeic acid, p-coumaric acid, ferulic acid, syringic acid, sinapinic acid, phenylpropanoids, α-Cyano-4-hydroxycinnamic acid, Cichoric acid, Cinnamic acid, Chlorogenic acid, Diferulic acids, Coumaric acid, Sinapinic acid (3,5-dimethoxy-4-hydroxycinnamic acid or sinapic acid), Caftaric acid, Coutaric acid, Fertaric acid, stilbenes, lignan, Polyphenolic amide, capsaicinoid, avenanthramide, resveratrol, ellagic acid, and curcumin.

In some embodiments, the biostimulant may be an allelochemical, alkaloid, tannin, lactone, quinone, steroid, carotenoid, or other substance including ALLELOCHEMICALS; Semiochemical; Phytochemical; Allomone; 9-hydroxy-4,7 megastigmadien-9-one; amphotericin B; antibiotic; ascorbic acid; avermectin; benzoic acid; benzoquinone; Bialaphos; carotenoid; Cineole; cinnamic acid; coumarin; cyanohydrin; erythromycin; glycoside; kairomone; kavain; ketone; leptospermone; macrolide; mesotrione; pheromone; phytoestrogen; polyacetylene; sorgoleone; ALKALOIDS; nicotine and anabasine; aporphine alkaloid liriodenine; serotonin, dopamine and histamine; TANNINS; Gallic acid; Phloroglucinol; Flavan-3-ol's scaffold; Hydrolyzable tannin; Phlorotannins; Condensed tannins and Phlobatannins (C-ring isomerized condensed tannin); tannic acid; ellagitannin; Castalagin; Castalin; Casuarictin; Grandinin; Roburin A; Tellimagrandin II; Terflavin B; Vescalagin; Pomegranate ellagitannin; Punicalagin; Punicalin; LACTONES; unsaturated lactone; nepetalactone; spironolactone; mevalonolactone; gluconolactone; butyrolactone; resorcylic acid lactone; macrolactone; Dilactone; QUINONES; Plastoquinone; Pyrroloquinoline quinone; Malbranchea cinnamomea; benzoquinone blattellaquinone; STEROIDS; Δ5-Avenasterol, Δ7-Avenasterol, Δ7-Stigmasterol; brassicasterol; brassinosteroid; campesterol; cholesterol; cycloartenol; ergosterol; Gonane and Sterane; Lanosterol and cycloartenol; lupeol; phytosterol; stanol; sterol; stigmastanol; stigmasterol; β-Sitosterol; CAROTENOIDS; Hydrocarbon; Lycopersene 7,8,11,12,15,7′,8′,11,12′,15′-Decahydro-γ,γ-carotene; Phytofluene; Lycopene; Hexahydrolycopene 15-cis-7,8,11,12,7′,8′-Hexahydro-γ,γ-carotene; Torulene 3′,4′-Didehydro-β,γ-carotene; α-Zeacarotene 7′,8′-Dihydro-ε,γ-carotene; α-Carotene; β-Carotene; γ-Carotene; δ-Carotene; ε-Carotene; ζ-Carotene; Alcohol; Alloxanthin; Bacterioruberin 2,2′-Bis(3-hydroxy-3-methylbutyl)-3,4,3′,4′-tetradehydro-1,2,1′,2′-tetrahydro-γ,γ-carotene-1,1′-diol; Cynthiaxanthin; Pectenoxanthin; Cryptomonaxanthin (3R,3′R)-7,8,7′,8′-Tetradehydro-β,β-carotene-3,3′-diol; Crustaxanthin β,-Carotene-3,4,3′,4′-tetrol; Gazaniaxanthin (3R)-5′-cis-β,γ-Caroten-3-ol; OH-Chlorobactene 1′,2′-Dihydro-f,γ-caroten-1′-ol; Loroxanthin β,ε-Carotene-3,19,3′-triol; Lutein (3R,3′R,6′R)-β,ε-carotene-3,3′-diol; Lycoxanthin γ,γ-Caroten-16-ol; Rhodopin 1,2-Dihydro-γ,γ-caroten-1-ol; Rhodopinol a.k.a. Warmingol 13-cis-1,2-Dihydro-γ,γ-carotene-1,20-diol; Saproxanthin 3′,4′-Didehydro-1′,2′-dihydro-β,γ-carotene-3,1′-diol; Zeaxanthin; Glycoside; Oscillaxanthin 2,2′-Bis((3-L-rhamnopyranosyl oxy)-3,4,3′,4′-tetradehydro-1,2, l′,2′-tetrahydro-γ,γ-carotene-1,1′-diol; Phleixanthophyll 1′4(3-D-Glucopyranosyloxy)-3′,4′-didehydro-1′,2′-dihydro-β,γ-caroten-2′-ol; Ether; Rhodovibrin 1′-Methoxy-3′,4′-didehydro-1,2,1′,2′-tetrahydro-γ,γ-caroten-1-ol; Spheroidene 1-Methoxy-3,4-di dehydro-1,2,7′,8′-tetrahydro-γ,γ-carotene; Epoxide; Diadinoxanthin 5,6-Epoxy-7′,8′-di dehydro-5,6-dihydro-carotene-3,3-diol; Luteoxanthin 5,6:5′,8′-Diepoxy-5,6,5′,8′-tetrahydro-β,β-carotene-3,3′-diol; Mutatoxanthin; Citroxanthin; Zeaxanthin furanoxide 5,8-Epoxy-5,8-dihydro-β,β-carotene-3,3′-diol; Neochrome 5′,8′-Ep oxy-6,7-didehydro-5,6,5′,8′-tetrahydro-β,β-carotene-3,5,3′-triol; Foliachrome; Trollichrome; Vaucheriaxanthin 5′,6′-Epoxy-6,7-didehydro-5,6,5′,6′-tetrahydro-β,β-carotene-3,5,19,3′-tetrol; Aldehyde; Rhodopinal; Warmingone 13-cis-1-Hydroxy-1,2-dihydro-γ,γ-caroten-20-al; Torularhodinaldehyde 3′,4′-Didehydro-β,γ-caroten-16′-al; Acid and acid ester Torularhodin 3′,4′-Didehydro-β,γ-caroten-16′-oic acid; Torularhodin methyl ester Methyl 3′,4′-didehydro-β,γ-caroten-16′-oate; Ketone; Astacene; Astaxanthin; Canthaxanthin[61] a.k.a. Aphanicin, Chlorellaxanthin β,β-Carotene-4,4′-dione; Capsanthin (3R,3'S,5′R)-3,3′-Dihydroxy-β,κ-caroten-6′-one; Capsorubin (3 S,5R,3'S,5′R)-3,3′-Dihydroxy-κ,κ-carotene-6,6′-dione Cryptocapsin (3 ‘R,5′R)-3’-Hydroxy-β,κ-caroten-6′-one; 2,2′-Diketospirilloxanthin 1,1′-Dimethoxy-3,4,3′,4′-tetradehydro-1,2,1′,2′-tetrahydro-γ,γ-carotene-2,2′-dione; Echinenone β,β-Caroten-4-one; 3′-Hydroxy echinenone; Flexixanthin 3,1′-Dihydroxy-3′,4′-didehydro-1′,2′-dihydro-β,γ-caroten-4-one; 3-OH-Canthaxanthin a.k.a. Adonirubin a.k.a. Phoenicoxanthin 3-Hydroxy-β,β-carotene-4,4′-dione; Hydroxyspheriodenone 1′-Hydroxy-1-methoxy-3,4-didehydro-1,2,1′,2′,7′,8′-hexahydro-γ,γ-caroten-2-one; Okenone 1′-Methoxy-1′,2′-dihydro-c,γ-caroten-4′-one Pectenol one 3,3′-Dihydroxy-7′,8′-didehydro-β,β-caroten-4-one; Phoeniconone a.k.a. Dehydroadonirubin 3-Hydroxy-2,3-didehydro-β,β-carotene-4,4′-dione; Phoenicopterone β,ε-Caroten-4-one Rubixanthone 3-Hydroxy-β,γ-caroten-4′-one; Siphonaxanthin 3,19,3′-Trihydroxy-7,8-dihydro-β,ε-Caroten-8-one; Ester of alcohols; Astacein 3,3′-Bispalmitoyloxy-2,3,2′,3′-tetradehydro-β,β-carotene-4,4′-dione or 3,3′-dihydroxy-2,3,2′,3′-tetradehydro-β,β-carotene-4,4′-dione dipalmitate; Fucoxanthin 3′-Acetoxy-5,6-ep oxy-3,5′-dihydroxy-6′,7′-didehydro-5,6,7,8,5′,6′-hexahydro-0,0-caroten-8-one; Isofucoxanthin 3 ‘-Acetoxy-3,5,5’-trihydroxy-6′,7′-di dehydro-5,8,5′,6′-tetrahydro-0,0-caroten-8-one; Physalien; Siphonein 3,3′-Dihydroxy-19-lauroyl oxy-7,8-dihydro-β,ε-caroten-8-one or 3,19,3′-trihydroxy-7,8-dihydro-0,6-caroten-8-one 19-laurate; Apocarotenoid; β-Apo-2′-carotenal 3′,4′-Didehydro-2′-apo-b-caroten-2′-al; Apo-2-lycopenal; Apo-6′-lycopenal 6′-Apo-γ-caroten-6′-al; Azafrinaldehyde 5,6-Dihydroxy-5,6-dihydro-10′-apo-β-caroten-10′-al; Bixin 6′-Methyl hydrogen 9′-cis-6,6′-diapocarotene-6,6′-dioate; Citranaxanthin 5′,6′-Dihydro-5′-apo-β-caroten-6′-one or 5′,6′-dihydro-5′-apo-18′-nor-β-caroten-6′-one or 6′-methyl-6′-apo-β-caroten-6′-one; Crocetin 8,8′-Diapo-8,8′-carotenedioic acid; Crocetinsemialdehyde 8′-Oxo-8,8′-diapo-8-carotenoic acid; Crocin Digentiobiosyl 8,8′-di apo-8,8′-carotenedioate; Hopkinsiaxanthin 3-Hydroxy-7,8-di dehydro-7′,8′-dihydro-7′-apo-b-carotene-4,8′-dione or 3-hydroxy-8′-methyl-7,8-di dehydro-8′-apo-b-carotene-4,8′-dione; Methyl apo-6′-lycopenoate Methyl 6′-apo-y-caroten-6′-oate; Paracentrone 3,5-Dihydroxy-6,7-didehydro-5,6,7′,8′-tetrahydro-7′-apo-b-caroten-8′-one or 3,5-dihydroxy-8′-methyl-6,7-didehydro-5,6-dihydro-8′-apo-b-caroten-8′-one; Sintaxanthin 7′,8′-Dihydro-7′-apo-b-caroten-8′-one or 8′-methyl-8′-apo-b-caroten-8′-one; Nor- and seco-carotenoids; Actinioerythrin 3,3′-Bisacyloxy-2,2′-dinor-b,b-carotene-4,4′-dione; β-Carotenone 5,6:5′,6′-Diseco-b,b-carotene-5,6,5′,6′-tetrone; Peridinin 3′-Acetoxy-5,6-epoxy-3,5′-dihydroxy-6′,7′-didehydro-5,6,5′,6′-tetrahydro-12′,13′,20′-trinor-b,b-caroten-19,11-olide; Pyrrhoxanthininol 5,6-epoxy-3,3′-dihydroxy-7′,8′-didehydro-5,6-dihydro-12′,13′,20′-trinor-b,b-caroten-19,11-olide Semi-α-carotenone 5,6-Seco-b,e-carotene-5,6-dione; Semi-β-carotenone 5,6-seco-b,b-carotene-5,6-dione or 5′,6′-seco-b,b-carotene-5′,6′-dione; Triphasiaxanthin 3-Hydroxysemi-b-carotenone 3′-Hydroxy-5,6-seco-b,b-carotene-5,6-dione or 3-hydroxy-5′,6′-seco-b,b-carotene-5′,6′-dione; Retro-carotenoids and retro-apo-carotenoid; Eschscholtzxanthin 4′,5′-Didehydro-4,5′-retro-b,b-carotene-3,3′-diol; Eschscholtzxanthone 3′-Hydroxy-4′,5′-didehydro-4,5′-retro-b,b-caroten-3-one; Rhodoxanthin 4′,5′-Didehydro-4,5′-retro-b,b-carotene-3,3′-dione; Tangeraxanthin 3-Hydroxy-5′-methyl-4,5′-retro-5′-apo-b-caroten-5′-one or 3-hydroxy-4,5′-retro-5′-apo-b-caroten-5′-one; Higher carotenoid; Nonaprenoxanthin 2-(4-Hydroxy-3-methyl-2-butenyl)-7′,8′,11′,12′-tetrahydro-e,y-carotene; Decaprenoxanthin 2,2′-Bis(4-hydroxy-3-methyl-2-butenyl)-e,e-carotene; C.p. 450 2-[4-Hydroxy-3-(hydroxymethyl)-2-butenyl]-2′-(3-methyl-2-butenyl)-b,b-carotene; C.p. 473 2′-(4-Hydroxy-3-methyl-2-butenyl)-2-(3-methyl-2-butenyl)-3′,4′-didehydro-1′,2′-dihydro-β,γ-caroten-1′-ol; and Bacterioruberin 2,2′-Bis(3-hydroxy-3-methylbutyl)-3,4,3′,4′-tetradehydro-1,2,1′,2′-tetrahydro-γ,γ-carotene-1,1′-diol.

In some embodiments, the biostimulant may be a microorganism or other substance including Azospirillum amazonense, Azospirillum brasilense, Azospirillum brasilense Sp7 (ATCC 29145), Azospirillum brasilense Sp245, Azospirillum fluorescens, Azospirillum lipoferum, Azotobacter chroococcum, Azotobacter vinelandii, Bradyrhizobium japonicum, Bradyrhizobium japonicum symbiovar genistearum, Bradyrhizobium japonicum symbiovar glycinearum, Rhizobium leguminosarum, Rhizobium leguminosarum strains (ATCC 10004, LMG 14904, 3Hoq18, USDA 2370), Bacillus amyloliquefaciens, Bacillus amyloliquefaciens subsp. amyloliquefaciens, Bacillus amyloliquefaciens subsp. plantarum, Bacillus azotoformans, Bacillus cereus, Bacillus coagulans, Bacillus firmus, Bacillus flexus, Bacillus flexus NJNPD41, Bacillus licheniformis, Bacillus megaterium, Bacillus pasteurii, Bacillus polymyxa, Bacillus polymyxa strains (ATCC 842, CCUG 1086, CFBP 4258, CIP 66.22, DSM 36, HAMBI 635, JCM 2507, LMG 13294, NBRC 15309, NCCB 24016, NCTC 10343, NRRL B-4317, VKM B-514), Bacillus popilliae, Bacillus pumilus, Bacillus safensis, Bacillus sphaericus, Bacillus subtilis, Bacillus subtilis subsp. inaquosorum, Bacillus subtilis subsp. spizizenii, Bacillus subtilis subsp. subtilis, Bacillus subtilis FZB24, Bacillus thuringiensis, Bacillus thuringiensis Btk ATCC 33679, Bacillus thuringiensis Btk HD73, Bacillus velezensis, Burkholderia ambifaria, Funneliformis mosseae, Gluconacetobacter diazotrophicus, Geobacillus stearothermophilus, Geobacillus stearothermophilus Rapid Readout strain, Gibberella fujikuroi, Gibberella. fujikuroi var. subglutinans, Gigaspora margarita, Glomus aggregatum, Glomus aggregatrum, Glomus clarum, Glomus deserticola, Glomus etunicatum, Glomus intraradices, Glomus monosporum, Glomus mosseae, Herbaspirillum lusitanum, Herbaspirillum lusitanum strains (CCUG 48869, CECT 5661, CIP 108242, DSM 17154, LMG 21710, P6-12, P6-12, Valverde P6-12), Herbaspirillum seropedicae, Laccaria bicolor, Laccaria laccata, Laccaria laccata var. laccata, Lactobacillus acidophilus, Lactobacillus casei, Lactobacillus plantarum, Lacticaseibacillus, Lactiplantibacillus, Lactococcus lactis, Lactococcus lactis sub sp. cremoris, Lactococcus lactis subsp. hordniae, Lactococcus lactis subsp. lactis, Lactococcus lactis subsp. lactis by. diacetylactis, Lactococcus lactis subsp. tructae, Mesorhizobium ciceri, Mesorhizobium ciceri strains (ATCC 51585, ATCC 700744, BCRC 15795, CCRC 15795, CECT 4846, CFBP 5557, CIP 104229, DSMZ 11540, HAMBI 1750, IAM 15103, ICMP 13641, JCM 21564, KACC 10646, KCTC 12155, LMG 14989, LMG 17150, NBRC 100389, ORS 2738, UPM-Ca7, USDA 3383), Mycobacterium phlei, Paenibacillus azotofixans, Paenibacillus durum, Paenibacillus polymyxa, Paenibacillus polymyxa strains (ATCC 842, CCUG 1086, CFBP 4258, CIP 66.22, DSM 36, HAMBI 635 and 1897, JCM 2507, LMG 13294, NBRC 15309, NCCB 24016, NCTC 10343, NRRL B-4317, VKM B-514), Pantoea agglomerans, Pantoea agglomerans strains (ATCC 27155, CCUG 539, CDC 1461-67, CFBP 3845, CIP 57.51, DSM 3493, ICPB 3435, ICMP 12534, JCM 1236, LMG 1286, NCTC 9381), Paraglomus brasilianum, Paraglomus occultum, Pisolithus tinctorius, Pseudomonas alcaligenes, Pseudomonas alcaligenes strains (ATCC 14909, CCUG 1425 A, CFBP 2437, CIP 101034, DSM 50342, JCM 5967, LMG 1224, NBRC 14159, NCCB 76044, NCTC 10367, VKM B-2171), Pseudomonas pseudoalcaligenes, Pseudomonas pseudoalcaligenes strains (ATCC 17440, CCUG 51525, CFBP 2435, CIP 66.14, DSM 50188, JCM 5968, LMG 1225, NBRC 14167, NCCB 76045, NCTC 10860), Pseudomonas chlororaphis group, Pseudomonas aureofaciens, Pseudomonas aureofaciens strains (ATCC 13985, CFBP 2133, LMG 1245), Pseudomonas chlororaphis, Pseudomonas chlororaphis strains (ATCC 9446, CCUG 552 B, CFBP 2132, CIP 63.22, DSM 50083, HAMBI 2011, JCM 2778, LMG 5004, NBRC 3904, NCCB 76041 and 37027, NCTC 13002, VKM B-1246), Pseudomonas fluorescens group, Pseudomonas fluorescens, Pseudomonas fluorescens strains (ATCC 13525, CCUG 1253, CCEB 546, CFBP 2102, CIP 69.13, DSM 50090, JCM 5963, LMG 1794, NBRC 14160, NCCB 76040, NCIMB 9046, NCTC 10038, NRRL B-14678, VKM B-894, G20-18), Pseudomonas putida group, Pseudomonas monteilii, Pseudomonas monteilii strains (ATCC 700476, CCUG 38736, CFML 90-60, CIP 104883, DSM 14164, JCM 21585), Pseudomonas putida, Pseudomonas putida strains (ATCC 12633, CCUG 12690, CFBP 2066, DSM 291, HAMBI 7, JCM 13063 and 20120, LMG 2257, NBRC 14164, NCAIM B.01634, NCCB 72006 and 68020, NCTC 10936, PP20), Pseudomonas jessenii, Pseudomonas jessenii CIP 105274, Pseudomonas kilonensis, Pseudomonas kilonensis (PK11), Rhizoglomus aggregatum, Rhizoglomus intraradices, Rhizophagus intraradices, Rhizophagus irregularis, Rhizopogon amylopogon, Rhizopogon amylopogon brunsii, Rhizopogon amylopogon arctostaphyli, Rhizopogon amylopogon kretzerae, Rhizopogon amylopogon salebrosus, Rhizopogon amylopogon pinyonensis, Rhizopogon amylopogon ellenae, Rhizopogon amylopogon subpurpurascens, Rhizopogon fulvigleba, Rhizopogon luteolus, Rhizopogon villosulus, Rhodopseudomonas palustris, Rhodopseudomonas palustris strains (CGA009, DX-1, TIE-1), Rhodopseudomonas sphaeroides, Saccharomyces cerevisiae, Saccharomyces cerevisiae var. boulardii, Saccharomyces cerevisiae hydrolysate, Scleroderma cepa, Scleroderma citrinum, Streptomyces atratus, Streptomyces atratus strains (46408, AS 4.1632, ATCC 14046, CBS 364.68, CGMCC 4.1632, DSM 41673, IFO 3897, JCM 3386, NBRC 3897, NRRL B-16927), Streptomyces aurantiogriseus, Streptomyces aurantiogriseus strains (AS 4.1450, ATCC 19887, ATCC 23883, BCRC 13758, CBS 663.68, CCRC 13758, CGMCC 4.1450, DSM 40138, ETH 24202, ETH 27525, IFO 12842, INA 10369/58, ISP 5138, JCM 4346, KCC S-0346, KCCS-0346, LMG 19298, NBRC 12842, NCIB 9849, NCIMB 9849, NRRL B-5416, NRRL-ISP 5138, R-8658, RIA 1130, VKM Ac-1093), Streptomyces chromofuscus, Streptomyces chromofuscus strains (13638/58, AS 4.1451, ATCC 23896, BCRC 15125, CBS 682.68, CCRC 15125, CGMCC 4.1451, DSM 40273, IFO 12851, INA 13638/58, ISP 5273, JCM 4354, KCC S-0354, KCTC 19069, Lanoot R-8679, LMG 19317, NBRC 12851, NRRL B-12175, NRRL-ISP 5273, R-8679, RIA 1191, VKM Ac-974), Streptomyces cinerochromogenes, Streptomyces cinerochromogenes (strains AS 4.162, ATCC 33339, CGMCC 4.1620, DSM 41651, Fuji 50, IFO 13822, IFO 13922, JCM 3385, NBRC 13822, NBRC 13922, NRRL B-1692, NRRL B-16928, P1), Streptomyces coelicolor, Streptomyces coelicolor strains (AS 4.1291, ATCC 25422, BCRC 13699, CBS 416.34, CBS 920.69, CCRC 13699, CGMCC 4.1291, CIP 105122, DSM 40455, ETH 10209, ICMP 12537, ICSSB 1006, IFO 13010, IMRU 850, IMSNU 20133, IMSNU 21006, ISP 5455, JCM 4446, KCC S-0446, KCC S-0466, KCC S-1072, KCCS-0466, KCTC 9202, Lanoot R-8660, LMG 19300, MTCC 932, NBIMCC 2386, NBRC 13010, NCIB 10043, NCIMB 10043, NRRL B-1271, NRRL B-2663, NRRL B-B-2663, NRRL-ISP 5455, MA 1202, strain ATCC 25422, VKM Ac-746, VTT E-991429), Streptomyces griseoviridis, Streptomyces griseoviridis strains (A 9071, Anderson PD 04955, AS 4.1418, ATCC 23920, BCRC 15101, CBS 904.68, CCRC 15101, CGMCC 4.1418, DSM 40229, ETH 31501, HAMBI 1086, IFO 12874, IMRU 3735, ISP 5229, JCM 4250, JCM 4643, KCC S-0250, KCC S-0643, KCCM 40225, KCCS-0250, KCCS-0643, KCTC 9780, Lanoot R-8683, LMG 19321, NBRC 12874, NCIMB 9853, NRRL 2427, NRRL B-2427 T, NRRL-ISP 5229, P-D 04955, R-8683, RIA 1170, VKM Ac-622), Streptomyces griseus, Streptomyces griseus strains (16S rRNA gene Glade, IFO 13350 strain), Streptomyces hygroscopicus, Streptomyces hygroscopicus subsp. aureolacrimosus, Streptomyces hygroscopicus subsp. Hygroscopicus, Streptomyces hygroscopicus subsp. Ossamyceticus, Streptomyces hygroscopicus subsp. yakushimaensis, Streptomyces janthinus, Streptomyces janthinus strains (ATCC 15870, ATCC 23925, BCRC 12074, CBS 909.68, CCRC 12074, CCT 5008, DSM 4O206, IFO 12879, INMI 117, ISP 5206, JCM 4387, KCC S-0387, LMG 8591, NBRC 12879, NRRL B-3365, NRRL-ISP 5206, RIA 1155, RIA 659, VKM Ac-208), Streptomyces lydicus, Streptomyces lydicus strain WYEC 108, Streptomyces lydicus strains (AS 4.1412, ATCC 25470, BCRC 11919, CBS 703.69, CCRC 11919, CDBB 1232, CECT 3163, CEST 3163, CGMCC 4.1412, D-45, DSM 40461, DSMZ 40461, HAMBI 1063, IFO 13058, IMET 43531, ISP 5461, JCM 4492, KCC S-0492, KCCS-0492, KCTC 9874, Lanoot R-8695, LMG 19331, NBRC 13058, NCIMB 12977, NRRL 2433, NRRL B-2433, NRRL-ISP 5461, R-8695, RIA 1250, Upjohn Co. UC D-45, VKM Ac-1869), Streptomyces rectiverticillatum, Streptomyces rimosus, Streptomyces rimosus S. rimosus paromomycinus, Streptomyces rimosus S. rimosus rimosus, Streptomyces venezuelae, Streptomyces violaceus, Streptomyces violaceus strains (ATCC 15891, ATCC 25516, BCRC 13791, CBS 658.69, CCRC 13791, CCT 5007, CECT 3237, CGMCC 4.1772, DSM 4O2O5, DSMZ 4O2O5, IFO 13104, INMI 1212, ISP 5205, JCM 4534, KCC S-0534, KCCM 40125, KCTC 9788, LMG 20275, NBRC 13104, NIHJ 493, NRRL B-5432, NRRL-ISP 5205, RIA 1296, RIA 157, UNIQEM 204, VKM Ac-528), Streptomyces violascens, Streptomyces violascens strains (ATCC 23968, BCRC 12240, CBS 266.66, CBS 951.68, CCRC 12240, CECT 3215, CGMCC 4.1923, DSM 40183, DSMZ 40183, IFO 12920, IMET 42061, INA 3959/54, ISP 5183, JCM 4424, KCC S-0424, KCCM 4O103, KCCS-0424, KCTC 9785, NBRC 12920, NCIB 9820, NCIMB 9820, NRRL B-2700, NRRL-ISP 5183, RIA 1138, VKM Ac-1275), Streptomyces viridochromeogenes, Streptomyces viridodiasticus, Streptomyces viridodiastaticus, Streptomyces viridodiastaticus strains (ATCC 25518, Baldacci IPV 334a, BCRC 12458, CBS 660.69, CCRC 12458, CGMCC 4.1780, DSM 40249, ETH 24357, IFO 13106, IPV 334 a, ISP 5249, JCM 4536, KCC S-0536, KCTC 19977, LMG 20279, NBRC 13106, NRRL B-5622, NRRL-ISP 5249, RIA 1298, VKM Ac-1749, VTT E-011973), Suillus granulatus, Suillus punctipes, Suillus punctatapies, Trichoderma afroharzianum, Trichoderma alboviride, Trichoderma anaharzianum, Trichoderma anisohamatum, Trichoderma asperellum, Trichoderma atroviride, Trichoderma aureoviride, Trichoderma brunneoviride, Trichoderma caeruleoviride, Trichoderma citrinoviride, Trichoderma gamsii, Trichoderma hamatum, Trichoderma harzianum, Trichoderma harzianum Rifai strains (T22, T-39, Ths97, IBT 9385 [T3], T334, KRL-AG2, (L04), Th-R16, T-78), Trichoderma inhamatum, Trichoderma koningii, Trichoderma longibrachiatum, Trichoderma nigrovirens, Trichoderma paratroviride, Trichoderma paraviride, Trichoderma paraviridescens, Trichoderma perviride, Trichoderma polysporum, Trichoderma pseudonigrovirens, Trichoderma reesei, Trichoderma reesei strains (Rut-C30, RL-P37, QM6a, MCG-80, 1391A, P59G, P210A, P345A), Trichoderma subviride, Trichoderma virens, Trichoderma virens strain (G-41, GL-21, T-1, R42), Trichoderma viride, Trichoderma viridescens, and Trichoderma zeloharzianum.

In some embodiments, the biostimulant may be a fungi or other substance including Cetraspora spp., Cetraspora helvetica, Gibberella spp., Gibberella acerina, Gibberella acervalis, Gibberella acuminata, Gibberella africana, Gibberella agglomerata, Gibberella atrofuliginea, Gibberella atrorufa, Gibberella australis, Gibberella avenacea, Gibberella baccata, Gibberella bambusae, Gibberella bolusiellae, Gibberella bresadolae, Gibberella briosiana, Gibberella butleri, Gibberella buxi, Gibberella cantareirensis, Gibberella cicatrisata, Gibberella circinata, Gibberella coffeae, Gibberella coronicola, Gibberella creberrima, Gibberella culmicola, Gibberella cyanea, Gibberella cyanogena, Gibberella cyanospora, Gibberella cylindrospora, Gibberella effusa, Gibberella engleriana, Gibberella euonymi, Gibberella ficina, Gibberella flacca, Gibberella fujikuroi, Gibberella. fujikuroi var. subglutinans, Gibberella fusispora, Gibberella gaditjirrii, Gibberella gordonii, Gibberella gossypina, Gibberella heterochroma, Gibberella hostae, Gibberella imperatae, Gibberella indica, Gibberella intricans, Gibberella juniperi, Gibberella konza, Gibberella lagerheimii, Gibberella lateritia, Gibberella longispora, Gibberella macrolopha, Gibberella malvacearum, Gibberella mapaniae, Gibberella maxima, Gibberella nemorosa, Gibberella nygamai, Gibberella parasitica, Gibberella passiflorae, Gibberella phyllostachydicola, Gibberella polycocca, Gibberella pseudopulicaris, Gibberella pulicaris, Gibberella quinqueseptata, Gibberella rhododendricola, Gibberella rugosa, Gibberella sacchari, Gibberella spiraeae, Gibberella stilboides, Gibberella subtropica, Gibberella thapsina, Gibberella tilakii, Gibberella tricincta, Gibberella tritici, Gibberella tropicalis, Gibberella tumida, Gibberella ulicis, Gibberella venezuelana, Gibberella violacea, Gibberella vitis, Gibberella xylarioides, Gibberella zeae, Gigaspora spp., Gigaspora albida, Gigaspora decipiens, Gigaspora gigantea, Gigaspora margarita, Gigaspora rosea, Glomus spp., Glomus aggregatum, Glomus aggregatrum, Glomus albidum, Glomus ambisporum, Glomus brazillanum, Glomus caledonium, Glomus coremioides, Glomus claroideum, Glomus clarum, Glomus clavisporum, Glomus constrictum, Glomus coronatum, Glomus deserticola, Glomus diaphanum, Glomus eburneum, Glomus etunicatum, Glomus fasciculatum, Glomus fistulosum, Glomus fragilistratum, Glomus geosporum, Glomus globiferum, Glomus heterosporum, Glomus hoi, Glomus intraradices, Glomus lacteum, Glomus lamellosum, Glomus luteum, Glomus manihotis, Glomus microaggregatum, Glomus monosporum, Glomus mosseae, Glomus multicaule, Glomus pansihalos, Glomus pustulatum, Glomus sinuosum, Glomus spurcum, Glomus tortuosum, Glomus trimurales, Glomus verruculosum, Glomus versiforme, Glomus viscosum, Laccaria spp., Laccaria amethysteo-occidentalis, Laccaria amethystina, Laccaria alba, Laccaria angustilamella, Laccaria aurantia, Laccaria bicolor, Laccaria fraterna, Laccaria fulvogrisea, Laccaria gomezii, Laccaria japonica, Laccaria laccata, Laccaria laccata var. laccata, Laccaria longipes, Laccaria maritima, Laccaria montana, Laccaria moshuijun, Laccaria nobilis, Laccaria ochropurpurea, Laccaria paraphysata, Laccaria proxima, Laccaria pseudomontana, Laccaria purpureobadia, Laccaria tetraspora, Laccaria tortilis, Laccaria vinaceobrunnea, Laccaria yunnanensis, Paraglomus spp., Paraglomus brasilianum, Paraglomus occultum, Paraglomus laccatum, Pisolithus spp., Pisolithus abditus, Pisolithus albus, Pisolithus arhizus, Pisolithus aurantioscabrosus, Pisolithus australis, Pisolithus calongei, Pisolithus capsulifer, Pisolithus croceorrhizus, Pisolithus hypogaeus, Pisolithus indicus, Pisolithus kisslingii, Pisolithus marmoratus, Pisolithus microcarpus, Pisolithus orientalis, Pisolithus pisiformis, Pisolithus tinctorius, Racocetra spp., Racocetra castanea, Racocetra coralloidea, Racocetra fulgida, Racocetra gregaria, Racocetra persica, Racocetra verrucosa, Racocetra weresubiae, Rhizoglomus spp., Rhizoglomus aggregatum, Rhizoglomus intraradices, Rhizophagus spp., Rhizophagus arabicus, Rhizophagus clams, Rhizophagus custos, Rhizophagus diaphanum, Rhizophagus fasciculatus, Rhizophagus intraradices, Rhizophagus iranicus, Rhizophagus irregularis, Rhizophagus manihotis, Rhizophagus proliferus, Rhizopogon spp., Rhizopogon albidus, Rhizopogon ater, Rhizopogon amylopogon, Rhizopogon amylopogon brunsii, Rhizopogon amylopogon arctostaphyli, Rhizopogon amylopogon kretzerae, Rhizopogon amylopogon salebrosus, Rhizopogon amylopogon pinyonensis, Rhizopogon amylopogon ellenae, Rhizopogon amylopogon subpurpurascens, Rhizopogon atroviolaceus, Rhizopogon brunneniger, Rhizopogon ellenae, Rhizopogon evadens, Rhizopogon fulvigleba, Rhizopogon fuscorubens, Rhizopogon hawkerae, Rhizopogon luteolus, Rhizopogon nigrescens, Rhizopogon occidentalis, Rhizopogon ochraceorubens, Rhizopogon parksii, Rhizopogon parvisporus, Rhizopogon pedicellus, Rhizopogon roseolus, Rhizopogon salebrosus, Rhizopogon subareolatus, Rhizopogon subaustralis, Rhizopogon subcaerulescens, Rhizopogon subpurpurascens, Rhizopogon sub salmonius, Rhizopogon succosus, Rhizopogon togasawariana, Rhizopogon truncatus, Rhizopogon vesiculosus, Rhizopogon villosulus, Rhizopogon vinicolor, Rhizopogon vulgaris, Saccharomyces spp., Saccharomyces arboricolus, Saccharomyces bayanus, Saccharomyces bulderi, Saccharomyces cariocanus, Saccharomyces cariocus, Saccharomyces cerevisiae, Saccharomyces cerevisiae var. boulardii, Saccharomyces cerevisiae hydrolysate, Saccharomyces chevalieri, Saccharomyces dairenensis, Saccharomyces ellipsoideus, Saccharomyces eubayanus, Saccharomyces exiguus, Saccharomyces florentinus, Saccharomyces fragilis, Saccharomyces kudriavzevii, Saccharomyces martiniae, Saccharomyces mikatae, Saccharomyces monacensis, Saccharomyces norbensis, Saccharomyces paradoxus, Saccharomyces pastorianus, Saccharomyces spencerorum, Saccharomyces turicensis, Saccharomyces unisporus, Saccharomyces uvarum, Saccharomyces zonatus, Scleroderma spp., Scleroderma cepa, Scleroderma citrinum, Scleroderma verrucosum, Scutellospora spp., Scutellospora biornata, Scutellospora calospora, Scutellospora cerradensis, Scutellospora dipurpurascens, Scutellospora erythropus, Scutellospora gilmorei, Scutellospora heterogama, Scutellospora nigra, Scutellospora nodosa, Scutellospora pellucida, Scutellospora reticulata, Scutellospora rubra, Scutellospora scutate, Suillus spp., Suillus abietinus, Suillus acerbus, Suillus acidus, Suillus albidipes, Suillus albivelatus, Suillus alboflocculosus, Suillus alkaliaurantians, Suillus amabilis, Suillus americanus, Suillus anomalus, Suillus appendiculatus, Suillus bellinii, Suillus borealis, Suillus boudieri, Suillus bovinoides, Suillus bovinus, Suillus bresadolae, Suillus brevipes, Suillus brunnescens, Suillus caerulescens, Suillus californicus, Suillus cavipes, Suillus cavipoides, Suillus cembrae, Suillus chiapasensis, Suillus collarius, Suillus collinitus, Suillus cothurnatus, Suillus decipiens, Suillus flavidus, Suillus flavogranulatus, Suillus flavoluteus, Suillus flavus, Suillus furfuraceus, Suillus fuscotomentosus, Suillus glandulosipes, Suillus gloeous, Suillus granulatus, Suillus grevillei, Suillus grisellus, Suillus guzmanii, Suillus helenae, Suillus hirtellus, Suillus hololeucus, Suillus holomaculatus, Suillus intermedius, Suillus jacuticus, Suillus kaibabensis, Suillus kunmingensis, Suillus lakei, Suillus lapponicus, Suillus lithocarpi-sequoiae, Suillus lutescens, Suillus luteus, Suillus marginielevatus, Suillus mediterraneensis, Suillus megaporinus, Suillus monticola, Suillus neoalbidipes, Suillus obscurus, Suillus occidentalis, Suillus ochraceoroseus, Suillus pallidiceps, Suillus pinorigidus, Suillus placidus, Suillus plorans, Suillus ponderosus, Suillus pseudoalbivelatus, Suillus pseudobrevipes, Suillus punctipes, Suillus punctatapies, Suillus pungens, Suillus quiescens, Suillus reticulatus, Suillus riparius, Suillus roseoporus, Suillus roseovelatus, Suillus ruber, Suillus rubricontextus, Suillus rubropunctatus, Suillus salmonicolor, Suillus serotinus, Suillus sibiricus, Suillus spraguei, Suillus subacerbus, Suillus subalpinus, Suillus sub aureus, Suillus subluteus, Suillus subolivaceus, Suillus subreticulatus, Suillus subvariegatus, Suillus tomentosus, Suillus triacicularis, Suillus tridentinus, Suillus variegatus, Suillus viscidus, Suillus volcanalis, Suillus wasatchicus, Suillus weaverae, Trichoderma spp., Trichoderma achlamydosporum, Trichoderma acremonioides, Trichoderma adaptatum, Trichoderma aeroaquaticum, Trichoderma aerugineum, Trichoderma aestuarinum, Trichoderma aethiopicum, Trichoderma afarasin, Trichoderma afroharzianum, Trichoderma aggregatum, Trichoderma aggressivum, Trichoderma albofulvopsis, Trichoderma albolutescens, Trichoderma alboviride, Trichoderma alni, Trichoderma alpinum, Trichoderma alutaceum, Trichoderma amazonicum, Trichoderma amoenum, Trichoderma anaharzianum, Trichoderma andinense, Trichoderma angustum, Trichoderma anisohamatum, Trichoderma appalachiense, Trichoderma applanatum, Trichoderma aquaticum, Trichoderma arachnoidea, Trichoderma arenarium, Trichoderma arundinaceum, Trichoderma asiaticum, Trichoderma asperelloides, Trichoderma asperellum, Trichoderma asymmetricum, Trichoderma atlanticum, Trichoderma atrobrunneum, Trichoderma atroviride, Trichoderma attinorum, Trichoderma auranteffusum, Trichoderma aurantioeffusum, Trichoderma aureoviride, Trichoderma aureum, Trichoderma austriacum, Trichoderma austrokoningii, Trichoderma awajun, Trichoderma azevedoi, Trichoderma balearicum, Trichoderma bannaense, Trichoderma barbatum, Trichoderma bavaricum, Trichoderma beijingense, Trichoderma beinartii, Trichoderma bifurcatum, Trichoderma bissettii, Trichoderma bomiense, Trichoderma botryosum, Trichoderma brassicae, Trichoderma breve, Trichoderma brevicompactum, Trichoderma brevicrassum, Trichoderma brevipes, Trichoderma brunneoviride, Trichoderma byssinum, Trichoderma caeruleimontis, Trichoderma caeruleoviride, Trichoderma caesareum, Trichoderma caesium, Trichoderma calamagrostidis, Trichoderma camelliae, Trichoderma camerunense, Trichoderma candidum, Trichoderma capillare, Trichoderma caribbaeum, Trichoderma carneum, Trichoderma catoptron, Trichoderma ceciliae, Trichoderma centrosinicum, Trichoderma ceraceum, Trichoderma ceramicum, Trichoderma ceratophylli, Trichoderma cerinum, Trichoderma changbaiense, Trichoderma chetii, Trichoderma chlamydosporicum, Trichoderma chlorosporum, Trichoderma christianii, Trichoderma chromospermum, Trichoderma cinnabarinum, Trichoderma cinnamomeum, Trichoderma citrinella, Trichoderma citrinoviride, Trichoderma compactum, Trichoderma composticola, Trichoderma concentricum, Trichoderma confertum, Trichoderma confluens, Trichoderma cordobense, Trichoderma corfecianum, Trichoderma cornu-damae, Trichoderma crassum, Trichoderma cremeoides, Trichoderma cremeum, Trichoderma croceum, Trichoderma crystalligenum, Trichoderma crystalligenum, Trichoderma cuenisporum, Trichoderma cyanodichotomus, Trichoderma dacrymycellum, Trichoderma delicatulum, Trichoderma deliquescens, Trichoderma densum, Trichoderma desrochii, Trichoderma dimorphum, Trichoderma dingleyeae, Trichoderma dorotheae, Trichoderma dubium, Trichoderma effusum, Trichoderma eijii, Trichoderma endophyticum, Trichoderma epimyces, Trichoderma erinaceum, Trichoderma estonicum, Trichoderma europaeum, Trichoderma euskadiense, Trichoderma evansii, Trichoderma fasciculatum, Trichoderma fassatiovae, Trichoderma fertile, Trichoderma flagellatum, Trichoderma flavescens, Trichoderma flavofuscum, Trichoderma flavum, Trichoderma floccosum, Trichoderma fomiticola, Trichoderma fujianense, Trichoderma fuscum, Trichoderma gamsii, Trichoderma ganodermatis, Trichoderma gansuanum, Trichoderma gelatinosum, Trichoderma ghanense, Trichoderma gillesii, Trichoderma gliocladium, Trichoderma globoides, Trichoderma gracile, Trichoderma grande, Trichoderma granulosum, Trichoderma gregarium, Trichoderma guizhouense, Trichoderma guttatum, Trichoderma hainanense, Trichoderma hamatum, Trichoderma harzianum, Trichoderma harzianum Rifai strains T22, T-39, Ths97, IBT 9385 [T3], T334, KRL-AG2, (L04), Th-R16, T-78, Trichoderma hausknechtii, Trichoderma hebeiense, Trichoderma helicolixii, Trichoderma helicum, Trichoderma hengshanicum, Trichoderma hongkongense, Trichoderma hubeiense, Trichoderma hunanense, Trichoderma hunua, Trichoderma hypoxylon, Trichoderma inaequilaterale, Trichoderma inconspicuum, Trichoderma ingratum, Trichoderma inhamatum, Trichoderma insigne, Trichoderma intricatum, Trichoderma istrianum, Trichoderma italicum, Trichoderma ivoriense, Trichoderma jaklitschii, Trichoderma junci, Trichoderma konilangbra, Trichoderma koningii, Trichoderma koningiopsis, Trichoderma koreanum, Trichoderma kunmingense, Trichoderma lacteum, Trichoderma laeve, Trichoderma laevisporum, Trichoderma lanuginosum, Trichoderma lateritioroseum, Trichoderma leguminosarum, Trichoderma lentiforme, Trichoderma lentinulae, Trichoderma lentissimum, Trichoderma leucopus, Trichoderma liberatum, Trichoderma lieckfeldtiae, Trichoderma limonium, Trichoderma linzhiense, Trichoderma Trichoderma longibrachiatum, Trichoderma longiphialidicum, Trichoderma longipile, Trichoderma longisporum, Trichoderma luteffusum, Trichoderma luteocrystallinum, Trichoderma luteoeffusum, Trichoderma mangshanicum, Trichoderma margaretense, Trichoderma martiale, Trichoderma mediterraneum, Trichoderma medusae, Trichoderma melanomagnum, Trichoderma mienum, Trichoderma minutisporum, Trichoderma minutum, Trichoderma moravicum, Trichoderma neokoningii, Trichoderma neorufoides, Trichoderma neosinense, Trichoderma neotropicale, Trichoderma nigrovirens, Trichoderma nothescens, Trichoderma novae-zelandiae, Trichoderma oblongisporum, Trichoderma obovatum, Trichoderma oligosporum, Trichoderma olivascens, Trichoderma ovalisporum, Trichoderma pachypallidum, Trichoderma panacis, Trichoderma paraceramosus, Trichoderma parareesei, Trichoderma pararogersonii, Trichoderma paratroviride, Trichoderma paraviride, Trichoderma paraviridescens, Trichoderma parepimyces, Trichoderma parestonicum, Trichoderma paucisporum, Trichoderma peberdyi, Trichoderma pedunculatum, Trichoderma penicillatum, Trichoderma peruvianum, Trichoderma p ervi ri de, Trichoderma petersenii, Trichoderma pezizoideum, Trichoderma phayaoense, Trichoderma phellinicola, Trichoderma phyllostachydis, Trichoderma piluliferum, Trichoderma pinnatum, Trichoderma placentula, Trichoderma pleuroti, Trichoderma pleuroticola, Trichoderma pluripenicillatum, Trichoderma pollinicola, Trichoderma polyalthiae, Trichoderma polypori, Trichoderma polysporum, Trichoderma poronioideum, Trichoderma priscilae, Trichoderma propepolypori, Trichoderma protrudens, Trichoderma pruinosum, Trichoderma pseudoasiaticum, Trichoderma pseudoasperelloides, Trichoderma pseudocandidum, Trichoderma pseudodensum, Trichoderma pseudogelatinosa, Trichoderma pseudokoningii, Trichoderma pseudolacteum, Trichoderma pseudonigrovirens, Trichoderma pseudostraminea, Trichoderma psychrophilum, Trichoderma pubescens, Trichoderma purpureum, Trichoderma pyramidale, Trichoderma pyrenium, Trichoderma pyrenium, Trichoderma racemosum, Trichoderma reesei, Trichoderma reesei strains Rut-C30, RL-P37, QM6a, MCG-80, 1391A, P59G, P210A, P345A, Trichoderma restrictum, Trichoderma rifaii, Trichoderma rogersonii, Trichoderma roseum, Trichoderma rossicum, Trichoderma rosulatum, Trichoderma rubi, Trichoderma rubropallens, Trichoderma rufobrunneum, Trichoderma rugosum, Trichoderma rugulosum, Trichoderma samuelsii, Trichoderma saturnisporopsis, Trichoderma saturnisporum, Trichoderma scalesiae, Trichoderma scorpioideum, Trichoderma sempervirentis, Trichoderma seppoi, Trichoderma shaoguanicum, Trichoderma shennongjianum, Trichoderma sichuanense, Trichoderma silvae-virgineae, Trichoderma simile, Trichoderma simmonsii, Trichoderma simplex, Trichoderma sinense, Trichoderma sinoaustrale, Trichoderma sinokoningii, Trichoderma sinoluteum, Trichoderma sinuosum, Trichoderma solani, Trichoderma solum, Trichoderma songyi, Trichoderma sparsum, Trichoderma speciosum, Trichoderma sphaerosporum, Trichoderma spirale, Trichoderma stercorarium, Trichoderma stilbohypoxyli, Trichoderma stipitatum, Trichoderma stramineum, Trichoderma strictipile, Trichoderma strigosellum, Trichoderma strigosum, Trichoderma stromaticum, Trichoderma subalni, Trichoderma subalpinum, Trichoderma subazureum, Trichoderma subeffusum, Trichoderma subiculoides, Trichoderma subsulphureum, Trichoderma subuliforme, Trichoderma subviride, Trichoderma supraverticillatum, Trichoderma surrotundum, Trichoderma sympodianum, Trichoderma taiwanense, Trichoderma tardum, Trichoderma tawa, Trichoderma taxi, Trichoderma tenue, Trichoderma texanum, Trichoderma thailandicum, Trichoderma thelephoricola, Trichoderma theobromicola, Trichoderma thermophilum, Trichoderma tiantangzhaiense, Trichoderma tibetense, Trichoderma tibeticum, Trichoderma tomentosum, Trichoderma tremelloides, Trichoderma trixiae, Trichoderma tropicosinense, Trichoderma turrialbense, Trichoderma uncinatum, Trichoderma undatipile, Trichoderma undulatum, Trichoderma valdunense, Trichoderma varians, Trichoderma velutinum, Trichoderma vermifimicola, Trichoderma vermipilum, Trichoderma verticillatum, Trichoderma vinosum, Trichoderma violaceum, Trichoderma virens, Trichoderma virens strain G-41, GL-21, T-1, R42, Trichoderma virgatum, Trichoderma viridarium, Trichoderma viride, Trichoderma viridescens, Trichoderma viridialbum, Trichoderma viridicollare, Trichoderma viridiflavum, Trichoderma viridulum, Trichoderma virilente, Trichoderma voglmayrii, Trichoderma vulgatum, Trichoderma vulpinum, Trichoderma xanthum, Trichoderma xixiacum, Trichoderma yui, Trichoderma yunnanense, Trichoderma zayuense, Trichoderma zelobreve, Trichoderma zeloharzianum, and Trichoderma zonatum.

In some embodiments, the biostimulant may be a bacteria or other substance including Acetobacter spp., Acetobacter aceti, Acetobacter cerevi siae, Acetobacter cibinongensis, Acetobacter estunensis, Acetobacter fabarum, Acetobacter farinalis, Acetobacter indonesiensis, Acetobacter lambici, Acetobacter liquefaciens, Acetobacter lovaniensis, Acetobacter malorum, Acetobacter musti, Acetobacter nitrogenifigens, Acetobacter oeni, Acetobacter okinawensis, Acetobacter orientalis, Acetobacter orleanensis, Acetobacter papayae, Acetobacter pasteurianus, Acetobacter peroxydans, Acetobacter persici, Acetobacter pomorum, Acetobacter senegalensis, Acetobacter sicerae, Acetobacter suratthaniensis, Acetobacter syzygii, Acetobacter thailandicus, Acetobacter tropicalis, Acetobacter xylinus, Actinomyces spp., Actinomyces bovis, Actinomyces bowdenii, Actinomyces canis, Actinomyces cardiffensis, Actinomyces catuli, Actinomyces coleocanis, Actinomyces dentalis, Actinomyces denticolens, Actinomyces europaeus, Actinomyces funkei, Actinomyces georgiae, Actinomyces gerencseriae, Actinomyces graevenitzii, Actinomyces hongkongensis, Actinomyces hordeovulneris, Actinomyces howellii, Actinomyces hyovaginalis, Actinomyces israelii, Actinomyces johnsonii, Actinomyces marimammalium, Actinomyces massiliensis, Actinomyces meyeri, Actinomyces naeslundii, Actinomyces nasicola, Actinomyces neuii, Actinomyces odontolyticus, Actinomyces oricola, Actinomyces oris, Actinomyces radicidentis, Actinomyces radingae, Actinomyces ruminicola, Actinomyces slackii, Actinomyces suimastitidis, Actinomyces timonensis, Actinomyces turicensis, Actinomyces urogenitalis, Actinomyces vaccimaxillae, Actinomyces viscosus, Allorhizobium spp., Allorhizobium borbori, Allorhizobium oryzae, Allorhizobium oryziradicis, Allorhizobium paknamense, Allorhizobium pseudoryzae, Allorhizobium taibaishanense, Allorhizobium terrae, Allorhizobium undicola, Allorhizobium vitis, Anabaena spp., Anabaena aequalis, Anabaena affinis, Anabaena angstumalis angstumalis, Anabaena angstumalis marchita, Anabaena aphanizomendoides, Anabaena azollae, Anabaena bornetiana, Anabaena catenula, Anabaenacedrorum, Anabaena circinalis, Anabaena confervoides, Anabaena constricta, Anabaena cyanobacterium, Anabaena cycadeae, Anabaena cylindrica, Anabaena echinispora, Anabaena felisii, Anabaena flos-aquae flos-aquae, Anabaena flos-aquae minor, Anabaena flos-aquae treleasei, Anabaena helicoidea, Anabaena inaequalis, Anabaena lapponica, Anabaena laxa, Anabaena lemmermannii, Anabaena levanderi, Anabaena limnetica, Anabaena macrospora macrospora, Anabaena macrospora robusta, Anabaena monticulosa, Anabaena nostoc, Anabaena oscillarioides, Anabaena planctonica, Anabaena raciborskii, Anabaena scheremetievi, Anabaena sphaerica, Anabaena spiroides crassa, Anabaena spiroides spiroides, Anabaena subcylindrica, Anabaena torulosa, Anabaena unispora, Anabaena variabilis, Anabaena verrucosa, Anabaena viguieri, Anabaena wisconsinense, Anabaena zierlingii, Arthrobacter spp., Arthrobacter agilis, Arthrobacter alkaliphilus, Arthrobacter alpinus, Arthrobacter bambusae, Arthrobacter bussei, Arthrobacter castelli, Arthrobacter citreus, Arthrobacter cry oconiti, Arthrobacter cry stallopoietes, Arthrobacter cupressi, Arthrobacter deserti, Arthrobacter echini, Arthrobacter enclensis, Arthrobacter endophyticus, Arthrobacter flavus, Arthrobacter gandavensis, Arthrobacter globiformis, Arthrobacter ginkgonis, Arthrobacter gyeryongensis, Arthrobacter halodurans, Arthrobacter humicola, Arthrobacter koreensis, Arthrobacter liuii, Arthrobacter living stonensis, Arthrobacter luteolus, Arthrobacter methylotrophus, Arthrobacter monumenti, Arthrobacter nanjingensis, Arthrobacter oryzae, Arthrobacter paludis, Arthrobacter parietis, Arthrobacter pascens, Arthrobacter pigmenti, Arthrobacter pityocampae, Arthrobacter pokkalii, Arthrobacter psychrochitiniphilus, Arthrobacter psychrolactophilus, Arthrobacter ram osus, Arthrobacter rhombi, Arthrobacter roseus, Arthrobacter ruber, Arthrobacter russicus, Arthrobacter silviterrae, Arthrobacter stackebrandtii, Arthrobacter subterraneus, Arthrobacter tecti, Arthrobacter tumbae, Arthrobacter viscosus, Arthrobacter woluwensis, Azorhizobium spp., Azorhizobium caulinodans, Azorhizobium doebereinerae, Azorhizobium oxalatiphilum, Azospirillum spp., Azospirillum agricola, Azospirillum amazonense, Azospirillum baldaniorum, Azospirillum brasilense, Azospirillum brasilense Sp7 (ATCC 29145), Azospirillum brasilense Sp245, Azospirillum canadense, Azospirillum doebereinerae, Azospirillum fermentarium, Azospirillum fluorescens, Azospirillum formosense, Azospirillum griseum, Azospirillum halopraeferens, Azospirillum humicireducens, Azospirillum largimobile, Azospirillum lipoferum, Azospirillum melinis, Azospirillum oleiclasticum, Azospirillum oryzae, Azospirillum palatum, Azospirillum palustre, Azospirillum picis, Azospirillum ramasamyi, Azospirillum rugosum, Azospirillum soli, Azospirillum thermophilum, Azospirillum thiophilum, Azospirillum zeae, Azotobacter spp., Azotobacter agilis, Azotobacter armeniacus, Azotobacter sp. AR, Azotobacter beijerinckii, Azotobacter chroococcum, Azotobacter sp. DCU26, Azotobacter sp. FAB, Azotobacter nigricans, Azotobacter paspali, Azotobacter salinestris, Azotobacter tropicalis, Azotobacter vinelandii, Bacillus spp., Bacillus acidiceler, Bacillus acidicola, Bacillus acidiproducens, Bacillus acidocaldarius, Bacillus acidoterrestris, Bacillus aeolius, Bacillus aerius, Bacillus aerophilus, Bacillus agaradhaerens, Bacillus agri, Bacillus aidingensis, Bacillus akibai, Bacillus albus, Bacillus alcalophilus, Bacillus algicola, Bacillus alginolyticus, Bacillus alkalidiazotrophicus, Bacillus alkalinitrilicus, Bacillus alkalisediminis, Bacillus alkalitelluris, Bacillus altitudinis, Bacillus alveayuensis, Bacillus alvei, Bacillus amyloliquefaciens, Bacillus amyloliquefaciens subsp. amyloliquefaciens, Bacillus amyloliquefaciens subsp. plantarum, Bacillus aminovorans, Bacillus amylolyticus, Bacillus andreesenii, Bacillus aneurinilyticus, Bacillus anthracia, Bacillus aquimaris, Bacillus arenosi, Bacillus arseniciselenatis, Bacillus arsenicus, Bacillus aurantiacus, Bacillus arvi, Bacillus aryabhattai, Bacillus asahii, Bacillus atrophaeus, Bacillus axarquiensis, Bacillus azotofixans, Bacillus azotoformans, Bacillus badius, Bacillus barbaricus, Bacillus bataviensis, Bacillus beijingensis, Bacillus benzoevorans, Bacillus beringensis, Bacillus berkeleyi, Bacillus beveridgei, Bacillus bogoriensis, Bacillus boroniphilus, Bacillus borstelensis, Bacillus brevis, Bacillus butanolivorans, Bacillus canaveralius, Bacillus carboniphilus, Bacillus cecembensis, Bacillus cellulosilyticus, Bacillus centrosporus, Bacillus cereus, Bacillus chagannorensis, Bacillus chitinolyticus, Bacillus chondroitinus, Bacillus choshinensis, Bacillus chungangensis, Bacillus cibi, Bacillus circulans, Bacillus clarkii, Bacillus clausii, Bacillus coagulans, Bacillus coahuilensis, Bacillus cohnii, Bacillus composti, Bacillus curdlanolyticus, Bacillus cycloheptanicus, Bacillus cytotoxicus, Bacillus daliensis, Bacillus decisifrondis, Bacillus decolorationis, Bacillus deserti, Bacillus dipsosauri, Bacillus drentensis, Bacillus edaphicus, Bacillus ehimensis, Bacillus eiseniae, Bacillus enclensis, Bacillus endophyticus, Bacillus endoradicis, Bacillus farraginis, Bacillus fastidiosus, Bacillus fengqiuensis, Bacillus firmus, Bacillus flexus, Bacillus flexus NJNPD41, Bacillus foraminis, Bacillus fordii, Bacillus formosus, Bacillus fortis, Bacillus fumarioli, Bacillus funiculus, Bacillus fusiformis, Bacillus galactophilus, Bacillus galactosidilyticus, Bacillus galliciensis, Bacillus gelatini, Bacillus gibsonii, Bacillus ginsengi, Bacillus ginsengihumi, Bacillus ginsengisoli, Bacillus glucanolyticus, Bacillus gordonae, Bacillus gottheilii, Bacillus graminis, Bacillus halmapalus, Bacillus haloalkaliphilus, Bacillus halochares, Bacillus halodenitrificans, Bacillus halodurans, Bacillus halophilus, Bacillus halosaccharovorans, Bacillus hemicellulosilyticus, Bacillus hemicentroti, Bacillus herbersteinensis, Bacillus horikoshii, Bacillus horneckiae, Bacillus horti, Bacillus huizhouensis, Bacillus humi, Bacillus hwajinpoensis, Bacillus idriensis, Bacillus indicus, Bacillus infantis, Bacillus infernus, Bacillus insolitus, Bacillus invictae, Bacillus iranensis, Bacillus isabeliae, Bacillus isronensis, Bacillus jeotgali, Bacillus kaustophilus, Bacillus kobensis, Bacillus kochii, Bacillus kokeshiiformis, Bacillus koreensis, Bacillus korlensis, Bacillus kribbensis, Bacillus krulwichiae, Bacillus laevolacticus, Bacillus larvae, Bacillus laterosporus, Bacillus lautus, Bacillus lehensis, Bacillus lentimorbus, Bacillus lentus, Bacillus licheniformis, Bacillus ligniniphilus, Bacillus litoralis, Bacillus locisalis, Bacillus luciferensis, Bacillus luteolus, Bacillus luteus, Bacillus macauensis, Bacillus macerans, Bacillus macquariensis, Bacillus macyae, Bacillus malacitensis, Bacillus mannanilyticus, Bacillus marisflavi, Bacillus marismortui, Bacillus marmarensis, Bacillus massiliensis, Bacillus megaterium, Bacillus mesonae, Bacillus methanolicus, Bacillus methylotrophicus, Bacillus migulanus, Bacillus mojavensis, Bacillus mucilaginosus, Bacillus muralis, Bacillus murimartini, Bacillus mycoides, Bacillus naganoensis, Bacillus nanhaiensis, Bacillus nanhaiisediminis, Bacillus nealsonii, Bacillus neidei, Bacillus neizhouensis, Bacillus niabensis, Bacillus niacini, Bacillus novalis, Bacillus oceanisediminis, Bacillus odysseyi, Bacillus okhensis, Bacillus okuhidensis, Bacillus oleronius, Bacillus oryzaecorticis, Bacillus oshimensis, Bacillus pabuli, Bacillus pakistanensis, Bacillus pallidus, Bacillus pallidus, Bacillus panacisoli, Bacillus panaciterrae, Bacillus pantothenticus, Bacillus parabrevis, Bacillus paraflexus, Bacillus pasteurii, Bacillus patagoniensis, Bacillus peoriae, Bacillus persepolensis, Bacillus persicus, Bacillus pervagus, Bacillus plakortidis, Bacillus pocheonensis, Bacillus polygoni, Bacillus polymyxa, Bacillus polymyxa strains ATCC 842, CCUG 1086, CFBP 4258, CIP 66.22, DSM 36, HAMBI 635, JCM 2507, LMG 13294, NBRC 15309, NCCB 24016, NCTC 10343, NRRL B-4317, VKM B-514, Bacillus popilliae, Bacillus pseudalcalophilus, Bacillus pseudofirmus, Bacillus pseudomycoides, Bacillus psychrodurans, Bacillus psychrophilus, Bacillus psychrosaccharolyticus, Bacillus psychrotolerans, Bacillus pulvifaciens, Bacillus pumilus, Bacillus purgationiresistens, Bacillus pycnus, Bacillus qingdaonensis, Bacillus qingshengii, Bacillus reuszeri, Bacillus rhizosphaerae, Bacillus rigui, Bacillus ruris, Bacillus safensis, Bacillus salarius, Bacillus salexigens, Bacillus saliphilus, Bacillus schlegelii, Bacillus sediminis, Bacillus selenatarsenatis, Bacillus selenitireducens, Bacillus seohaeanensis, Bacillus shacheensis, Bacillus shackletonii, Bacillus siamensis, Bacillus silvestris, Bacillus simplex, Bacillus siralis, Bacillus smithii, Bacillus soli, Bacillus solimangrovi, Bacillus solisalsi, Bacillus songklensis, Bacillus sonorensis, Bacillus sphaericus, Bacillus sporothermodurans, Bacillus stearothermophilus, Bacillus stratosphericus, Bacillus subterraneus, Bacillus subtilis, Bacillus subtilis subsp. inaquosorum, Bacillus subtilis subsp. spizizenii, Bacillus subtilis subsp. subtilis, Bacillus subtilis FZB24, Bacillus taeanensis, Bacillus tequilensis, Bacillus thermantarcticus, Bacillus thermoaerophilus, Bacillus thermoamylovorans, Bacillus thermocatenulatus, Bacillus thermocloacae, Bacillus thermocopriae, Bacillus thermodenitrificans, Bacillus thermoglucosidasius, Bacillus thermolactis, Bacillus thermoleovorans, Bacillus thermophilus, Bacillus thermoproteolyticus, Bacillus thermoruber, Bacillus thermosphaericus, Bacillus thiaminolyticus, Bacillus thioparans, Bacillus thuringiensis, Bacillus thuringiensis Btk ATCC 33679, Bacillus thuringiensis Btk HD73, Bacillus tianshenii, Bacillus trypoxylicola, Bacillus tusciae, Bacillus validus, Bacillus vallismortis, Bacillus vedderi, Bacillus velezensis, Bacillus vietnamensis, Bacillus vireti, Bacillus vulcani, Bacillus wakoensis, Bacillus xiamenensis, Bacillus xiaoxiensis, Bacillus zanthoxyli, Bacillus zhanjiangensis, Beijerinckia spp., Beijerinckia derxii, Beijerinckia derxii subsp. derxii, Beijerinckia derxii subsp. venezuelae, Beijerinckia doebereinerae, Beijerinckia indica, Beijerinckia indica subsp. indica, Beijerinckia indica subsp. lacticogenes, Beijerinckia mobilis, Bradyrhizobium spp., Bradyrhizobium agreste, Bradyrhizobium algeriense, Bradyrhizobium americanum, Bradyrhizobium amphicarpaeae, Bradyrhizobium arachidis, Bradyrhizobium archetypum, Bradyrhizobium australiense, Bradyrhizobium betae, Bradyrhizobium cajani, Bradyrhizobium canariense, Bradyrhizobium centrosematis, Bradyrhizobium cosmicum, Bradyrhizobium cytisi, Bradyrhizobium daqingense, Bradyrhizobium denitrificans, Bradyrhizobium diazoefficiens, Bradyrhizobium diversitatis, Bradyrhizobium elkanii, Bradyrhizobium embrapense, Bradyrhizobium erythrophlei, Bradyrhizobium ferriligni, Bradyrhizobium frederickii, Bradyrhizobium ganzhouense, Bradyrhizobium glycinis, Bradyrhizobium guangdongense, Bradyrhizobium guangxiense, Bradyrhizobium hipponense, Bradyrhizobium huanghuaihaiense, Bradyrhizobium icense, Bradyrhizobium ingae, Bradyrhizobium iriomotense, Bradyrhizobium ivorense, Bradyrhizobium japonicum, Bradyrhizobium japonicum symbiovar genistearum, Bradyrhizobium japonicum symbiovar glycinearum, Bradyrhizobium jicamae, Bradyrhizobium kavangense, Bradyrhizobium lablabi, Bradyrhizobium liaoningense, Bradyrhizobium lupini, Bradyrhizobium manausense, Bradyrhizobium mercantei, Bradyrhizobium murdochi, Bradyrhizobium namibiense, Bradyrhizobium nanningense, Bradyrhizobium neotropicale, Bradyrhizobium niftali, Bradyrhizobium nitroreducens, Bradyrhizobium oligotrophicum, Bradyrhizobium ottawaense, Bradyrhizobium pachyrhizi, Bradyrhizobium paxllaeri, Bradyrhizobium retamae, Bradyrhizobium rifense, Bradyrhizobium ripae, Bradyrhizobium shewense, Bradyrhizobium stylosanthis, Bradyrhizobium subterraneum, Bradyrhizobium symbiodeficiens, Bradyrhizobium tropiciagri, Bradyrhizobium vignae, Bradyrhizobium viridifuturi, Bradyrhizobium yuanmingense, Bradyrhizobium brasilense, Bradyrhizobium campsiandrae, Bradyrhizobium centrolobii, Bradyrhizobium forestalis, Bradyrhizobium guangzhouense, Bradyrhizobium macuxiense, Bradyrhizobium sacchari, Photorhizobium thompsonianum, Bradyrhizobium uaiense, Bradyrhizobium valentinum, Bradyrhizobium zhanjiangense, Burkholderia spp., Burkholderia alpina, Burkholderia ambifaria, Burkholderia anthina, Burkholderia arboris, Burkholderia cenocepacia, Burkholderia cepacia, Burkholderia contaminans, Burkholderia diffusa, Burkholderia dolosa, Burkholderia gladioli, Burkholderia glumae, Burkholderia humptydooensis, Burkholderia lata, Burkholderia latens, Burkholderia mallei, Burkholderia metallica, Burkholderia multivorans, Burkholderia oklahomensis, Burkholderia plantarii, Burkholderia pseudomallei, Burkholderia pseudomultivorans, Burkholderia puraquae, Burkholderia pyrrocinia, Burkholderia seminalis, Burkholderia singaporensis, Burkholderia singularis, Burkholderia stabilis, Burkholderia stagnalis, Burkholderia territorii, Burkholderia thailandensis, Burkholderia ubonensis, Burkholderia vietnamiensis, Chroococcidiopsis spp., Chroococcopsis gigantea, Clostridium spp., Clostridium aceticum, Clostridium acetireducens, Clostridium acetobutylicum, Clostridium acidisoli, Clostridium aciditolerans, Clostridium acidurici, Clostridium aerotolerans, Clostridium aestuarii, Clostridium akagii, Clostridium aldenense, Clostridium aldrichii, Clostridium algidicarnis, Clostridium algidixylanolyticum, Clostridium algifaecis, Clostridium algoriphilum, Clostridium alkalicellulosi, Clostridium amazonense, Clostridium aminophilum, Clostridium aminovalericum, Clostridium amygdalinum, Clostridium amylolyticum, Clostridium arbusti, Clostridium arcticum, Clostridium argentinense, Clostridium asparagiforme, Clostridium aurantibutyricum, Clostridium autoethanogenum, Clostridium baratii, Clostridium bartlettii, Clostridium beijerinckii, Clostridium bifermentans, Clostridium bolteae, Clostridium bornimense, Clostridium botulinum, Clostridium bowmanii, Clostridium bryantii, Clostridium butyricum, Clostridium cadaveris, Clostridium caenicola, Clostridium caminithermale, Clostridium carboxidivorans, Clostridium carnis, Clostridium cavendishii, Clostridium celatum, Clostridium celerecrescens, Clostridium cellobioparum, Clostridium cellulofermentans, Clostridium cellulolyticum, Clostridium cellulosi, Clostridium cellulovorans, Clostridium chartatabidum, Clostridium chauvoei, Clostridium chromiireducens, Clostridium citroniae, Clostridium clariflavum, Clostridium clostridioforme, Clostridium coccoides, Clostridium cochlearium, Clostridium colletant, Clostridium cocleatum, Clostridium colicanis, Clostridium colinum, Clostridium collagenovorans, Clostridium cylindrosporum, Clostridium difficile, Clostridium diolis, Clostridium disporicum, Clostridium drakei, Clostridium durum, Clostridium estertheticum, Clostridium estertheticum estertheticum, Clostridium estertheticum laramiense, Clostridium fallax, Clostridium felsineum, Clostridium fervidum, Clostridium fimetarium, Clostridium formicaceticum, Clostridium frigidicarnis, Clostridium frigoris, Clostridium ganghwense, Clostridium gasigenes, Clostridium ghonii, Clostridium glycolicum, Clostridium glycyrrhizinilyticum, Clostridium grantii, Clostridium haemolyticum, Clostridium halophilum, Clostridium hastiforme, Clostridium hathewayi, Clostridium herbivorans, Clostridium hiranonis, Clostridium histolyticum, Clostridium homopropionicum, Clostridium huakuii, Clostridium hungatei, Clostridium hydrogeniformans, Clostridium hydroxybenzoicum, Clostridium hylemonae, Clostridium jeddahense, Clostridium jejuense, Clostridium indolis, Clostridium innocuum, Clostridium intestinale, Clostridium irregulare, Clostridium isatidis, Clostridium josui, Clostridium kluyveri, Clostridium lactatifermentans, Clostridium lacusfryxellense, Clostridium laramiense, Clostridium lavalense, Clostridium lentocellum, Clostridium lentoputrescens, Clostridium leptum, Clostridium limosum, Clostridium litorale, Clostridium liquoris, Clostridium lituseburense, Clostridium ljungdahlii, Clostridium lortetii, Clostridium lundense, Clostridium luticellarii, Clostridium magnum, Clostridium malenominatum, Clostridium mangenotii, Clostridium mayombei, Clostridium maximum, Clostridium methoxybenzovorans, Clostridium methylpentosum, Clostridium moniliforme, Clostridium neopropionicum, Clostridium nexile, Clostridium nitrophenolicum, Clostridium novyi, Clostridium oceanicum, Clostridium orbiscindens, Clostridium oroticum, Clostridium oryzae, Clostridium oxalicum, Clostridium papyrosolvens, Clostridium paradoxum, Clostridium paraperfringens, Clostridium paraputrificum, Clostridium pascui, Clostridium pasteurianum, Clostridium peptidivorans, Clostridium perenne, Clostridium perfringens, Clostridium pfennigii, Clostridium phytofermentans, Clostridium piliforme, Clostridium polysaccharolyticum, Clostridium polyendosporum, Clostridium populeti, Clostridium propionicum, Clostridium proteoclasticum, Clostridium proteolyticum, Clostridium psychrophilum, Clostridium puniceum, Clostridium punense, Clostridium purinilyticum, Clostridium putrefaciens, Clostridium putrificum, Clostridium quercicolum, Clostridium quinii, Clostridium ramosum, Clostridium rectum, Clostridium roseum, Clostridium s accharobutylicum, Clostridium saccharogumia, Clostridium saccharolyticum, Clostridium saccharoperbutylacetonicum, Clostridium sardiniense, Clostridium sartagoforme, Clostridium saudiense, Clostridium senegalense, Clostridium scatologenes, Clostridium schirmacherense, Clostridium scindens, Clostridium septicum, Clostridium sordellii, Clostridium sphenoides, Clostridium spiroforme, Clostridium sporogenes, Clostridium sporosphaeroides, Clostridium stercorarium, Clostridium stercorarium leptospartum, Clostridium stercorarium stercorarium, Clostridium stercorarium thermolacticum, Clostridium sticklandii, Clostridium straminisolvens, Clostridium subterminale, Clostridium sufflavum, Clostridium sulfidigenes, Clostridium swellfunianum, Clostridium symbiosum, Clostridium tagluense, Clostridium tarantellae, Clostridium tepidiprofundi, Clostridium termitidis, Clostridium tertium, Clostridium tetani, Clostridium tetanomorphum, Clostridium thermaceticum, Clostridium thermautotrophicum, Clostridium thermoalcaliphilum, Clostridium thermobutyricum, Clostridium thermocellum, Clostridium thermocopriae, Clostridium thermohydrosulfuricum, Clostridium thermolacticum, Clostridium thermopalmarium, Clostridium thermopapyrolyticum, Clostridium thermosaccharolyticum, Clostridium thermosuccinogenes, Clostridium thermosulfurigenes, Clostridium thiosulfatireducens, Clostridium tyrobutyricum, Clostridium uliginosum, Clostridium ultunense, Clostridium ventriculi, Clostridium villosum, Clostridium vincentii, Clostridium viride, Clostridium vulturis, Clostridium xylanolyticum, Clostridium xylanovorans, Frankia spp., Frankia alni, Ca. Frankia alpina, Frankia asymbiotica, Ca. Frankia californiensis, Frankia canadensis, Frankia casuarinae, Frankia coriariae, Ca. Frankia datiscae, Frankia discariae, Frankia elaeagni, Frankia inefficax, Frankia irregularis, Ca. Frankia meridionalis, Ca. Frankia nodulisporulans, Frankia saprophytica, Frankia soli, Frankia subtilis, Frankia torreyi, Geobacillus spp., Geobacillus caldoxylosilyticus, Geobacillus galactosidasius, Geobacillus icigianus, Geobacillus jurassicus, Geobacillus kaustophilus, Geobacillus lituanicus, Geobacillus stearothermophilus, Geobacillus stearothermophilus Rapid Readout strain, Geobacillus subterraneus, Geobacillus thermantarcticus, Geobacillus thermocatenulatus, Geobacillus thermodenitrificans, Geobacillus thermoglucosidasius, Geobacillus thermoleovorans, Geobacillus toebii, Geobacillusuzenensis, Geobacillus vulcani, Gluconacetobacter spp., Gluconacetobacter aggeris, Gluconacetobacter asukensis, Gluconacetobacter azotocaptans, Gluconacetobacter diazotrophicus, Gluconacetobacter dulcium, Gluconacetobacter entanii, Gluconacetobacter johannae, Gluconacetobacter liquefaciens, Gluconacetobacter sacchari, Gluconacetobacter takamatsuzukensis, Gluconacetobacter tumulicola, Gluconacetobacter tumulisoli, Herbaspirillum spp., Herbaspirillum aquaticum, Herbaspirillum autotrophicum, Herbaspirillum chlorophenolicum, Herbaspirillum frisingense, Herbaspirillum hiltneri, Herbaspirillum huttiense, Herbaspirillum lusitanum, Herbaspirillum lusitanum strains CCUG 48869, CECT 5661, CIP 108242, DSM 17154, LMG 21710, P6-12, P6-12, Valverde P6-12, Herbaspirillum massiliense, Herbaspirillum rhizosphaerae, Herbaspirillum rubrisubalbicans, Herbaspirillum seropedicae, Klebsiella spp., Klebsiella aerogenes, Klebsiella granulomatis, Klebsiella grimontii, Klebsiella huaxiensis, Klebsiella kielensis, Klebsiella michiganensis, Klebsiella milletis, Klebsiella oxytoca, Klebsiella pneumoniae, Klebsiella pneumoniae subsp. ozaenae, Klebsiella pneumoniae subsp. pneumoniae, Klebsiella pneumoniae subsp. rhinoscleromatis, Klebsiella quasipneumoniae, Klebsiella quasipneumoniae subsp. quasipneumoniae, Klebsiella quasipneumoniae subsp. similipneumoniae, Klebsiella quasivariicola, Klebsiella senegalensis, Klebsiella steroids, Klebsiella variicola, Lacticaseibacillus spp., Lacticaseibacillus absianus, Lacticaseibacillus baoqingensis, Lacticaseibacillus brantae, Lacticaseibacillus camelliae, Lacticaseibacillus casei, Lacticaseibacillus chiayiensis, Lacticaseibacillus daqingensis, Lacticaseibacillus hegangensis, Lacticaseibacillus hulanensis, Lacticaseibacillus jixianensis, Lacticaseibacillus manihotivorans, Lacticaseibacillus nasuensis, Lacticaseibacillus pantheris, Lacticaseibacillus paracasei, Lacticaseibacillus porcinae, Lacticaseibacillus rhamnosus, Lacticaseibacillus saniviri, Lacticaseibacillus sharpeae, Lacticaseibacillus songhuajiangensis, Lactobacillus suibinensis, Lacticaseibacillus thailandensis, Lacticaseibacillus yichunensis, Lacticaseibacillus zeae, Lacticaseibacillus zhaodongensis, Lactiplantibacillus spp., Lactiplantibacillus argentoratensis, Lactiplantibacillus daoliensis, Lactiplantibacillus daowaiensis, Lactiplantibacillus dongliensi, Lactiplantibacillus fabifermentans, Lactiplantibacillus garii, Lactiplantibacillus herbarum, Lactiplantibacillus modestisalitolerans, Lactiplantibacillus mudanjiangensis, Lactiplantibacillus nangangensis, Lactiplantibacillus paraplantarum, Lactiplantibacillus pentosus, Lactiplantibacillus pingfangensis, Lactiplantibacillus plajomi, Lactiplantibacillus plantarum, Lactiplantibacillus songbeiensis, Lactiplantibacillus xiangfangensis, Lactobacillus spp., Lactobacillus acetotolerans, Lactobacillus acidophilus, Lactobacillus alvi, Lactobacillus amylolyticus, Lactobacillus amylovorus, Lactobacillus apis, Lactobacillus backi, Lactobacillus bombicola, Lactobacillus casei, Lactobacillus colini, Lactobacillus crispatus, Lactobacillus delbrueckii, Lactobacillus equicursoris, Lactobacillus fornicalis, Lactobacillus gallinarum, Lactobacillus gasseri, Lactobacillus gigeriorum, Lactobacillus ginsenosidimutans, Lactobacillus hamsteri, Lactobacillus helsingborgensis, Lactobacillus helveticus, Lactobacillus hominis, Lactobacillus iners, Lactobacillus intestinalis, Lactobacillus jensenii, Lactobacillus jinshani, Lactobacillus johnsonii, Lactobacillus kalixensis, Lactobacillus kefiranofaciens, Lactobacillus kimbladii, Lactobacillus kitasatonis, Lactobacillus kullabergensis, Lactobacillus melliventris, Lactobacillus mulieris, Lactobacillus nasalidis, Lactobacillus panisapium, Lactobacillus paragasseri, Lactobacillus pasteurii, Lactobacillus plantarum, Lactobacillus porci, Lactobacillus psittaci, Lactobacillus raoultii, Lactobacillus rodentium, Lactobacillus rogosae, Lactobacillus taiwanensis, Lactobacillus thermophilus, Lactobacillus timonensis, Lactobacillus ultunensis, Lactobacillus xujianguonis, Holzapfelia, Amylolactobacillus, Bombilactobacillus, Companilactobacillus, Lapidilactobacillus, Agrilactobacillus, Schleiferilactobacillus, Loigolactobacillus, Lacticaseibacillus, Latilactobacillus, Dellaglioa, Liquorilactobacillus, Ligilactobacillus, Lactiplantibacillus, Furfurilactobacillus, Paucilactobacillus, Limosilactobacillus, Fructilactobacillus, Acetilactobacillus, Apilactobacillus, Levilactobacillus, Secundilactobacillus, Lentilactobacillus, Lactococcus spp., Lactococcus chungangensis, Lactococcus formosensis, Lactococcus fujiensis, Lactococcus garvieae, Lactococcus garvieae subsp. garvieae, Lactococcus garvieae subsp. bovis, Lactococcus hircilactis, Lactococcus lactis, Lactococcus lactis subsp. cremoris, Lactococcus lactis subsp. hordniae, Lactococcus lactis subsp. lactis, Lactococcus lactis subsp. lactis bv. diacetylactis, Lactococcus lactis subsp. tructae, Lactococcus laudensis, Lactococcus nasutitermitis, Lactococcus piscium, Lactococcus plantarum, Lactococcus raffinolactis, Lactococcus taiwanensis, Mesorhizobium spp., Mesorhizobium abyssinicae, Mesorhizobium acaciae, Mesorhizobium albiziae, Mesorhizobium alhagi, Mesorhizobium amorphae, Mesorhizobium atlanticum, Mesorhizobium australicum, Mesorhizobium calcicola, Mesorhizobium camelthorni, Mesorhizobium cantuariense, Mesorhizobium caraganae, Mesorhizobium carbonis, Mesorhizobium carmichaelinearum, Mesorhizobium chacoense, Mesorhizobium ciceri, Mesorhizobium ciceri strains ATCC 51585, ATCC 700744, BCRC 15795, CCRC 15795, CECT 4846, CFBP 5557, CIP 104229, DSMZ 11540, HAMBI 1750, IAM 15103, ICMP 13641, JCM 21564, KACC 10646, KCTC 12155, LMG 14989, LMG 17150, NBRC 100389, ORS 2738, UPM-Ca7, USDA 3383, Mesorhizobium composti, Mesorhizobium delmotii, Mesorhizobium ephedrae, Mesorhizobium erdmanii, Mesorhizobium gobiense, Mesorhizobium hankyongi, Mesorhizobium hawassense, Mesorhizobium helmanticense, Mesorhizobium huakuii, Mesorhizobium japonicum, Mesorhizobium jarvisii, Mesorhizobium kowhai, Mesorhizobium loti, Mesorhizobium mediterraneum, Mesorhizobium metallidurans, Mesorhizobium muleiense, Mesorhizobium newzealandense, Mesorhizobium norvegicum, Mesorhizobium oceanicum, Mesorhizobium olivaresii, Mesorhizobium opportunistum, Mesorhizobium plurifarium, Mesorhizobium prunaredense, Mesorhizobium qingshengii, Mesorhizobium robiniae, Mesorhizobium sangaii, Mesorhizobium sanjuanii, Mesorhizobium sediminum, Mesorhizobium septentrionale, Mesorhizobium shangrilense, Mesorhizobium shonense, Mesorhizobium silamurunense, Mesorhizobium soli, Mesorhizobium sophorae, Mesorhizobium tamadayense, Mesorhizobium tamadayense symbiovar loti, Mesorhizobium tamadayense symbiovar tamadayense, Mesorhizobium tarimense, Mesorhizobium temperatum, Mesorhizobium terrae, Mesorhizobium thiogangeticum, Mesorhizobium tianshanense, Mesorhizobium waimense, Mesorhizobium waitakense, Mesorhizobium wenxiniae, Mesorhizobium alexandrii, Mesorhizobium denitrificans, Candidatus Mesorhizobium hominis, Mesorhizobium hungaricum, Mesorhizobium intechi, Mesorhizobium rhizophilum, Mesorhizobium zhangyense, Mycobacterium spp., Mycobacterium phlei, Mycobacterium tuberculosis complex, Mycobacterium avium complex, Mycobacterium gordonae clade, Mycobacterium kansasii clade, Mycobacterium nonchromogenicum/terrae clade, Mycolactone-producing mycobacteria, Mycobacterium simiae clade, Mycobacterium abscessus clade, Mycobacterium chelonae clade, Mycobacterium fortuitum clade, Mycobacterium mucogenicum clade, Mycobacterium parafortuitum clade, Mycobacterium vaccae clade, Nostoc spp., Nostoc agglutinans, Nostoc alatosporum, Nostoc album, Nostoc alpinum, Nostoc ambiceps, Nostoc amplissimum, Nostoc anisococcum, Nostoc antarcticum, Nostoc apuanum, Nostoc arctum, Nostoc arenarium, Nostoc austinii, Nostoc belmonticum, Nostoc bicalyptratum, Nostoc bornetii, Nostoc borzioides, Nostoc brittoni, Nostoc caeruleum, Nostoc caladarium, Nostoc calcicola, Nostoc carneum, Nostoc catenatum, Nostoc cesatii, Nostoc ciniflonum, Nostoc citrisporum, Nostoc coimbatorense, Nostoc comminutum, Nostoc commune, Nostoc conglomeratum, Nostoc copiosum, Nostoc cordubense, Nostoc crassisporum, Nostoc crassisporum, Nostoc cristatum, Nostoc cycadae, Nostoc delpinoi, Nostoc depressum, Nostoc desertorum, Nostoc diamorphoticum, Nostoc diplonema, Nostoc disciforme, Nostoc edaphicum, Nostoc edule, Nostoc elgonense, Nostoc ellipsoideum, Nostoc ellipsosporum, Nostoc endophytum, Nostoc epilithicum, Nostoc expansum, Nostoc filarzskyi, Nostoc flagelliforme, Nostoc flavicans, Nostoc fluviatile, Nostoc foliaceum, Nostoc fonticola, Nostoc fragiforme, Nostoc fuscescens, Nostoc fuscum, Nostoc gelatinosum, Nostoc ghotgewadense, Nostoc glomeratum, Nostoc granulare, Nostoc gregarium, Nostoc gymnosphaericum, Nostoc hatei, Nostoc heterothrix, Nostoc humifusum, Nostoc hyalinum, Nostoc hyalinum, Nostoc hydrocoleoides, Nostoc imperfectum, Nostoc indistinguendum, Nostoc insulare, Nostoc interbryum, Nostoc intestinale, Nostoc inundatum, Nostoc kihlmanii, Nostoc koraiense, Nostoc krishnamurthyi, Nostoc lacerum, Nostoc lacunosum, Nostoc lacustre, Nostoc leptonema, Nostoc letestui, Nostoc lichenoides, Nostoc limosum, Nostoc linckia, Nostoc littorale, Nostoc locularis, Nostoc longstaffi, Nostoc lophotelos, Nostoc maculiforme, Nostoc mamillosum, Nostoc margaritaceum, Nostoc membranaceum, Nostoc microscopicum, Nostoc microtis, Nostoc minimum, Nostoc minutissimum, Nostoc minutum, Nostoc molle, Nostoc mougeotii, Nostoc myriococcum, Nostoc nivale, Nostoc notarisii, Nostoc nylstromicum, Nostoc opalinum, Nostoc oryzae, Nostoc palmelioides, Nostoc paludosum, Nostoc papillosum, Nostoc paradoxum, Nostoc parietinum, Nostoc parmelioides, Nostoc parvulum, Nostoc passerinianum, Nostoc pellucidum, Nostoc peloponnesiacum, Nostoc peltigerae, Nostoc polysaccum, Nostoc polysporum, Nostoc prismaticum, Nostoc pruniforme, Nostoc pseudogelatinosum, Nostoc punctatum, Nostoc punctiforme, Nostoc purpurascens, Nostoc purpureum, Nostoc ramosum, Nostoc repandum, Nostoc reticulatum, Nostoc riabuschinskii, Nostoc rupestre, Nostoc salsum, Nostoc saxatile, Nostoc segawae, Nostoc sergianum, Nostoc shensiense, Nostoc simulans, Nostoc sinuatum, Nostoc sphaericum, Nostoc sphaeroides, Nostoc sphaerosporum, Nostoc spinosum, Nostoc subtilissimum, Nostoc symbioticum, Nostoc tenax, Nostoc tenuissimum, Nostoc thermophilum, Nostoc thermotolerans, Nostoc tibeticum, Nostoc torulosum, Nostoc trentepohlii, Nostoc tuberculosum, Nostoc undulatum, Nostoc vaillantii, Nostoc variegatum, Nostoc verrucosum, Nostoc vesicarium, Nostoc viride, Nostoc vulgare, Nostoc wartisporum, Nostoc wichmannii, Nostoc willei, Nostoc wollnyanum, Nostoc zetterstedtii, Oscillatoria spp., Oscillatoria amoena, Oscillatoria anguiformis, Oscillatoria anguina, Oscillatoria annae, Oscillatoria bonnemaisonii, Oscillatoria brevis, Ocillatoria chalybea, Oscillatoria chilkensis, Oscillatoria crassa, Oscillatoria croasdaleae, Oscillatoria curviceps, Oscillatoria depauperata, Oscillatoria engelmanniana, Oscillatoria euboeica, Oscillatoria fischeri, Oscillatoria fracta, Oscillatoria froelichii, Oscillatoria funiformis, Oscillatoria indica, Oscillatoria jenensis, Oscillatoria levis, Oscillatoria limosa, Oscillatoria limnetica, Oscillatoria mahabaleshwarensis, Oscillatoria major, Oscillatoria margaritifera, Oscillatoria miniata, Oscillatoria minutissima, Oscillatoria muralis, Oscillatoria nitida, Oscillatoria nylstromica, Oscillatoria obscura, Oscillatoria olivaceobrunnea, Oscillatoria princeps, Oscillatoria proboscidea, Oscillatoria pulchra, Oscillatoria rhamphoidea, Oscillatoria ribeyi, Oscillatoria rubescens, Oscillatoria sancta, Oscillatoria subbrevis, Oscillatoria subcapitata, Oscillatoria tapetiformis, Oscillatoria tenioides, Oscillatoria trichoides, Oscillatoria versicolor, Oscillatoria willei, Paenibacillus spp., Paenibacillus agarexedens, Paenibacillus agaridevorans, Paenibacillus alginolyticus, Paenibacillus alkaliterrae, Paenibacillus alvei, Paenibacillus amylolyticus, Paenibacillus anaericanus, Paenibacillus antarcticus, Paenibacillus apiarius, Paenibacillus assamensis, Paenibacillus azoreducens, Paenibacillus azotofixans, Paenibacillus barcinonensis, Paenibacillus borealis, Paenibacillus brasilensis, Paenibacillus brassicae, Paenibacillus campinasensis, Paenibacillus chinjuensis, Paenibacillus chitinolyticus, Paenibacillus chondroitinus, Paenibacillus cineris, Paenibacillus cookii, Paenibacillus curdlanolyticus, Paenibacillus daejeonensis, Paenibacillus dendritiformis, Paenibacillus durum, Paenibacillus ehimensis, Paenibacillus elgii, Paenibacillus favisporus, Paenibacillus glucanolyticus, Paenibacillus glycanilyticus, Paenibacillus gordonae, Paenibacillus graminis, Paenibacillus granivorans, Paenibacillus hodogayensis, Paenibacillus illinoisensis, Paenibacillus jamilae, Paenibacillus kobensis, Paenibacillus koleovorans, Paenibacillus koreensis, Paenibacillus kribbensis, Paenibacillus lactis, Paenibacillus larvae, Paenibacillus lautus, Paenibacillus lentimorbus, Paenibacillus macerans, Paenibacillus macquariensis, Paenibacillus massiliensis, Paenibacillus mendelii, Paenibacillus motobuensis, Paenibacillus naphthalenovorans, Paenibacillus nematophilus, Paenibacillus odorifer, Paenibacillus pabuli, Paenibacillus peoriae, Paenibacillus phoenicis, Paenibacillus phyllosphaerae, Paenibacillus polymyxa, Paenibacillus polymyxa strains ATCC 842, CCUG 1086, CFBP 4258, CIP 66.22, DSM 36, HAMBI 635 and 1897, JCM 2507, LMG 13294, NBRC 15309, NCCB 24016, NCTC 10343, NRRL B-4317, VKM B-514, Paenibacillus popilliae, Paenibacillus pulvifaciens, Paenibacillus rhizosphaerae, Paenibacillus sanguinis, Paenibacillus stellifer, Paenibacillus terrae, Paenibacillus thiaminolyticus, Paenibacillus timonensis, Paenibacillus tundrae, Paenibacillus turicensis, Paenibacillus tylopili, Paenibacillus validus, Paenibacillus vortex, Paenibacillus vulneris, Paenibacillus wynnii, Paenibacillus xylanilyticus, Pantoea spp., Pantoea agglomerans, Pantoea agglomerans strains ATCC 27155, CCUG 539, CDC 1461-67, CFBP 3845, CIP 57.51, DSM 3493, ICPB 3435, ICMP 12534, JCM 1236, LMG 1286, NCTC 9381, Pantoea ananatis, Pantoea citrea, Pantoea dispersa, Pantoea punctata, Pantoea stewartii, Pantoea terrea, Pantoea vagans, Phormidium spp., Phormidium aerugineo-caeruleum, Priestia spp., Priestia megaterium, Pseudomonas spp., Pseudomonas aeruginosa group, Pseudomonas aeruginosa, Pseudomonas alcaligenes, Pseudomonas alcaligenes strains ATCC 14909, CCUG 1425 A, CFBP 2437, CIP 101034, DSM 50342, JCM 5967, LMG 1224, NBRC 14159, NCCB 76044, NCTC 10367, VKM B-2171, Pseudomonas anguilliseptica, Pseudomonas argentinensis, Pseudomonas borbori, Pseudomonas citronellolis, Pseudomonas flavescens, Pseudomonas mendocina, Pseudomonas nitroreducens, Pseudomonas oleovorans, Pseudomonas pseudoalcaligenes, Pseudomonas pseudoalcaligenes strains ATCC 17440, CCUG 51525, CFBP 2435, CIP 66.14, DSM 50188, JCM 5968, LMG 1225, NBRC 14167, NCCB 76045, NCTC 10860, Pseudomonas resinovorans, Pseudomonas straminea, Pseudomonas chlororaphis group, Pseudomonas aurantiaca, Pseudomonas aureofaciens, Pseudomonas aureofaciens strains ATCC 13985, CFBP 2133, LMG 1245, Pseudomonas chlororaphis, Pseudomonas chlororaphis strains ATCC 9446, CCUG 552 B, CFBP 2132, CIP 63.22, DSM 50083, HAMBI 2011, JCM 2778, LMG 5004, NBRC 3904, NCCB 76041 and 37027, NCTC 13002, VKM B-1246, Pseudomonas fragi, Pseudomonas lundensis, Pseudomonas taetrolens, Pseudomonas fluorescens group, Pseudomonas antarctica, Pseudomonas azotoformans, Pseudomonas blatchfordae, Pseudomonas brassicacearum, Pseudomonas brenneri, Pseudomonas cedrina, Pseudomonas corrugata, Pseudomonas fluorescens, Pseudomonas fluorescens strains ATCC 13525, CCUG 1253, CCEB 546, CFBP 2102, CIP 69.13, DSM 50090, JCM 5963, LMG 1794, NBRC 14160, NCCB 76040, NCIMB 9046, NCTC 10038, NRRL B-14678, VKM B-894, G20-18, Pseudomonas gessardii, Pseudomonas libanensis, Pseudomonas mandelii, Pseudomonas marginalis, Pseudomonas mediterranea, Pseudomonas meridiana, Pseudomonas migulae, Pseudomonas mucidolens, Pseudomonas orientalis, Pseudomonas panacis, Pseudomonas proteolytica, Pseudomonas rhodesiae, Pseudomonas synxantha, Pseudomonas thivervalensis, Pseudomonas tolaasii, Pseudomonas veronii, Pseudomonas pertucinogena group, Pseudomonas denitrificans, Pseudomonas pertucinogena, Pseudomonas putida group, Pseudomonas cremoricolorata, Pseudomonas entomophila, Pseudomonas fulva, Pseudomonas monteilii, Pseudomonas monteilii strains ATCC 700476, CCUG 38736, CFML 90-60, CIP 104883, DSM 14164, JCM 21585, Pseudomonas mosselii, Pseudomonas oryzihabitans, Pseudomonas parafulva, Pseudomonas plecoglossicida, Pseudomonas putida, Pseudomonas putida strains ATCC 12633, CCUG 12690, CFBP 2066, DSM 291, HAMBI 7, JCM 13063 and 20120, LMG 2257, NBRC 14164, NCAIM B.01634, NCCB 72006 and 68020, NCTC 10936, PP20, Pseudomonas stutzeri group, Pseudomonas balearica, Pseudomonas luteola, Pseudomonas stutzeri, Pseudomonas syringae group, Pseudomonas amygdali, Pseudomonas avellanae, Pseudomonas caricapapayae, Pseudomonas cichorii, Pseudomonas coronafaciens, Pseudomonas ficuserectae, Pseudomonas helianthi', Pseudomonas meliae, Pseudomonas savastanoi, Pseudomonas syringae, Pseudomonas tomato', Pseudomonas viridiflava, incertae sedis, Pseudomonas abietaniphila, Pseudomonas acidophila, Pseudomonas agarici, Pseudomonas alcaliphila, Pseudomonas alkanolytica, Pseudomonas amyloderamosa, Pseudomonas asplenii, Pseudomonas azotifigens, Pseudomonas cannabina, Pseudomonas coenobios, Pseudomonas congelans, Pseudomonas costantinii, Pseudomonas cruciviae, Pseudomonas delhiensis, Pseudomonas excibis, Pseudomonas extremorientalis, Pseudomonas frederiksbergensis, Pseudomonas fuscovaginae, Pseudomonas gelidicola, Pseudomonas grimontii, Pseudomonas indica, Pseudomonas jessenii, Pseudomonas jessenii CIP 105274, Pseudomonas jinjuensis, Pseudomonas kilonensis, Pseudomonas kilonensis (PK11), Pseudomonas knackmussii, Pseudomonas koreensis, Pseudomonas lini, Pseudomonas lutea, Pseudomonas moraviensis, Pseudomonas otitidis, Pseudomonas pachastrellae, Pseudomonas palleroniana, Pseudomonas papaveris, Pseudomonas peli, Pseudomonas perolens, Pseudomonas poae, Pseudomonas pohangensis, Pseudomonas protegens, Pseudomonas psychrophila, Pseudomonas psychrotolerans, Pseudomonas rathonis, Pseudomonas reptilivora, Pseudomonas resiniphila, Pseudomonas rhizosphaerae, Pseudomonas rubescens, Pseudomonas salomonii, Pseudomonas segitis, Pseudomonas septica, Pseudomonas simiae, Pseudomonas suis, Pseudomonas teessidea, Pseudomonas thermotolerans, Pseudomonas toyotomiensis, Pseudomonas tremae, Pseudomonas trivialis, Pseudomonas turbinellae, Pseudomonas tuticorinensis, Pseudomonas umsongensis, Pseudomonas vancouverensis, Pseudomonas vranovensis, Pseudomonas xanthomarina, Rhizobium spp., Rhizobium acidisoli, Rhizobium aegyptiacum, Rhizobium aethiopicum, Rhizobium aggregatum, Rhizobium alamii, Rhizobium altiplani, Rhizobium alvei, Rhizobium anhuiense, Rhizobium aquaticum, Rhizobium arenae, Rhizobium arsenicireducens, Rhizobium azibense, Rhizobium azooxidifex, Rhizobium bangladeshense, Rhizobium binae, Rhizobium calliandrae, Rhizobium capsici, Rhizobium cauense, Rhizobium cellulosilyticum, Rhizobium changzhiense, Rhizobium chutanense, Rhizobium daejeonense, Rhizobium dioscoreae, Rhizobium ecuadorense, Rhizobium endolithicum, Rhizobium endophyticum, Rhizobium esperanzae, Rhizobium etli, Rhizobium fabae, Rhizobium favelukesii, Rhizobium flavum, Rhizobium freirei, Rhizobium gallicum, Rhizobium gei, Rhizobium grahamii, Rhizobium hainanense, Rhizobium halophytocola, Rhizobium helianthi, Rhizobium hidalgonense, Rhizobium indigoferae, Rhizobium ipomoeae, Rhizobium jaguaris, Rhizobium laguerreae, Rhizobium leguminosarum, Rhizobium leguminosarum strains ATCC 10004, LMG 14904, 3Hoq18, USDA 2370, Rhizobium lemnae, Rhizobium lentis, Rhizobium leucaenae, Rhizobium loessense, Rhizobium lusitanum, Rhizobium marinum, Rhizobium mayense, Rhizobium mesoamericanum, Rhizobium mesosinicum, Rhizobium metallidurans, Rhizobium miluonense, Rhizobium mongolense, Rhizobium multihospitium, Rhizobium naphthalenivorans, Rhizobium oryzicola, Rhizobium pakistanense, Rhizobium paranaense, Rhizobium petrolearium, Rhizobium phaseoli, Rhizobium pisi, Rhizobium populi, Rhizobium puerariae, Rhizobium rhizogenes, Rhizobium rhizophilum, Rhizobium rhizoryzae, Rhizobium rosettiformans, Rhizobium ruizarguesonis, Rhizobium selenitireducens, Rhizobium smilacinae, Rhizobium soli, Rhizobium sophorae, Rhizobium sophoriradicis, Rhizobium straminoryzae, Rhizobium sullae, Rhizobium tarimense, Rhizobium tibeticum, Rhizobium tropici, Rhizobium tubonense, Rhizobium tumorigenes, Rhizobium vallis, Rhizobium viscosum, Rhizobium wenxiniae, Rhizobium wuzhouense, Rhizobium yanglingense, Rhizobium yantingense, Rhizobium zeae, Rhizobium album, Rhizobium albus, Rhizobium deserti, Rhizobium flavescens, Rhizobium glycinendophyticum, Rhizobium halotolerans, Rhizobium hedysari, Rhizobium helanshanense, Rhizobium indicum, Rhizobium kunmingense, Candidatus Rhizobium massiliense, Rhizobium oryzihabitans, Rhizobium panacihumi, Rhizobium phenanthrenilyticum, Rhizobium pongamiae, Rhizobium qilianshanense, Rhizobium rhizolycopersici, Rhizobium rhizosphaerae, Rhizobium terrae, Rhodobacter spp., Rhodobacter aestuarii, Rhodobacter azotoformans, Rhodobacter blasticus, Rhodobacter capsulatus, Rhodobacter johrii, Rhodobacter maris, Rhodobacter megalophilus, Rhodobacter ovatus, Rhodobacter sphaeroides, Rhodobacter veldkampii, Rhodobacter vinaykumarii, Rhodobacter viridis, Rhodopseudomonas spp., Rhodopseudomonas boonkerdii, Rhodopseudomonas cryptolactis, Rhodopseudomonas faecalis, Rhodopseudomonas harwoodiae, Rhodopseudomonas julia, Rhodopseudomonas palustris, Rhodopseudomonas palustris strains CGA009, DX-1, TIE-1, Rhodopseudomonas parapalustris, Rhodopseudomonas pentothenatexigens, Rhodopseudomonas pseudopalustris, Rhodopseudomonas rhenobacensis, Rhodopseudomonas telluris, Rhodopseudomonas thermotolerans, Rhodopseudomonas sphaeroides, Schinkia spp., Schinkia azotoformans, Serratia spp., Serratia aquatilis, Serratia entomophila, Serratia ficaria, Serratia fonticola, Serratia glossinae, Serratia grimesii, Serratia liquefaciens, Serratia marcescens, Serratia myotis, Serratia nematodiphila, Serratia odorifera, Serratia plymuthica, Serratia proteamaculans, Serratia quinivorans, Serratia rubidaea, Serratia symbiotica, Serratia ureilytica, Serratia vespertilionis, Streptococcus spp., Streptococcus acidominimus, Streptococcus agalactiae, Streptococcus alactolyticus, Streptococcus anginosus, Streptococcus australis, Streptococcus caballi, Streptococcus cameli, Streptococcus canis, Streptococcus caprae, Streptococcus castoreus, Streptococcus criceti, Streptococcus constellatus, Streptococcus cristatus, Streptococcus cuniculi, Streptococcus danieliae, Streptococcus dentasini, Streptococcus dentiloxodontae, Streptococcus dentirousetti, Streptococcus devriesei, Streptococcus didelphis, Streptococcus downei, Streptococcus dysgalactiae, Streptococcus entericus, Streptococcus equi, Streptococcus equinus, Streptococcus ferus, Streptococcus gallinaceus, Streptococcus gallolyticus, Streptococcus gordonii, Streptococcus halichoeri, Streptococcus halotolerans, Streptococcus henryi, Streptococcus himalayensis, Streptococcus hongkongensis, Streptococcus hyointestinalis, Streptococcus hyovaginalis, Streptococcus ictaluri, Streptococcus infantarius, Streptococcus infantis, Streptococcus iniae, Streptococcus intermedius, Streptococcus lactarius, Streptococcus loxodontisalivarius, Streptococcus lutetiensis, Streptococcus macacae, Streptococcus marimammalium, Streptococcus marmotae, Streptococcus massiliensis, Streptococcus merionis, Streptococcus minor, Streptococcus mitis, Streptococcus moroccensis, Streptococcus mutans, Streptococcus oralis, Streptococcus oricebi, Streptococcus oriloxodontae, Streptococcus orisasini, Streptococcus orisratti, Streptococcus orisuis, Streptococcus ovis, Streptococcus panodentis, Streptococcus pantholopis, Streptococcus parasanguinis, Streptococcus parasuis, Streptococcus parauberis, Streptococcus peroris, Streptococcus pharyngis, Streptococcus phocae, Streptococcus pluranimalium, Streptococcus plurextorum, Streptococcus pneumoniae, Streptococcus porci, Streptococcus porcinus, Streptococcus porcorum, Streptococcus pseudopneumoniae, Streptococcus pseudoporcinus, Streptococcus pyogenes, Streptococcus ratti, Streptococcus rifensis, Streptococcus rubneri, Streptococcus rupicaprae, Streptococcus salivarius, Streptococcus saliviloxodontae, Streptococcus sanguinis, Streptococcus sinensis, Streptococcus sobrinus, Streptococcus suis, Streptococcus tangierensis, Streptococcus thoraltensis, Streptococcus troglodytae, Streptococcus troglodytidis, Streptococcus tigurinus, Streptococcus thermophilus, Streptococcus uberis, Streptococcus urinalis, Streptococcus ursoris, Streptococcus vestibularis, Streptococcus zooepidemicus, Viridans streptococci, Streptococcus anginosus group, Streptomyces spp., Streptomyces atratus, Streptomyces atratus strains 46408, AS 4.1632, ATCC 14046, CBS 364.68, CGMCC 4.1632, DSM 41673, IFO 3897, JCM 3386, NBRC 3897, NRRL B-16927, Streptomyces aurantiogriseus, Streptomyces aurantiogriseus strains AS 4.1450, ATCC 19887, ATCC 23883, BCRC 13758, CBS 663.68, CCRC 13758, CGMCC 4.1450, DSM 40138, ETH 24202, ETH 27525, IFO 12842, INA 10369/58, ISP 5138, JCM 4346, KCC S-0346, KCCS-0346, LMG 19298, NBRC 12842, NCIB 9849, NCIMB 9849, NRRL B-5416, NRRL-ISP 5138, R-8658, RIA 1130, VKM Ac-1093, Streptomyces chromofuscus, Streptomyces chromofuscus strains 13638/58, AS 4.1451, ATCC 23896, BCRC 15125, CBS 682.68, CCRC 15125, CGMCC 4.1451, DSM 40273, IFO 12851, INA 13638/58, ISP 5273, JCM 4354, KCC S-0354, KCTC 19069, Lanoot R-8679, LMG 19317, NBRC 12851, NRRL B-12175, NRRL-ISP 5273, R-8679, RIA 1191, VKM Ac-974, Streptomyces cinerochromogenes, Streptomyces cinerochromogenes strains AS 4.162, ATCC 33339, CGMCC 4.1620, DSM 41651, Fuji 50, IFO 13822, IFO 13922, JCM 3385, NBRC 13822, NBRC 13922, NRRL B-1692, NRRL B-16928, P1, Streptomyces coelicolor, Streptomyces coelicolor strains AS 4.1291, ATCC 25422, BCRC 13699, CBS 416.34, CBS 920.69, CCRC 13699, CGMCC 4.1291, CIP 105122, DSM 40455, ETH 10209, ICMP 12537, ICSSB 1006, IFO 13010, IMRU 850, IMSNU 20133, IMSNU 21006, ISP 5455, JCM 4446, KCC S-0446, KCC S-0466, KCC S-1072, KCCS-0466, KCTC 9202, Lanoot R-8660, LMG 19300, MTCC 932, NBIMCC 2386, NBRC 13010, NCIB 10043, NCIMB 10043, NRRL B-1271, NRRL B-2663, NRRL B-B-2663, NRRL-ISP 5455, RIA 1202, strain ATCC 25422, VKM Ac-746, VTT E-991429, Streptomyces griseoviridis, “Streptomyces griseoviridis strains A 9071, Anderson PD 04955, AS 4.1418, ATCC 23920, BCRC 15101, CBS 904.68, CCRC 15101, CGMCC 4.1418, DSM 40229, ETH 31501, HAMBI 1086, IFO 12874, IMRU 3735, ISP 5229, JCM 4250, JCM 4643, KCC S-0250, KCC S-0643, KCCM 40225, KCCS-0250, KCCS-0643, KCTC 9780, Lanoot R-8683, LMG 19321, NBRC 12874, NCIMB 9853, NRRL 2427, NRRL B-2427 T, NRRL-ISP 5229, P-D 04955, R-8683, RIA 1170, VKM Ac-622”, Streptomyces griseus, Streptomyces griseus strains 16S rRNA gene clade, IFO 13350 strain, Streptomyces hygroscopicus, Streptomyces hygroscopicus subsp. aureolacrimosus, Streptomyces hygroscopicus subsp. Hygroscopicus, Streptomyces hygroscopicus subsp. Ossamyceticus, Streptomyces hygroscopicus subsp. yakushimaensis, Streptomyces janthinus, Streptomyces janthinus strains ATCC 15870, ATCC 23925, BCRC 12074, CBS 909.68, CCRC 12074, CCT 5008, DSM 40206, IFO 12879, INMI 117, ISP 5206, JCM 4387, KCC S-0387, LMG 8591, NBRC 12879, NRRL B-3365, NRRL-ISP 5206, RIA 1155, RIA 659, VKM Ac-208, Streptomyces lydicus, Streptomyces lydicus strain WYEC 108, Streptomyces lydicus strains AS 4.1412, ATCC 25470, BCRC 11919, CBS 703.69, CCRC 11919, CDBB 1232, CECT 3163, CEST 3163, CGMCC 4.1412, D-45, DSM 40461, DSMZ 40461, HAMBI 1063, IFO 13058, IMET 43531, ISP 5461, JCM 4492, KCC S-0492, KCCS-0492, KCTC 9874, Lanoot R-8695, LMG 19331, NBRC 13058, NCIMB 12977, NRRL 2433, NRRL B-2433, NRRL-ISP 5461, R-8695, RIA 1250, Upjohn Co. UC D-45, VKM Ac-1869, Streptomyces rectiverticillatum, Streptomyces rimosus, Streptomyces rimosus S. rimosus paromomycinus, Streptomyces rimosus S. rimosus rimosus, Streptomyces venezuelae, Streptomyces violaceus, Streptomyces violaceus strains ATCC 15891, ATCC 25516, BCRC 13791, CBS 658.69, CCRC 13791, CCT 5007, CECT 3237, CGMCC 4.1772, DSM 40205, DSMZ 40205, IFO 13104, INMI 1212, ISP 5205, JCM 4534, KCC S-0534, KCCM 40125, KCTC 9788, LMG 20275, NBRC 13104, NIHJ 493, NRRL B-5432, NRRL-ISP 5205, RIA 1296, RIA 157, UNIQEM 204, VKM Ac-528, Streptomyces violascens, Streptomyces violascens strains ATCC 23968, BCRC 12240, CBS 266.66, CBS 951.68, CCRC 12240, CECT 3215, CGMCC 4.1923, DSM 40183, DSMZ 40183, IFO 12920, IMET 42061, INA 3959/54, ISP 5183, JCM 4424, KCC S-0424, KCCM 40103, KCCS-0424, KCTC 9785, NBRC 12920, NCIB 9820, NCIMB 9820, NRRL B-2700, NRRL-ISP 5183, RIA 1138, VKM Ac-1275, Streptomyces viridochromeogenes, Streptomyces viridodiasticus, Streptomyces viridodiastaticus, Streptomyces viridodiastaticus strains ATCC 25518, Baldacci IPV 334a, BCRC 12458, CBS 660.69, CCRC 12458, CGMCC 4.1780, DSM 40249, ETH 24357, IFO 13106, IPV 334 a, ISP 5249, JCM 4536, KCC S-0536, KCTC 19977, LMG 20279, NBRC 13106, NRRL B-5622, NRRL-ISP 5249, RIA 1298, VKM Ac-1749, VTT E-011973, Synechocystis spp., and Synechocystis sp. PCC 6803, acetic acid bacteria (AAB), Acetobacteraceae, Komagataeibacter, Gluconacetobacter, and Acetobacter

In some embodiments, the pesticide may be a chemical or other substance including (−)-.alpha.-Cubebene; (1,1′-Biphenyl)-2-ol, 3,5-dichloro-; (1,1′-Biphenyl)-2-ol, 3,5-dichloro-, potassium salt; (1,1′-Biphenyl)-2-ol, 3-chloro-; (1,1′-Biphenyl)-2-ol, 5-chloro-; (1,1′-Biphenyl)-2-ol, 5-chloro-, potassium salt; (1,1′-Biphenyl)-2-ol, ammonium salt; (1,1′-Biphenyl)-4-ol, sodium salt; (3S, 6R)-3-METHYL-6-ISOPROPENYL-9-DECEN-1-YL ACETATE; (3S, 6S)-3-METHYL-6-ISOPROPENYL-9-DECEN-1-YL ACETATE; (Benzamidooxy)acetic acid, ammonium salt; (E)-(3,3-Dimethylcyclohexylidene)acetaldehyde; (E)-11-Tetradecen-1-ol acetate; (E)-4-TRIDECEN-1-YL-ACETATE; (E)-4-Tridecen-1-yl acetate; (E)-5-DECEN-1-OL; (E)-5-DECENOL; (E)-5-DECENYL ACETATE; (E)-8-Dodecen-1-yl acetate; (E)-9-Dodecen-1-ol acetate; (E)-9-Tricosene; (E,E)-9,11-TETRADECADIEN-1-YL ACETATE; (E,Z)-3,13-Octadecadien-1-ol acetate; (R,Z)-5-(1-Decenyl)dihydro-2(3H)-furanone; (S)-KINOPRENE; (S)-VERBENONE; (Z)-(3,3-Dimethylcyclohexylidene)acetaldehyde; (Z)-11-Hexadecen-1-ol; (Z)-11-HEXADECEN-1-YL ACETATE; (Z)-11-HEXADECENAL; (Z)-11-Hexadecenyl acetate; (Z)-11-Tetradecenyl acetate; (Z)-13-Octadecenal; (Z)-13-Octadecenyl acetate; (Z)-2-(3,3-Dimethylcyclohexylidene)ethanol; (Z)-2-Carbomethoxy-1-methylvinyl dimethyl phosphate; (Z)-4-Tridecen-1-yl acetate; (Z)-4-TRIDECEN-1-YL-ACETATE; (Z)-6-Heneicosen-11-one; (Z)-8-Dodecen-1-yl acetate; (Z)-9-DODECENYL ACETATE; (Z)-9-HEXADECENAL; (Z)-9-Tetradecen-1-ol; (Z)-9-Tetradecenal; (Z,E)-3,13-Octadecadienol; (Z,E)-7,9,11-DODECATRIENYL FORMATE; (Z,E)-9,12-Tetradecadien-1-ol acetate; (Z,Z)-11,13-HEXADECADIENAL; (Z,Z)-3,13-Octadecadien-1-ol; (Z,Z)-3,13-Octadecadien-1-ol acetate; .beta.-Alanine, N-acetyl-N-butyl-, ethyl ester; (1,1′-Biphenyl)-2-ol, 3(or 5)-chloro-, compd. with 2,2′-iminobis(ethanol) (1:1); (1,1′-Biphenyl)-2-ol, 3-chloro-, sodium salt; (1,1′-Biphenyl)-2-ol, 5-chloro-, sodium salt; (1,1′-Biphenyl)-4-ol, 3-chloro-, sodium salt; 1-((2,3,6-Trichlorobenzyl)oxy)-2-propanol; 1-((6-Chloro-3-pyridinyl)methyl)-4,5-dihydro-N-nit<BR>ro-1H-imidazol-2-amine; 1-(2-(2-Chlorobenzyl)-2-hydroxy-3,3-dimethylbutyl)<BR>-1,2,4-triazole; 1-(2-Hydroxyethyl)-2-alkyl-2-imidazoline (as in fatty acids of tall oil); 1-(2-HYDROXYETHYL)-2-ALKYL-2-IMIDAZOLINE, ALKYL DERIVED FROM TALL OIL FATTY ACIDS; 1-(2-Hydroxyethyl)-2-heptadecenyl-2-imidazoline; 1-(3-Chloroallyl)-3,5,7-triaza-1-azoniaadamantane chloride; 1-(Alkyl*amino)-3-aminopropane *(42% C12, 26% C18, 15% C14, 8% C16, 5% C10, 4% C8); 1-(Alkyl* amino)-3-aminopropane *(53% C12, 19% C14, 8.5% C16, 7% C8, 6.5% C10, 6% C18); 1-(Alkyl* amino)-3-aminopropane adipate *(as in fatty acids of coconut oil); 1-(Alkyl* amino)-3-aminopropane benzoate *(as in fatty acids of coconut oil); 1-(Alkyl* amino)-3-aminopropane diacetate *(as in fatty acids of coconut oil); 1-(Alkyl* amino)-3-aminopropane hydroxyacetate *(as in fatty acids of coconut oil); 1-(Alkyl* amino)-3-aminopropane monoacetate *(47% C12, 18% C14, 10% C18, 9% C10, 8% C16, 8% C8); 1-(Alkyl* amino)-3-aminopropane monoacetate *(as in fatty acids of coconut oil); 1-(Alkyl* amino)-3-aminopropane propionate-copper acetate complex; 1(or 2)-(2-Methoxymethylethoxy)propanol; 1,1,2,2-Tetrachloroethane; 1,12-Di(3-decyl-2-methylimidazolium)dodecane dibromide; 1,1′-Dimethyl-4,4′-bipyridinium bis(methyl sulfate); 1,1′-Oxybis(2,2-dichloroethane); 1,2,3-Propanetricarboxylic acid, 2-hydroxy-, ammonium salt; 1,2,3-PROPANETRIOL, HOMOPOLYMER, (Z)-9-OCTADECENOATE; 1,2,3-Propanetriol, mono(4-aminobenzoate); 1,2,4,5-Tetrachloro-3-nitrobenzene; 1,2,4-Triazine-5(4H)-one, 4-amino-6-(1,1-dimethylethyl)-3-(ethylthio)-; 1,2,4-Triazolo(4,3-a)pyridin-3(2H)-one,2-(2,4-dich<BR>loro-5-(2-propynyloxy)phenyl)-5,6,7,8-tetrahydro-; 1,2,4-Trichlorobenzene; 1,2,4-Trimethoxybenzene; 1,2-Benzenedicarboxaldehyde; 1,2-Benzisothiazol-3(2H)-one, 2-butyl-; 1,2-BENZISOTHIAZOLIN-3-ONE; 1,2-Benzisothiazolin-3-one, 2-butyl; 1,2-DIBROMO-2,4-DICYANOBUTANE; 1,2-Dibromo-3-chloropropane; 1,2-Dichloropropane; 1,2-Dihydro-3,6-pyridazinedione, diethanolamine salt; 1,2-Ethanediamine; 1,2-Ethanediamine, N-((2-(1-nitroethyl)phenyl)methyl)-, monopotassium salt; 1,2-Ethanediamine, N,N-dimethyl-N′-2-pyridinyl-N′-(2-thienylmethyl)-, monohydrochloride; 1,2-Ethanediamine, polymer with (chloromethyl)oxirane and N-methylmethanamine; 1,2-Ethanediol; 1,2-Ethylene dichloride; 1,2-Methylenedioxy-4-(2-(octylsulfidnyl)propyl)ben<BR>zene; 1,3,2-Benzodioxabismole-5-carboxylic acid, 2,7-dihydroxy-; 1,3,2-Dioxaborinane, 2,2′-((1-methyl-1,3-propanediyl)bis(oxy))bis(4-methyl-; 1,3,2-Dioxaborinane, 2,2′oxybis(4,4,6-trimethyl-; 1,3,2-Dioxaphosphorinane, ethanimidiothioic acid deriv.; 1,3,4-Metheno-1H-cyclobuta(cd)pentalene, 1,1a,2,2,3,3a,4,5,5,5a,5b,6-dodecachlorooctahydro-; 1,3,5-Triazine-1,3,5(2H,4H,6H)-triethanol, .alpha.,.alpha.′,.alpha.′-trimethyl-; 1,3,5-Triazine-2,4,6(1H,3H,5H)-trione, 1,3,5-trichloro-, mixt. with 1,3-dichloro-1,3,5-triazine-2,4,6(1H,3H,5H)-trione potassium salt; 1,3,5-Triazine-2,4-diamine, N-(1,2-dimethylpropyl)-N′-ethyl-6-(methylthio)-; 1,3,5-Triazine-2,4-diamine, N-cyclopropyl-N′-(1,1-dimethylethyl)-6-(methylthio)-; 1,3,5-Triazine-2-amine, 4,6-dichloro-N-(2-chlorophenyl)-; 1,3,5-Triethylhexahydro-s-triazine; 1,3-BIS(HYDROXYMETHYL)-5,5-DIMETHYL HYDANTOIN; 1,3-Butylene glycol; 1,3-Dibromo-5,5-dimethylhydantoin; 1,3-Dibromo-5-ethyl-5-methylhydantoin; 1,3-Dichloro-5,5-dimethylhydantoin; 1,3-Dichloro-5-ethyl-5-methylhydantoin; 1,3-DICHLOROPROPENE; 1,3-Dichloropropene, Telone; 1,3-Dimethylol-5,5-dimethylhydantoin; 1,3-Dioxane, 5-bromo-2-methyl-3-nitro-; 1,3-Propanediamine, N-(3-aminopropyl)-N-dodecyl-; 1,3-Propanediamine, N-9-octadecenyl-, (Z)-, mono-D-gluconate; 1,3-Propanediol, 2-methyl-2-nitro-; 1,4:5,8-Dimethanonaphthalene, 1,2,3,4,10,10-hexachloro-1,4,4a,5,8,8a-hexahydro-, (1.alpha.,4.alpha.,4a.beta.,5.alpha.,8.alpha.,8a.beta.)-; 1,4-DIEMETHYLNAPHTHALENE; 1,4-Dimethylnapthalene; 1,6,10-Dodecatriene, 7,11-dimethyl-3-methylene-, (E)-; 1,6-Diamino-2,2-difluorohexane; 1,7-Dioxaspiro[5.5] undecane; 10,10′-Oxybisphenoxarsine; 10,10′-OXYBISPHENOXYARSINE; 11-Tetradecen-1-ol, (E)-; 1-alpha-Hydroxyergocalciferol; 1-AMINOCYCLOPROPANE-1-CARBOXYLIC ACID; 1-Bromo-1-(bromomethyl)-1,3-propanedicarbonitrile; 1-BROMO-3-CHLORO-5,5-DIMETHYL HYDANTOIN; 1-Bromo-3-chloro-5,5-dimethylhydantoin; 1-Butanethiol; 1-Chloro-2-nitropropane; 1-CHLORO-5,5-DIMETHYLHYDANTOIN; 1-Cyanoguanidine; 1-Decanaminium, N,N-dimethyl-N-octyl-, chloride; 1-Decanaminium, N-decyl-N,N-dimethyl-, chloride; 1-Decanol; 1-Dodecanamine, N,N-dimethyl-, acetate; 1-Dodecanaminium, N,N-dimethyl-N-octyl-, chloride; 1-Dodecanamium-N,N′-methylenebis(oxy-2,1-ethanediyl)bis(N,N-dimethyl-, dichloride; 1-Ethyl-2-heptadecenyl-1-(2-hydroxyethyl)-2-imidazolinium bromide; 1H,3H,5H,-Oxazolo(3,4-c)oxazole, poly(oxymethylene) deriv.; 1H-1,2,4-Triazole; 1H-1,2,4-Triazole, 1-((2-(2,4-dichlorophenyl)-4-ethyl-1,3-dioxolan-2-yl)methyl)-; 1H-1,2,4-Triazole, 1-((4-bromo-2-(2,4-dichlorophenyl)tetrahydro-2-furanyl)methyl)-; 1H-1,2,4-Triazole, 1-(2-(2,4-dichlorophenyl)pentyl)-; 1-Hexanol; 1H-Imidazol-2-ethanol, 1-(heptadecenyl)-4,5-dihydro-, monohydrochloride; 1H-Imidazole, 2-heptadecyl-4,5-dihydro-, monoacetate; 1H-Imidazole, heptadecenyl-4,5-dihydro-, monohydrochloride; 1H-Imidazole-1-ethanol, 2-methyl-5-nitro-; 1H-Imidazoleethanol, heptadecyl-4,5-dihydro-, monohydrochloride; 1H-Indene-1,3(2H)-dione, 2-(2,2-dimethyl-1-oxopropyl)-, ion(1-), calcium; 1H-Indene-1,3(2H)-dione, 2-(3-methyl-1-oxobutyl)-; 1-H-Purin-6-amine, N-(2-furanylmethyl)-; 1H-Purine-2,6-dione, 3,7-dihydro-1,3,7-trimethyl-; 1H-Pyrazole-1-methanol, 3,5-dimethyl-; 1H-Pyrrole-2,5-dione, 1-(2-methyl-1-naphthalenyl)-; 1H-Pyrrole-3-carbonitrile,4-bromo-2-(4-chloropheny<BR>1)-5-(trifluoromethyl)-; 1-Indole-3-butanethioic acid, S-phenyl ester; 1-METHYLCYCLOPROPENE; 1-NAPHTHALENEACETAMIDE; 1-Naphthaleneacetic acid; 1-Naphthaleneacetic acid (see Naphthaleneacetic Acid, Its Salts; 1-Napthalenesulfonic acid, methyl ester; 1-Octadecanaminium, N,N-dimethyl-N-(3-(trimethoxysilyl)propyl)-, chloride; 1-Octanaminium, N,N-dimethyl-N-octyl-, chloride; 1-Octanol; 1-OCTEN-3-OL; 1-Pentanethiol; 1-Phenanthrenemethanamine, 1,2,3,4,4a,9,10,10a-octahydro-1,4a-dimethyl-7-(1-methylethyl)-, 1R-(1.alpha.,4a.beta.,10a.alpha.)-; 1-Phenanthrenemethanamine, 1,2,3,4,4a,9,10,10a-octahydro-1,4a-dimethyl-7-(1-methylethyl)-, acetate, (1R-(1.alpha.,4a.beta.,10a.alpha.))-1-TETRADECANAMINE, N,N-DIMETHYL-, N-OXIDE; 1-Tetradecanol, formate; 1-Triacontanol; 1-Tridecanamine, N,N-dimethyl-, 7-oxabicyclo(2.2.1)heptane-2,3-dicarboxylate (2:1); 2-((Hydroxymethyl)amino)-2-methyl-1-propanol; 2-((Hydroxymethyl)amino)ethanol; 2-(2-(P-(DIISOBUTYL) PHENOXY) ETHOXY) ETHYL DIMETHYLBENZYL AMMONIUM CHLORIDE; 2-(2-Butoxyethoxy)ethyl thiocyanate; 2-(2-Ethoxyethoxy)ethyl 2-benzimidazole carbamate; 2(3H)-Furanone, dihydro-5-pentyl-; 2-(3-HYDROXYPROPYL)-HEPTA-METHYL TRISILOXANE, ETHOXYLATED, ACETATE; 2-(4-tert-Butylphenoxy)isopropyl-2-chloroethyl sulfite; 2-(Decylthio)ethanamine hydrochloride; 2-(Hydroxymethyl)-2-nitro-1,3-propanediol; 2-(m-Chlorophenoxy)propionamide; 2-(m-Chlorophenoxy)propionic acid; 2-(m-Chlorophenoxy)propionic acid, sodium salt; 2-(Thiocyanomethylthio)benzothiazole; 2,2′-(1-METHYLTRIMETHYLENEDIOXY)BIS-(4-METHYL-1,3,2-DIOXABORINANE); 2,2′-(COCOALKYLIMINO)-BIS-(ETHANOL) WITH BIS-(2-ETHYLHEXYL) PHOSPHATE (1:1); 2,2′-(COCOALKYLIMINO)-BIS-(ETHANOL) WITH MONO (2-ETHYLHEXYL) PHOSPHATE (1:1); 2,2-DIBROMO-3-NITRILOPROPIONAMIDE; 2,2′-Dithiobisbenzothiazole; 2,2′-Methylenebis(3,4,6-trichlorophenol); 2,2′-Methylenebis(4-chlorophenol); 2,2′-OXYBIS (4,4,6-TRIMETHYL-1,3,2-DIOXABORINANE); 2,2′-Thiobis(4-chloro-6-methylphenol); 2,3,4,5-Bis(2-butylene)tetrahydro-2-furaldehyde; 2,3,5-Trichloro-4-(propylsulfonyl)pyridine; 2,3,5-Trimethylphenyl methylcarbamate; 2,3,6-Trichlorobenzoic acid; 2,3,6-Trichlorobenzoic acid and related polychlorobenzoic acids, dimethylamine salt of; 2,3,6-Trichlorophenylacetic acid; 2,3,6-Trichlorophenylacetic acid, sodium salt; 2,3-Dichloro-1,4-napthoquinone; 2,3-Dichloropropene; 2,4(1H,3H)-Pyrimidinedione, 5-bromo-6-methyl-3-(1-methylpropyl)-, compd. with N-methylmethanamine (1:1); 2,4,5-T; 2,4,5-Trichlorophenol; 2,4,5-Trichlorophenoxyacetic acid; 2,4,5-Trichlorophenoxyacetic acid, 2-ethyl-4-methylpentyl ester; 2,4,5-Trichlorophenoxyacetic acid, alkyl (C3-C7) ester; 2,4,5-Trichlorophenoxyacetic acid, amyl ester; 2,4,5-Trichlorophenoxyacetic acid, butoxyethoxypropanol ester; 2,4,5-Trichlorophenoxyacetic acid, butyl ester; 2,4,5-Trichlorophenoxyacetic acid, diethylethanolamine salt; 2,4,5-Trichlorophenoxyacetic acid, dimethylamine salt; 2,4,5-Trichlorophenoxyacetic acid, isopropyl ester; 2,4,5-Trichlorophenoxyacetic acid, N,N-dimethyl oleyl-linoleyl amine salt; 2,4,5-Trichlorophenoxyacetic acid, N,N-dimethyloleylamine salt; 2,4,5-Trichlorophenoxyacetic acid, triethanolamine salt; 2,4,5-Trichlorophenoxyacetic acid, triethylamine salt; 2,4,6-Trichlorophenol; 2,4,6-Trichlorophenol, sodium salt; 2,4-D; 2,4-D butoxyethyl ester (BEE); 2,4-D isopropanolamine salt (IPA); 2,4-D triisopropanolamine salt (TIPA); 2,4-D, 2-ETHYLHEXYL ESTER; 2,4-D, alkanolamine salt; 2,4-D, BUTOXYETHANOL ESTER; 2,4-D, butoxyethyl ester; 2,4-D, DIETHANOLAMINE SALT; 2,4-D, DIMETHYLAMINE SALT; 2,4-D, ISOOCTYL ESTER; 2,4-D, ISOPROPYL ESTER; 2,4-D, isopropylamine salt; 2,4-D, lithium salt; 2,4-D, sodium salt; 2,4-D, tetradecylamine salt; 2,4-D, TRIISOPROPANOLAMINE SALT; 2,4-D, TRIISOPROPYLAMINE SALT; 2,4-DB; 2,4-DECADIENOIC ACID, ETHYL ESTER, (2E,4Z)-; 2,4-dichlorophenoxyacetic acid, 2-octyl ester; 2,4-dichlorophenoxyacetic acid, 3-butoxypropyl ester; 2,4-dichlorophenoxyacetic acid, alkylamines derived from tall oil; 2,4-Dichlorophenoxyacetic acid, ammonium salt; 2,4-dichlorophenoxyacetic acid, butoxyethylpropyl ester; 2,4-dichlorophenoxyacetic acid, butoxypolyethoxypropyl ester; 2,4-dichlorophenoxyacetic acid, butyl ester; 2,4-DICHLOROPHENOXYACETIC ACID, CHOLINE SALT; 2,4-Dichlorophenoxyacetic acid, dodecylamine salt; 2,4-dichlorophenoxyacetic acid, isobutyl ester; 2,4-dichlorophenoxyacetic acid, N-oleyl-1,3-propylenediamine salt; 2,4-Dichlorophenoxyacetic acid, octylamine salt; 2,4-dichlorophenoxyacetic acid, propylene glycol butyl ether ester; 2,4-Dichlorophenyl benzenesulfonate; 2,4-Dichlorophenyl p-nitrophenyl ether; 2,4-Dinitrochlorobenzene; 2,4-Dinitrophenol; 2,4-Dodecadienoic acid, 3,7,11-trimethyl-, 2-propynyl ester, (S-(E,E))-; 2,4-Dodecadienoic acid, 3,7,11-trimethyl-, ethyl ester, (S-(E,E))-; 2,4-DP; 2,4-DP-p; 2,4-DP-p, 2-ethylhexyl ester; 2,4-DP-P, DIMWETHYLAMINE SALT; 2,4-DP-p, DMA salt; 2,4-DP-P, ISOOCTYL ESTER; 2,4-Imidazolidinedione, 1-(hydroxymethyl)-5,5-dimethyl-; 2,4-Imidazolidinedione, 1,3-bis(hydroxymethyl)-5,5-dimethyl-; 2,4-Imidazolidinedione, 1-bromo-3-chloro-5,5-dimethyl-; 2,4-Imidazolidinedione, 1-chloro-5-ethyl-5-methyl-; 2,4-Imidazolidinedione, 3-bromo-1-chloro-5,5-dimethyl-; 2,4-XYLENOL; 2,6-Bis((dimethylamino)methyl)cyclohexanone; 2,6-Diisopropyl-napthalene/2,6-DIPN; 2,6-Dimethyl-m-dioxan-4-ol acetate; 2,7:3,6-Dimethanonaphth(2,3-b)oxirene, 3,4,5,6,9,9-hexachloro-1a,2,2a,3,6,6a,7,7a-octahydro-, (1a.alpha.,2.beta.,2a.alpha.,3.beta.,6.beta.,6a.alpha.,7.beta.,7a.alpha.)-; 2,Mercaptobenzothiazole; 2-Alkyl* isoquinolinium bromide*(50% C12, 30% C14, 17% C16, 3% C18); 2-Alkyl*-1-(2-aminoethyl)-2-imidazoline acetate-nickel sulfate complex; 2-Alkyl*-1-(2-hydroxyethyl)-2-imidazoline acetate *(as in fatty acids of tall oil); 2-Alkyl*-1-(2-hydroxyethyl)-2-imidazoline phosphate *(100% C13); 2-Alkyl*-1(or 3)-benzyl-1-(2-hydroxethyl)-2-imidazolinium chloride *(as in fatty acids of tall oil); 2-Alkyl*-1-benzyl-1-(2-hydroxyethyl)-2-imidazolinium chloride *(as in fatty acids of coconut oil); 2-Aminobutane; 2-Benzyl-4-chlorophenol; 2-Butanone, 4-(4-(acetyloxy)phenyl)-, acetate; 2-Butenedioic acid (Z)-, monoester with 1(or 2)-((tributylstannyl)oxy)propanol; 2-Butenoic acid, 3-((dimethoxyphosphinyl)oxy)-, methyl ester, (E)-; 2-BUTOXYETHANOL; 2-Butyl-2-ethyl-1,3-propanediol; 2-Chloro-1-(2,4-dichlorophenyl)vinyl diethyl phosphate; 2-Chloro-4-phenylphenol; 2-Chloro-9-hydroxy-9H-fluorene-9-carboxylic acid; 2-Chloro-N-(hydroxymethyl)acetamide; 2-Chlorophenol; 2-Cyclohexe-1-one,2-[1-[[2-(4-chlorophenoxy)propoxy]imino]butyl]-3-hydroxy-5-(tetrahydro-2H-thiopyran-3-yl)-; 2-Cyclopenten-1-one, 2-hydroxy-3-methyl-; 2-CYCLOPENTEN-1-ONE, 3-METHYL-2-(2Z)-2-PENTENYL-; 2-Ethoxyethyl p-methoxycinnamate; 2-Ethyl-1,3-hexanediol; 2-ETHYL-1-HEXANOL; 2-Ethylhexanoate salt of magnesium 8-quinolinolate; 2-ETHYLHEXYL SULFATE, SODIUM SALT; 2-Fluoroacetamide; 2H-1,3-Thiazine, tetrahydro-2-(nitromethylene)-; 2H-1-Benzopyran-2-one, 3-(1-(2-furanyl)-3-oxobutyl)-4-hydroxy-; 2H-1-Benzopyran-2-one, 3-(1-(2-furanyl)-3-oxobutyl)-4-hydroxy-, sodium salt; 2H-Cyclopent(d)isothiazol-3(4H)-one, 5,6-dihydro-2-methyl-; 2-Heptadecyl-1-methyl-1-(2-(stearoylamido)ethyl)-2-imidazolinium methyl sulfate; 2H-Pyran-2,4(3H)-dione, 3-acetyl-6-methyl-, ion(1-), sodium; 2-Hydroxyethyl octyl sulfide; 2′-Hydroxyethyl-2,3-dibromopropionate; 2-HYDROXYPROPYL GUAR GUM; 2-Isovaleryl-1,3-indandione, calcium salt; 2-Lauryl isoquinolinium bromide; 2-Mercaptobenzothiazole; 2-Mercaptobenzothiazole, sodium salt; 2-Mercaptobenzothiazole, zinc salt; 2-Methoxyethanol; 2-METHYL-1-BUTANOL; 2-Methyl-1-naphthaleneacetamide; 2-Methyl-1-naphthaleneacetic acid; 2-Methyl-2,4-pentanediol; 2-Methyl-3(2H)-isothiazolone; 2-Methyl-3(2H)-isothiazolone 107104; 2-METHYL-4-ISOTHIAZOLIN-3-ONE; 2-Naphthacenecarboxamide, 4-(dimethylamino)-1,4,4a,5,5a,6,11,12a-octahydro-3,5,6,10,12,12a-hexahydroxy-6-methyl-1,11-dioxo-, (4S-(4.alpha.,4a.alpha.,5.alpha.,5a.alpha.,6.beta.,12a.alpha.))-; 2-Naphthacenecarboxamide, 7-chloro-4-(dimethylamino)-1,4,4a,5,5a,6,11,12a-octahydro-3,6,10,12,12a-pentahydroxy-6-methyl-1,11-dioxo-, (4S-(4.alpha.,4a.alpha.,5a.alpha.,6.beta.,12a.alpha.))-; 2-Naphthol; 2-Nitro-2-ethyl-1,3-propanediol; 2-phenethyl propionate (PeP); 2-Phenylethanol; 2-Propen-1-aminium, N,N-dimethyl-N-2-propenyl-, chloride, homopolymer; 2-PROPENOIC ACID, TELOMER WITH SODIUM HYDROGEN SULFITE; 2-Pyridinesulfonamide, N-[[(4,6-dimethoxy-2-pyrimidinyl)amino]carbonyl]-3-(2,2,2-trifluoroethoxy)-, monosodium salt, monohydrate; 2-Pyrrolidinone, 3-chloro-4-(chloromethyl)-1-(3-(trifluoromethyl)phenyl)-3-(1-Ethylpropyl)phenyl methylcarbamate; 3-(1-Methylbutyl)phenyl methylcarbamate; 3-(2-(3,5-Dimethyl-2-oxocyclohexyl)-2-hydroxyethyl<BR>)glutarimide; 3(2H)-Isothiazolone, 2-methyl-, calcium complex; 3(2H)-Isothiazolone, 4,5-dichloro-2-octyl; 3(2H)-Isothiazolone, 4,5-dichloro-2-octyl-; 3-(4-Chlorophenyl)-1,1-dimethylurea trichloroacetate; 3-(TRIHYDROXYSILYL) PROPYL DIMETHYL OCTADECYL AMMONIUM CHLORIDE; 3-(TRIMETHOXYSILYL) PROPYLDIMETHYLOCTADECYL AMMONIUM CHLORIDE; 3,4,4′-Trichlorocarbanilide; 3,4′,5-Tribromosalicylanilide; 3,4,5-Trimethylphenyl methylcarbamate; 3,4-Dichloro-5-isothiazolecarboxylic acid; 3,5,5-Trimethyl-2-cyclohexen-1-one; 3,5,7-Triaza-1-azoniatricyclo(3.3.1.1(superscript3,7))decane, 1-methyl-, chloride; 3,5,7-Triaza-1-azoniatricyclo(3.3.1.13,7)decane, 1,1′-(2-butene-1,4-diyl)bis-, dichloride; 3,5,7-Triazatricyclo(3.3.1.1(superscript 3,7))decane, 1-(3-chloro-2-propenyl)-, chloride, (Z)-; 3,5-Dibromo-3′-(trifluoromethyl)salicylanilide; 3,5-Dibromo-4-hydroxybenzonitrile butyrate; 3,5-Dibromosalicylanilide; 3′,6′-Dihydroxy-2′,4′,5′,7′-tetraiodospiro(isobenzofuran-1(3H),9′-(9H)xanthen)-3-one, disodium salt; 3,7-Benzofurandiol, 2,3-dihydro-2,2-dimethyl-, 7-(methylcarbamate); 3,7-DIMETHYL-6-OCTEN-1-OL; 3-Alkoxy*-2-hydroxypropyl trimethyl ammonium chloride *(100% C12-C15 as in linear, primary alcohol); 3-Buten-2-one, 4-(2,6,6-trimethyl-2-cyclohexen-1-yl)-, (E)-; 3-Butenoic acid, 2-amino-4-(2-aminoethoxy)-, monohydrochloride, (S-(E))-; 3-Butoxypropyl 2,4,5-trichlorophenoxyacetate; 3-Chloro-4-methylbenzenamine; 3-CHLORO-P-TOLUIDINE HYDROCHLORIDE; 3-DECEN-2-ONE; 3H-1,2-Dithiol-3-one, 4,5-dichloro-; 3H-2-Benzopyran-3-one, octahydro-; 3-Heptanol, 4-methyl-; 3-IODO-2-PROPYNYL BUTYLCARBAMATE; 3-Isoxazolecarboxylic acid, 4,5-dihydro-5,5-diphenyl-, ethyl ester; 3-Ketopetromyzonol sulfate; 3-Methyl-2-cyclohexen-1-one; 3-Phenyl-1,1-dimethylurea trichloroacetate; 3-Phenyl-2-propenol; 3-Pyridinecarboxylic acid, 2-(4-chlorophenyl)-1-ethyl-1,4-dihydro-6-methyl-4-oxo-, potassium salt; 3-Quinolinecarboxylic acid, 2-(4,5-dihydro-4-methyl-4-(1-methylethyl)-5-oxo-1H-imidazol-2-yl)-, monoammonium salt; 3-Quinolinecarboxylic acid, 2-(4,5-dihydro-4-methyl-4-(1-methylethyl)-5-oxo-1H-imidazol-2-yl)-, monosodium salt; 4-(2,4-DB), DIMETHYLAMINE SALT; 4-(2-NITROBUTYL)MORPHOLINE; 4-(Dimethylamino)-3-methylphenyl methylcarbamate; 4(or 5)-Chloro-2-methylcyclohexanecarboxylic acid, 1,1-dimethylethyl ester; 4,4′-(2-ETHYL-2-NITROTRIMETHYLENE)DIMORPHOLINE; 4,4′-Dichloro-a-methylbenzhydrol; 4,4-DIMETHYL OXAZOLIDINE; 4,4-Dimethyloxazolidine; 4′,5-Dibromosalicylanilide; 4,5-DICHLORO-2-N-OCTYL-3(2H)-ISOTHIAZOLONE; 4-Amino-3,5,6-trichloropicolinic acid, isooctyl ester; 4-Amino-3,5,6-trichloropicolinic acid, triethylamine salt; 4-Aminobenzenesulfonamide; 4-Aminopyridine; 4-Bromoacetoxymethyl-m-dioxolane; 4-Chloro-2-cyclopentylphenol; 4-Chloro-2-cyclopentylphenol, potassium salt; 4-Chloro-3-cresol; 4-Chlorophenyl 2,4,5-trichlorophenyl sulfide; 4-CPA; 4-Cyclododecyl-2,6-dimethylmorpholine acetate; 4-Methyl-2-pentanone; 4-Nitrophenol; 4-NONYLPHENOL, FORMALDEHYDE RESIN, PROPOXYLATED; 4-tert-Amylphenol; 4-tert-Butylphenol; 4-VINYLCYCLOHEXENEDIEPOXIDE; 5,5-DIMETHYLHYDANTOIN; 5-Bromo-3-sec-butyl-6-methyluracil, sodium salt; 5-CHLORO-2-(2,4-DICHLOROPHENOXY) PHENOL; 5-Chloro-2-methyl-3(2H)-isothiazolone; 5-Chloro-2-methyl-3(2H)-isothiazolone, calcium chloride complex; 5-CHLORO-2-METHYL-4-ISOTHIAZOLIN-3-ONE; 5-Chloro-2-methyl-4-isothiazolin-3-one calcium chloride; 5-Chloro-2-methyl-4-isothiazolin-3-one calcium chloride with 2-methyl-4-isothazolin-3-one calcium chloride; 5-Decen-1-ol, (E)-; 5-Decen-1-ol, acetate, (E)-; 5-HYDROXY METHOXY METHYL-1-AZA-3,7-DIOXABICYCLO (3.3.0) OCTANE; 5-Hydroxymethoxymethyl-1-aza-3,7-dioxabicyclo(3.3.<BR>0)octane; 5-HYDROXYMETHYL-1-AZA-3,7-DIOXABICYCLO (3.3.0) OCTANE; 5-Hydroxymethyl-1-aza-3,7-dioxabicyclo(3.3.0)octan<BR>e; 5-HYDROXYPOLY (METHYLENEOXY) (74% C2, 21% C3, 4% C4, 1% C5) METHYL-1-AZA-3,7-DIOXABICYCLO (3.3.0) OCTANE; 5-Isothiazolecarboxylic acid, 3,4-dichloro-, potassium salt; 6-(and 2)-Chloro-3,4-xylyl methylcarbamate; 6,8-Dioxabicyclo(3.2.1)octane, 1,5-dimethyl-, (1S)-; 6,8-Dioxabicyclo(3.2.1)octane, 5-ethyl-2,4-dimethyl-, (1S-(endo,endo))-; 6-Chloro-2-phenylphenol, potassium salt; 6-Dodecen-1-ol, acetate, (E)-; 6-Dodecen-1-ol, acetate, (Z)-; 7,11-Hexadecadien-1-ol, acetate; 7,11-Hexadecadien-1-ol, acetate, (E,Z)-; 7,11-Hexadecadien-1-ol, acetate, (Z,Z)-; 7-Oxabicyclo(2.2.1)heptane-2,3-dicarboxylic acid, compd with N,N-dimethylcocamine (1:2); 7-Oxabicyclo(2.2.1)heptane-2,3-dicarboxylic acid, compd. with N,N-dimethyl-1-tridecaneamine (1:1); 7-Oxabicyclo(2.2.1)heptane-2,3-dicarboxylic acid, disodium salt; 7-Oxabicyclo(2.2.1)heptane-2,3-dicarboxylic acif, dihydroxyaluminum salt; 8-Quinolinol; 8-Quinolinol benzoate; 8-Quinolinol citrate; 8-Quinolinol sulfate; 9,10-Secocholesta-5,7,10(19)-triene-1,3-diol, (1.alpha.,3.beta.,5Z,7E)-; 9-Decen-1-ol, 3-methyl-6-(1-methylethenyl)-acetate, (3S,6S)-; 9-Decen-1-ol, 3-methyl-6-(1-methylethenyl)-, acetate. (3S,6R)-; 9-Dodecenyl acetate, (Z)-; 9-Octadecen-1-amine, N,N-dimethyl-, (Z)-, acetate; and 9-Octadecen-1-aminium, N-ethyl-N,N-dimethyl-, bromide.

In some embodiments, the pesticide may be a microorganism, virus, or other substance including Agrobacterium radiobacter, Agrobacterium radiobacter (strain K84), Agrobacterium radiobacter strain K1026, Agrobacterium radiobacter STRAIN K1026, Agrobacterium spp., Agrobacterium vitis strain F2/5, Alternaria cassiae, Alternaria destruens, Alternaria destruens strain 059, Alternaria spp., Ampelomyces quisqualis, Ampelomyces quisqualis isolate M-10, Ampelomyces spp., Anagrapha falcifera multi-nuclear polyhedrosis virus, Anagrapha falcifera multi-nuclear polyhedrosis virus polyhedral inclusion bodies in aqueous suspension, Arthrobotrys amerospora, Arthrobotrys spp., Aspergillus flavus, Aspergillus flavus 36 colonized wheat, Aspergillus flavus NRRL 21882, Aspergillus flavus STRAIN AF36, Aspergillus flavus STRAIN NRRL 21882, Aspergillus spp., Aureobasidium pullulans, Aureobasidium pullulans STRAIN DSM 14940, Aureobasidium pullulans STRAIN DSM 14941, Aureobasidium spp., Bacillus amyloliquefaciens, Bacillus amyloliquefaciens FZB42, Bacillus amyloliquefaciens MBI600, Bacillus amyloliquefaciens STRAIN D747, Bacillus amyloliquefaciens STRAIN F727, Bacillus amyloliquefaciens STRAIN MBI 600, Bacillus cereus, Bacillus cereus strain BPO1, Bacillus firmus, Bacillus firmus (STRAIN I-1582), Bacillus firmus strain-1582 Spores, Bacillus lentimorbus, Bacillus licheniformis, Bacillus licheniformis SB 3086, Bacillus licheniformis strain SB3086, Bacillus megaterium, Bacillus mycoides, Bacillus mycoides ISOLATE J, Bacillus popilliae, Bacillus pumilus, Bacillus pumilus GB34, Bacillus pumilus GHA 180, Bacillus pumilus strain GB34, Bacillus pumilus strain QST 2808, Bacillus pumilus STRAIN QST 2808, Bacillus sphaericus, Bacillus sphaericus 2362 SEROTYPE H5A5B STRAIN ABTS 1743 (FERMENTATION SOLIDS, SPORES AND INSECTICIDAL TOXINS), Bacillus spp., Bacillus subtilis, Bacillus subtilis DRIED QST 713 STRAIN, Bacillus subtilis GB03, Bacillus subtilis MBI 600, Bacillus subtilis STRAIN IAB/BS03, Bacillus subtilis strain QST 713, Bacillus subtilis VAR. Amyloliquefaciens STRAIN FZB24, Bacillus thuringiensis, Bacillus thuringiensis aizawai strain NB200, Bacillus thuringiensis Cry 1F protein and the genetic material necessary for its production (plasmid insert PHI 8999) in corn, Bacillus thuringiensis Cry1A.105 protein and genetic material necessary (vector PV-ZMIR245) for its production in corn, Bacillus thuringiensis Cry1A.105/Cry2Ab2/Cry1F/Cry3Bb1/Cry34Ab1/and Cry35Ab1 proteins produced in the combined trait corn product MON 89034×TC1507×MON 88017×DAS-59122-7, Bacillus thuringiensis Cry1Ab protein and the genetic material necessary for its production (via elements of p2062) in Event 3243M corn, Bacillus thuringiensis Cry1F protein and the genetic material necessary for its production (plasmid insert PH18999) in corn, Bacillus thuringiensis Cry2Ab protein and the genetic material necessary for its production (vector GHBK11) in cotton, Bacillus thuringiensis Cry2Ab protein and the genetic material necessary for its production (Vector ZMBK28) in corn, Bacillus thuringiensis Cry2Ab2 protein and the genetic material necessary (vector PV-ZMIR245) for its production in corn, Bacillus thuringiensis Cry34Ab1 and Cry35Ab1 proteins and the genetic material necessary for their production in corn, Bacillus thuringiensis Cry3B1 protein and the genetic material necessary for its production (Vector ZMIR 13L) in corn, Bacillus thuringiensis Cry3Bb protein and the genetic material necessary for its production (Vector ZMIR 12L) in corn, Bacillus thuringiensis Cry3Bb protein and the genetic material necessary for its production (Vector ZMIR 14L) in corn, Bacillus thuringiensis Cry3Bb1 protein and the genetic material necessary (vector ZMIR39) for its production in corn, Bacillus thuringiensis CryIA(b) delta-endotoxin and the genetic material necessary for its production (plasmid vector pZ01502) in corn, when used as a plant pesticide in all raw agricultural commodities of field corn, sweet corn and popcorn, Bacillus thuringiensis CryIA(b) delta-endotoxin and the genetic material necessary for its production (plasmid vector pZ01502) in corn, when used as a plant pesticide in all raw agricultural commodities of field corn, sweet corn and popcorn., Bacillus thuringiensis serovar japonensis strain buibui, Bacillus thuringiensis SSP kurstaki STRAIN EVB 113 19, Bacillus thuringiensis sub. kurstaki strain EG7673 Coleopteran active toxin, Bacillus thuringiensis sub. kurstaki strain EG7673 Lepidopteran active toxin, Bacillus thuringiensis subsp. Aizawai, Bacillus thuringiensis subsp. aizawai strain GC-91, Bacillus thuringiensis subsp. Aizawai, Strain ABTS-1857, Bacillus thuringiensis SUBSP. GALLERIAE STRAIN SDS-502 (FERMENTATION SOLIDS, SPORES AND INSECTICIDAL TOXINS), Bacillus thuringiensis subsp. Israelensis, Bacillus thuringiensis subsp. israelensis strain EG2215, Bacillus thuringiensis SUBSP. Israelensis STRAIN SUM-6218, Bacillus thuringiensis subsp. kurstaki, Bacillus thuringiensis subsp. kurstaki CryIA (c) delta-endotoxin and the genetic material necessary for its production in corn, Bacillus thuringiensis subsp. kurstaki delta endotoxin protein as produced by the CryIIA gene and its controlling sequences in cotton, Bacillus thuringiensis subsp. kurstaki strain BMP123, Bacillus thuringiensis subsp. kurstaki strain EG2348, Bacillus thuringiensis subsp. kurstaki strain EG2371, Bacillus thuringiensis subsp. kurstaki strain EG2424, Bacillus thuringiensis subsp. kurstaki strain EG7826, Bacillus thuringiensis subsp. kurstaki strain HD1 delta-endotoxin as produced in corn by a cry1A(b) gene and its controlling sequences, Bacillus thuringiensis subsp. kurstaki, delta-endotoxin as produced in corn by an HD-1 gene and its controlling sequences and found on plasmid vector pZO1502, Bacillus thuringiensis subsp. morrisoni lepidopteran active, Bacillus thuringiensis subsp. san diego, Bacillus thuringiensis subsp. Tenebrionis, Bacillus thuringiensis subsp. tolworthi Cry9C protein and the genetic material necessary for its production (pRVA9909) in corn plants, Bacillus thuringiensis subspecies israelensis Strain BMP 144 solids, spores and insecticidal toxins, Bacillus thuringiensis subspecies kurstaki strain EG7841 Lepidopteran active toxin, Bacillus thuringiensis SUBSPECIES kurstaki GENETICALLY ENGINEERED STRAIN EG7841 LEPIDOPTERAN ACTIVE TOXIN, Bacillus thuringiensis subspecies tenebrionis delta endotoxin as produced in potato by Cry IIIA gene and its controlling sequences and found in the following constructs (PV-STBT02, PV-STBT04, and PV-STMT01, IR-22), Bacillus thuringiensis subspecies tenebrionis delta endotoxin as produced in potato by Cry IIIA gene and its controlling sequences and found in the following constructs (PV-STMT02, PV-STMT04, PV-STMT10, PV-STMT11), Bacillus thuringiensis subspecies tenebrionis delta endotoxin as produced in potato by Cry IIIA gene and its controlling sequences and found in the following constructs (PV-STBT02, PV-STBT04, and PV-STMT01, IR-22), Bacillus thuringiensis subspecies tenebrionis delta endotoxin as produced in potato by Cry IIIA gene and its controlling sequences and found in the following contructs (PVSTMT15, PVSTBT02 in combination with PV-STPY01, IR-22), Bacillus thuringiensis v kurstaki (Btk)—DiPel DF, Bacillus thuringiensis var. aizawai Cry1F (synpro) and the genetic material (from the insert of plasmid pGMA281) necessary for its production in cotton, Bacillus thuringiensis var. kurstaki Cry1Ac (synpro) and the genetic material (from the insert of plasmid pMYC3006) necessary for its production in cotton, Bacillus thuringiensis var. kurstaki delta endotoxin protein as produced by the Cry1A(c) gene and its controlling sequences, Bacillus thuringiensis var. kurstaki strain M-200 protein toxin, Bacillus thuringiensis variety kurstaki (Delta endotoxin) encapsulated in killed Pseudomonas fluorescens, Bacillus thuringiensis VIP3A protein and the genetic material necessary for its production (pCOT1 in cotton), Bacillus thuringiensis, SUBSP. aizawai, GC-91 PROTEIN, Bacillus thuringiensis, SUBSP. aizawai STRAIN ABTS-1857, Bacillus thuringiensis SUBSP. israelensis SEROTYPE H-14, Bacillus thuringiensis SUBSP. israelensis STRAIN AM 65-52, Bacillus thuringiensis SUBSP. kurstaki STRAIN SA-12, Bacillus thuringiensis SUBSP. kurstaki SEROTYPE (3A,3B), Bacillus thuringiensis SUBSP. kurstaki STRAIN ABTS-351 (FERMENTATION SOLIDS AND SOLUBLES), Bacillus thuringiensis SUBSP. kurstaki STRAIN EG 2348, Bacillus thuringiensis SUBSP. kurstaki STRAIN SA-11, Bacteriophage, Bacteriophage (from selected Pseudomonas species), BACTERIOPHAGE ACTIVE AGAINST CLAVIBACTER MICHIGANENSIS SUBSP. MICHIGANENSIS, Bacteriophage active against Xanthomonas campestris pv. vesicatoria, BACTERIOPHAGE ACTIVE AGAINST Xanthomonas campestris PV. vesicatoria AND Pseudomonas syringae PV. TOMATO, BACTERIOPHAGES ACTIVE AGAINST XYLELLA FASTIDIOSA, Beauvaria bassiana, Beauvaria spp., Beauveria bassiana ATCC 74040, Beauveria bassiana HF 23, Beauveria bassiana strain 447, Beauveria bassiana STRAIN ANT-03, Beauveria bassiana STRAIN GHA, Beauveria bassiana STRAIN PPRI 5339, Burkholderia Cepacia, Burkholderia Cepacia AMMD, Burkholderia cepacia strain AMMD, Burkholderia cepacia strain Ral-3, Burkholderia cepacia type Wisconsin isolate/strain J82, Burkholderia cepacia type Wisconsin isolate/strain M54, BURKHOLDERIA SP STRAIN A396 CELLS AND FERMENTATION MEDIA, Burkholderia spp., Burkholderia strain A396 cells and spent fermentation media, Candida oleophila, Candida oleophila isolate I-182, Candida spp., Chondrostereum purpureum, Chondrostereum purpureum isolate PFC 2139, Chondrostereum purpureum strain HQ1, Chondrostereum purpureum strain PFC 2139, Chondrostereum spp., Chromobacterium spp., Chromobacterium subtsugae, Chromobacterium subtsugae STRAIN PRAA4-1, Clavibacter spp., Clavibacter xyli, Clavibacter xyli subsp. cynodontis isolate producing Bacillus thuringiensis subsp. kurstaki delta-endotoxin protein, Clavibacter xyli subspecies cyondontis isolate MD69a producing Bacillus thuringiensis subspecies kurstaki delta-endotoxin protein, Clonostachys rosea, Clonostachys rosea STRAIN CR-7, Clonostachys rosea STRAIN J1446, Clonostachys spp., CODLING MOTH GRANULOSIS VIRUS, Colletotrichum gloeosporioides, Colletotrichum gloeosporioides f. sp. aeschynomene, Colletotrichum gloeosporioides f. sp. malvae, Colletotrichum spp., Coniothyrium minitans, Coniothyrium minitans STRAIN CON/M/91-08, Coniothyrium spp., Cryptococcus infirmo-miniatus, Cryptococcus infirmo-miniatus strain YY6, Cryptococcus spp., Cyanobacteria, Cydia pomonella granulosis virus, Cydia pomonella granulosis virus Cyd-X, Duddingtonia flagrans, Duddingtonia flagrans STRAIN IAH 1297, Duddingtonia spp., Flavobacterium balustinum, Flavobacterium balustinum strain 299, Flavobacterium spp., Gliocladium spp., Gliocladium virens, Gliocladium virens GL-21, Gliocladium virens GL-21 (SPORES), GRANULOSIS VIRUS, Harrisina brillians granulosis virus, Helicoverpa armigera NUCLEOPOLYHEDROVIRUS STRAIN BV-0003, Heterorhabditis spp., Hirsutella spp., Hirsutella tompsonii, Isaria fumosorosea, Isaria fumosorosea Apopka Strain 97, Isaria fumosorosea STRAIN FE 990, Isaria fumosorosea STRAIN FE 9901, Isaria spp., Lagenidium giganteum, Lagenidium giganteum, mycelium or oospores, Lagenidium spp., Mamestra configurata nucleopolyhedrovirus (McNPV), Melanoplus sanguinipes virus, Metarhizium anisopliae, Metarhizium anisopliae Strain ESF1, Metarhizium anisopliae STRAIN F52, Metarhizium anisopliae strain F52 spores, Metarhizium spp., Metarrhizium anisopliae ESF1, Muscodor albus, Muscodor albus strain QST 20799, Muscodor albus STRAIN SA13, Muscodor spp., Mycoleptodiscus spp., Mycoleptodiscus terrestris, Mycoleptodiscus terrestris mycelia, Myrothecium spp., myrothecium verrucaria, Myrothecium verrucaria DRIED FERMENTATION SOLIDS & SOLUBLES STRAIN AARC-0255, Nosema locustae, Nosema locustae SPORES, Nosema spp., nuclear polyhedrosis virus, nucleopolyhedrosis virus, NUCLEOPOLYHEDROVIRUS, Oedaleus senegalensis virus, Paecilomyces fumosoroseus, Paecilomyces fumosoroseus APOPKA STRAIN 97, Paecilomyces spp., Pantoea agglomerans, Pantoea agglomerans strain C9-1, Pantoea spp., Penicillium oxalicum, Penicillium spp., pepino MOSAIC VIRUS, pepino MOSAIC VIRUS STRAIN CH2 ISOLATE 1906, Phytophthora palmivora, Phytophthora spp., Potato leaf roll virus, Potato leaf roll virus (PLRV) coat protein as produced in potato by PLRV modCP gene and its controlling sequences and found in the following constructs (PV-STMT02, PV-STMT04, PV-STMT10, PV-STMT11, PV-STMT12, PV-STMT13 and PV-STMT14), Potato leafroll virus (PLRV) replicase protein as produced in potato plants, Pseudomonas spp., Pseudomonas aureofaciens, Pseudomonas aureofaciens strain Tx-1, Pseudomonas cepacia, Pseudomonas cepacia type Wisconsin, Pseudomonas chlororaphis, Pseudomonas chlororaphis strain 63-28, Pseudomonas chlororaphis SUBSP. aurantiaca STRAIN AFS009, Pseudomonas fluorescens, Pseudomonas fluorescens (natural occurring strain), Pseudomonas fluorescens 1629RS, Pseudomonas fluorescens A506 (previously coded 006418), Pseudomonas fluorescens CL 145A STRAIN TOXINS, Pseudomonas fluorescens EG-1053 (previously coded 006418), Pseudomonas fluorescens isolate Ps 3732-3-7. Contains delta endotoxin gene from BTK(Bacillus thuringiensis, subsp. kurstaki). Resistant to kanamycin. HOMOLOGOUS RECOMBINATION TECHNOLOGY., Pseudomonas fluorescens Strain NCIB 12089, Pseudomonas fluorescens strain PRA-25, PSEUDOMONAS FLUORESCENS STRAIN A506, Pseudomonas putida, Pseudomonas spp., Pseudomonas syringae, Pseudomonas Syringae 742RS, Pseudomonas syringae strain ESC 10, Pseudomonas syringae STRAIN ESC-10, Pseudomonas syringae strain ESC-11, Pseudozyma flocculosa, Puccinia canaliculate, Puccinia spp., Puccinia thlaspeos, Puccinia thlaspeos ‘woad strain’, Puccinia thlaspeos ‘woad strain’ on rust-infected pieces of dyer's woad, Purpureocillium lilaciunum, Purpureocillium lilaciunum STRAIN 251, Purpureocillium spp., Rhizobia leguminosarum, Rhizobia leguminosarum biovar viceae containing the cryIII gene from Bacillus thuringiengis subsp. tenebrionis, Rhizobia spp., Rhodotorula glutinis, Rhodotorula spp., Saccharomyces cerevisiae, Sclerotinia sclerotiorum, Sclerotinia spp., Scytalidium FY, Scytalidium spp., Spodoptera exigua MULTINUCLEOPOLYHEDROVIRUS, Spodoptera exigua MULTINUCLEOPOLYHEDROVIRUS STRAIN BV-004, Steinernema carpocapsae, Steinernema feltiae, Steinernematid spp., Streptomyces spp., Streptomyces galbus, Streptomyces galbus strain QST 6047, Streptomyces griseoviridis, Streptomyces griseoviridis STRAIN K61, Streptomyces lydicus, Streptomyces lydicus WYEC 108, Streptomyces spp., Streptomyces strain K61, Trichoderma asperellum, Trichoderma asperellum ICC 012, Trichoderma asperellum STRAIN T-34, Trichoderma atroviride, Trichoderma atroviride SC1, Trichoderma gamsii, Trichoderma gamsii ICC 080, Trichoderma hamatum, Trichoderma hamatum TH382, Trichoderma harzianum, Trichoderma harzianum RIFAI STRAIN KRL-AG2, Trichoderma harzianum Rifai strain T-22, Trichoderma polysporum, Trichoderma polysporum (ATCC 20475), Trichoderma spp., Trichoderma virens, Trichoderma virens STRAIN G-41, Trichoderma viride, Trichoderma viride (ATCC 20476), Trichoderma viride sensu Bisby, Ulocladium oudemansii, Ulocladium oudemansii (U3 STRAIN), Ulocladium spp., Unocladium oudemansii, Unocladium oudemansii (U3 strain), Unocladium spp., Verticillium dahliae, Verticillium dahliae isolate WCS 850, Verticillium lecanii, Verticillium spp., Xanthomonas campestris, and Xanthomonas spp.

In some embodiments, the pesticide may be Cry1A(c) and CryiC derived*delta endotoxins of Bacillus thuringiensis encapsulated in killed Pseudomonas fluorescens; Abamectin; Abate, Temephos; Accent; Acephate; ACEQUINOCYL; Acetalized polyvinyl alcohol complexed with iodine; Acetamide, 2-chloro-N-(2,3-dimethylphenyl)-N-(1-methylethyl)-; Acetamide, N-(4-methyl-3-(((trifluoromethyl)sulfonyl)amino)phenyl)-, compd. with 2,2′-iminobis(ethanol) (1:1); Acetaminophen; Acetamiprid; ACETIC ACID; Acetic acid, ((3,5,6-trichloro-2-pyridinyl)oxy)-, ethyl ester; Acetic acid, (2,4,5-trichlorophenoxy)-, 2-ethylhexyl ester; Acetic acid, (2,4,5-trichlorophenoxy)-, compd. with (Z)-N-9-octadecenyl-1,3-propanediamine (1:1); Acetic acid, (2,4,5-trichlorophenoxy)-, compd. with 1-dodecanamine (1:1); Acetic acid, (2,4,5-trichlorophenoxy)-, compd. with 1-tetradecanamine; Acetic acid, (2,4-dichlorophenoxy)-, compd. with (Z)-N,N-dimethyl-9-octadecen-1-amine (1:1); Acetic acid, (2,4-dichlorophenoxy)-, compd. with (Z,Z)-N,N-dimethyl-9,12-octadecadien-1-amine (1:1), mixt. with (Z)-N,N-dimethyl-9-octadecen-1-amine (2,4-dichlorophenoxy)acetate; Acetic acid, (2,4-dichlorophenoxy)-, compd. with 1-amino-2-propanol (1:1); Acetic acid, (2,4-dichlorophenoxy)-, compd. with 1-heptanamine (1:1); Acetic acid, (2,4-dichlorophenoxy)-, compd. with 2,2′,2″-nitrilotris(ethanol) (1:1); Acetic acid, (2,4-dichlorophenoxy)-, compd. with 2-aminoethanol (1:1); Acetic acid, (2,4-dichlorophenoxy)-, compd. with morpholine (1:1); Acetic acid, (2,4-dichlorophenoxy)-, compd. with N,N-diethylethanamine (1:1); Acetic acid, (2,4-dichlorophenoxy)-, compd. with N-ethylethanamine (1:1); Acetic acid, {{1-{(dimethylamino)carbonyl}-3-(1,1-dimethylethyl)-1H-1,2,4-triazol-5-yl}thio}-, ethyl ester; Acetic acid, bromo-, 2-butene-1,4-diyl ester; Acetic acid, trichloro-, 1,2-ethanediyl ester; Acetic acid, trichloro-, magnesium salt; Acetochlor; Acetone; Acetylsalicylic acid; Acibenzolar-S-methyl; Acid Blue 9; ACID BLUE 9, DIAMMONIUM SALT; Acid Yellow 23; Acifluorfen; Acrolein; ACRYLAMIDE/SODIUM ACRYLATE COPOLYMER; ACRYLIC ACID; Acrylonitrile; ADBAC (60% C14, 30% C16, 5% C18, 5% C12); ADBAC (Alkyl* dimethyl ethylbenzyl ammonium chloride *(50% C12, 30% C14, 17% C16, 3% C18); ADBAC 60% C14, 30% C16, 10% C12; ADBAC 67% C12, 25% C14, 7% C16, 1% C8, C10, C18; AFIDOPYROPEN; Alachlor; ALCOHOL ALKOXYLATE; ALCOHOL ETHOXYLATE PHOSPHATE ESTER; ALCOHOL SULFATES; ALCOHOLS, C12-C14, ALIPHATIC; Alcohols, C6, C8 & C10, ethoxylated, propoxylated mix with alcohols, C12-15, ethoxylated; Alcohols, C6-12; Aldicarb; Aldoxycarb; Aldrin, Dieldrin; Aliette (Fosetyl-Al); Aliphatic petroleum hydrocarbons, Petroleum oil; Aliphatic petroleum solvent; Alkanol* amine dinoseb (2-sec-butyl-4,6-dinitrophenol) *(salts of the ethanol and isoprapanol series); ALKYL (50% C12, 30% C14, 17% C16, 3% C18) DIMETHYLBENZYL AMMONIUM CHLORIDE; ALKYL (50% C12, 30% C14, 17% C16, 3% C18) DIMETHYLETHYLBENZYL AMMONIUM CHLORIDE; ALKYL (50% C14, 40% C12, 10% C16) DIMETHYLBENZYL AMMONIUM CHLORIDE; ALKYL (50% C14, 40% C12, 10% C16) DIMETHYLBENZYL AMMONIUM SACCHARINATE; ALKYL (58% C14, 28% C16, 14% C12) DIMETHYLBENZYL AMMONIUM CHLORIDE; ALKYL (60% C14, 25% C12, 15% C16) DIMETHYLBENZYL AMMONIUM CHLORIDE; ALKYL (60% C14, 30% C16, 5% C12, 5% C18) DIMETHYLBENZYL AMMONIUM CHLORIDE; ALKYL (67% C12, 25% C14, 7% C16, 1% C18) DIMETHYLBENZYL AMMONIUM CHLORIDE; ALKYL (67% C12, 25% C14, 7% C16, 1% C8,C10,C18) DIMETHYLBENZYL AMMONIUM CHLORIDE; ALKYL (68% C12, 32% C14) DIMETHYLETHYLBENZYL AMMONIUM CHLORIDE; ALKYL (95% C14, 3% C12, 2% C16) DIMETHYL BENZYL AMMONIUM CHLORIDE; ALKYL (95% C14, 3% C12, 2% C16) DIMETHYL BENZYL AMMONIUM CHLORIDE DIHYDRATE; ALKYL (C1O-16) DIMETHYL AMINE OXIDE; ALKYL (C8,C10) POLYGLUCOSIDE; ALKYL (C8-C18) BIS (2-HYDROXYETHYL) BENZYL AMMONIUM CHLORIDE; ALKYL (C9-C11) OLIGOMERIC D-GLUCOPYRANOSIDE; ALKYL AND ALKYLARYL POLY (OXYETHYLENE) GLYCOLS, MIXED; ALKYL BENZENE SULFONIC ACID; Alkyl pyridines; ALKYL(42% C12, 26% C18, 15% C14, 8% C16, 5% C10, 4% C8)1,3-PROPYLENEDIAMINE; Alkyl(C12-C15) poly(oxypropylene)poly(oxyethylene)-iodine complex; Alkyl* (ethyl cycloimidinium) 3-hydroxy-3-ethyl sodium alcoholate, 2-methyl sodium carboxylate-tridecyl polyoxyethylene ethanol-iodine complex *(100% C12); Alkyl* amine hydrochloride *(as in fatty acids of coconut oil); Alkyl* bis(2-hydroxyethyl) amine acetate *(65% C18, 30% C16, 5% C14); Alkyl* bis(2-hydroxyethyl) ammonium acetate *(as in fatty acids of coconut oil); Alkyl* bis(2-hydroxyethyl)benzyl ammonium chloride *(57% C10, 20% C12, 11% C14, 9% C18, 2% C16, 1% C8); Alkyl* diethanolamide *(70% C12, 30% C14); Alkyl* dimethyl 3,4-dichlorobenzyl ammonium chloride *(100% C12); Alkyl* dimethyl 3,4-dichlorobenzyl ammonium chloride *(42% C12, 27% C14, 13% C16, 18% C8-C18); Alkyl* dimethyl 3,4-dichlorobenzyl ammonium chloride *(50% C12, 30% C14, 17% C16, 3% C18); Alkyl* dimethyl 3,4-dichlorobenzyl ammonium chloride *(50% C14, 40% C12, 10% C16); Alkyl* dimethyl 3,4-dichlorobenzyl ammonium chloride *(55% C14, 23% C12, 20% C16, 2% C18); Alkyl* dimethyl 3,4-dichlorobenzyl ammonium chloride *(60% C, 12, 25% C14, 15% C16); Alkyl* dimethyl 3,4-dichlorobenzyl ammonium chloride *(63% C12, 23% C14, 14% C16); Alkyl* dimethyl 3,4-dichlorobenzyl ammonium chloride *(65% C12, 22% C14, 10% C16, 3% C18); Alkyl* dimethyl 3,4-dichlorobenzyl ammonium chloride *(90% C14, 5% C16, 5% C12); Alkyl* dimethyl 3,4-dichlorobenzyl ammonium chloride polyethoxypolypropoxypolyethoxyethanol-iodine complex *(50% C12, 30% C14, 17% C16, 3% C18); Alkyl* dimethyl benzyl ammonium chloride *(100% C14); Alkyl* dimethyl benzyl ammonium chloride *(100% C16); Alkyl* dimethyl benzyl ammonium chloride *(40% C12, 40% C14, 20% C16); Alkyl* dimethyl benzyl ammonium chloride *(41% C14, 28% C12, 19% C18, 12% C16); Alkyl* dimethyl benzyl ammonium chloride *(47% C12, 18% C14, 15% (C5-C15), 10% C18, 10% C16); Alkyl* dimethyl benzyl ammonium chloride *(50% C12, 30% C14, 17% C16, 3% C18); Alkyl* dimethyl benzyl ammonium chloride *(50% C14, 40% C12, 10% C16); Alkyl* dimethyl benzyl ammonium chloride *(58% C14, 28% C16, 14% C12); Alkyl* dimethyl benzyl ammonium chloride *(60% C14, 30% C16, 10% C12); Alkyl* dimethyl benzyl ammonium chloride *(60/C, 14, 25% C12, 15% C16); Alkyl* dimethyl benzyl ammonium chloride *(60% C14, 30% C16, 5% C18, 5% C12); Alkyl* dimethyl benzyl ammonium chloride *(61% C12, 23% C14, 11% C16, 2.5% C18 2.5% C10 and trace of C8); Alkyl* dimethyl benzyl ammonium chloride *(61% C12, 23% C14, 11% C16, 5% C18); Alkyl* dimethyl benzyl ammonium chloride *(65% C12, 23% C14, 12% C16); Alkyl* dimethyl benzyl ammonium chloride *(65% C12, 25% C14, 10% C16); Alkyl* dimethyl benzyl ammonium chloride *(67% C12, 24% C14, 9% C10-C18); Alkyl* dimethyl benzyl ammonium chloride *(67% C12, 25% C14, 7% C16, 1% C18); Alkyl* dimethyl benzyl ammonium chloride *(67% C12, 25% C14, 7% C16, 1% C8, C1O, and C18); Alkyl* dimethyl benzyl ammonium chloride *(67% C12, 27% C14, 6% C16); Alkyl* dimethyl benzyl ammonium chloride *(68% C12, 25% C14, 7% C16); Alkyl* dimethyl benzyl ammonium chloride *(70% C12, 30% C14); Alkyl* dimethyl benzyl ammonium chloride *(70% C12, 24% C14, 5% C16, 1% C10); Alkyl* dimethyl benzyl ammonium chloride *(90% C14, 5% C12, 5% C16); Alkyl* dimethyl benzyl ammonium chloride *(93% C14, 4% C12, 3% C16); Alkyl* dimethyl benzyl ammonium chloride *(95% C16, 5% C18); Alkyl* dimethyl benzyl ammonium chloride *(95% C14, 3% C12, 2% C16); Alkyl* dimethyl benzyl ammonium chloride *(as in fatty acids of coconut oil); Alkyl* dimethyl benzyl ammonium chloride *(C8-18); Alkyl* dimethyl benzyl ammonium saccharinate *(50% C14, 40% C12, 10% C16); Alkyl* dimethyl betaines *(46% C12, 24% C14, 10% C16, 8% C10, 7% C8, 5% C18); Alkyl* dimethyl dimethylbenzyl ammonium chloride *(50% C12, 30% C14, 17% C16, 3% C18); Alkyl* dimethyl ethyl ammonium bromide *(85% C16, 15% C18); Alkyl* dimethyl ethyl ammonium bromide *(90% C14, 5% C16, 5% C12); Alkyl* dimethyl ethyl ammonium bromide *(mixed alkyl and alkenyl groups as in fatty acids of soybean oil); Alkyl* dimethyl ethylbenzyl ammonium chloride *(50% C12, 30% C14, 17% C16, 3% C18); Alkyl* dimethyl ethylbenzyl ammonium chloride *(60% C14, 30% C16, 5% C12, 5% C18); Alkyl* dimethyl ethylbenzyl ammonium chloride *(68% C12, 32% C14); Alkyl* dimethyl ethylbenzyl ammonium cyclohexylsulfamate *(50% C12, 30% C14, 17% C16, 3% C18); Alkyl* dimethyl isopropylbenzyl ammonium chloride *(50% C12, 30% C14, 17% C16, 3% C18); Alkyl* dipropoxyamine *(47% C12, 18% C14, 10% C18, 9% C10, 8% C16, 8% C8); Alkyl* dodecylbenzyl dimethyl ammonium chloride *(70% C12, 30% C14); Alkyl* methyl isoquinolinium chloride *(55% C14, 12% C12, 17% C16, 3% C18); Alkyl* monoethanolamide *(as in fatty acids of coconut oil); Alkyl* N,N-bis(2-hydroxyethyl)amine *(100% C8-C18); Alkyl* poly(oxypropylene)poly(oxyethylene)-iodine complex *(43% C10, 30% C14, 12% C12, 10% C16, 5% C18); Alkyl* sodium benzene sulfonate *(56% C, 11, 33% C12, 7% C10, 4% C13); Alkyl* trimethyl ammonium bromide *(67/C16, 30% C14, 3% C12-C18); Alkyl* trimethyl ammonium bromide *(95% C14, 5% C16); Alkyl* trimethyl ammonium chloride *(70% C12, 30% C14); Alkyl* trimethyl ammonium chloride *(70% C18, 27% C16, 3% C14); Alkyl* trimethyl ammonium chloride *(90% C18, 10% C16); Alkyl* trimethyl ammonium chloride *(alkyl as in fatty acids of soybean oil); Alkyl* trimethyl ammonium chloride *(as in fatty acids of coconut oil); Alkyl* trimethyl ammonium chloride *derived from cottonseed oil; Alkyl*-5-hydroxy-4-oxo-2(4H)-pyranylmethyl dimethyl ammonium chloride *(49% C12, 17% C14, 17% C1O, 10% C18, 9% C16, 8% C8); Alkyl*-diamine monobenzoate *(as in fatty acids of coconut oil); Alkyl*-N,N-bis(2-hydroxyethyl)amine *(100% C12-C18); Alkyl*-N,N-bis(2-hydroxyethyl)methyl ammonium chloride *(53% C12, 19% C14, 8.5% C16, 7.0% C8, 6.5% C10, 6.0% C18); Alkyl*-N,N-di(hydroxyethyl)amine *(as in fatty acids of soybean oil); ALKYL-1,3-PROPYLENE DIAMINE ACETATE, ALKYL DERIVED FROM COCONUT OIL FATTY ACIDS; Alkyl-amino betaine; Alkylated aromatic petroleum oil; Allantoin; Allethrin; Allethrin Coil; Allethrin, d-trans Allethrin; Allyl alcohol; Allyl isothiocyanate; alpha-(((Diethoxyphosphinothioyl)oxy)imino)benzene<BR>acetonitrile; alpha-(+)-Pinene ALPHA-(PARA-DODECYLPHENYL)-OMEGA-HYDROXYPOLY(OXYETHYLENE); ALPHA-(PARA-NONYLPHENYL)-OMEGA-HYDROXYPOLY(OXYETHYLENE); ALPHA-(PARA-NONYLPHENYL)-OMEGA-HYDROXYPOLY(OXYETHYLENE), BRANCHED; ALPHA-(PARA-NONYLPHENYL)-OMEGA-HYDROXYPOLY(OXYETHYLENE), PHOSPHATE ESTER; ALPHA-(PARA-TERT-BUTYLPHENYL)-OMEGA-HYDROXYPOLY(OXYETHYLENE) PHOSPHATE; ALPHA-[PARA-(1,1,3,3-TETRAMETHYLBUTYL)PHENYL]-OMEGA-HYDROXYPOLY(OXYETHYLENE); ALPHA-2,6,8-TRIMETHYL-4-NONYLOXY-OMEGA-HYDROXYPOLY(OXYETHYLENE); ALPHA-ALKYL (C10-C14)-OMEGA-HYDROXYPOLY(OXYETHYLENE); ALPHA-ALKYL (C10-C16)-OMEGA-HYDROXYPOLY(OXYETHYLENE); ALPHA-ALKYL (C12-C14)-OMEGA-HYDROXYPOLY(OXYETHYLENE); ALPHA-ALKYL (C12-C15)-OMEGA-HYDROXYPOLY(OXYETHYLENE) SULFATE, SODIUM SALT; ALPHA-ALKYL (C12-C16)-OMEGA-HYDROXYPOLY(OXYETHYLENE); ALPHA-ALKYL (C8-C18)-OMEGA-HYDROXYPOLY(OXYETHYLENE) POLY(OXYPROPYLENE); ALPHA-ALKYL (C9-C11)-OMEGA-HYDROXYPOLY(OXYETHYLENE); ALPHA-ALKYL (C9-C16)-OMEGA-HYDROXYPOLY(OXYETHYLENE); ALPHA-ALKYL (SECONDARY C11-C15)-OMEGA-HYDROXYPOLY(OXYETHYLENE); ALPHA-ALKYL (SECONDARY C12-C14)-OMEGA-HYDROXYPOLY(OXYETHYLENE) ALPHA-ALKYLARYL-OMEGA-HYDROXYPOLY(OXYETHYLENE); alpha-Alkyl-omega-hydroxypoly(oxyethylene)-iodine complex *(100% C12-C15); alpha-C11-15-sec-alkyl-omega-hydroxypoly(oxy-1,2-e<BR>thanediyl); ALPHA-CHLORALOSE; alpha-Chlorohydrin; ALPHA-CYPERMETHRIN; ALPHA-DODECYL-OMEGA-HYDROXYPOLY(OXYETHYLENE); ALPHA-ISODECYL-OMEGA-HYDROXYPOLY(OXYETHYLENE) ALPHA-ISODECYL-OMEGA-HYDROXYPOLY(OXYETHYLENE) PHOSPHATE; ALPHA-OCTYLPHENYL-OMEGA-HYDROXYPOLY(OXYETHYLENE); ALPHA-PINENE BETA-PINENE COPOLYMER; ALPHA-TRIDECYL-OMEGA-HYDROXYPOLY(OXYETHANOL) PHOSPHATE; ALPHA-UNDECYL-OMEGA-HYDROXYPOLY(OXYETHYLENE); Aluminum 3,6-dichloro-o-anisate; Aluminum chloride; Aluminum phosphide; Aluminum powder; Aluminum sulfate; Amdro; AMETOCTRADIN; Ametryn; Amicarbazone; Amidochlor; Amine oxide; Amines, C10-16-alkyldimethyl, N-oxides; Amines, tallow alkyl, ethoxylated propoxylated; AMINO ETHOXY VINYL GLYCINE HYDROCHLORIDE; AMINOCYCLOPYRACHLOR; AMINOCYCLOPYRACHLOR, POTASSIUM SALT; Aminopyralid; Aminopyralid, triisopropanolamine salt; Amitraz; Amitrole; AMMONIA; Ammonium 1-naphthaleneacetate; Ammonium 2,3,6-trichlorophenylacetate; Ammonium 3-amino-2,5-dichlorobenzoate; Ammonium alum; Ammonium arsenate; AMMONIUM BICARBONATE; Ammonium bromide; Ammonium carbonate; Ammonium chloride; Ammonium dinoseb (2-sec-butyl-4,6-dinitrophenol); Ammonium ethylenediaminetetraacetate; Ammonium fluosilicate; Ammonium isobutyrate; Ammonium lauryl sulfate; AMMONIUM NITRATE; AMMONIUM NONANOATE; Ammonium oleate; Ammonium oxalate; Ammonium polysulfides; AMMONIUM PROPIONATE; Ammonium soaps of fatty acids; Ammonium sulfamate; AMMONIUM SULFATE; Ammonium thiosulfate; AMYL ACETATE; a-Naphthylthiourea; Ancymidol; Androst-5-en-3-ol, 17-((3-(dimethylamino)propyl)methyl)amino)-, dihydrochloride, (3.beta.,17.beta.)-; Androsterone; Anilazine; Animal gland extract (lion urine); Anthracene oil; Anthraquinone; Antimony potassium tartrate; Antimycin A; AROMATIC 200; Aromatic petroleum solvent; Arsenic acid; Arsenic acid (H3AsO4), calcium salt (2:3); Arsenic acid (H3AsO4), lead(2+) salt (1:1); Arsenic oxide (As2O3); Arsenic oxide (As2O5); Arsenic pentoxide; Arsenic trioxide; Arsonic acid, (4-aminophenyl)-; Arsonic acid, methyl-, compd. with 1-docecanamine (1:1); Asbestos; Asphalt; Aspon; Assert; Assure; Asulam; Asulam, sodium salt; Atrazine; ATTAPULGITE; Auramine; Avenge; Azaconazole; Azadirachtin; Azetidine-3-carboxylic acid; Azinphos-Methyl; Azinphos-methyl, Guthion; Azodrin; Azoxystrobin; BALSAM FIR OIL; Baquacil, PHMB; Barban; Bardac 2180; Bardac 22C50; Barium carbonate; Barium metaborate; Barium sulfate; Barley straw; Barquat; Barquat MS-100; Basic copper chloride; Basic copper sulfate; Basic copper zinc sulfate complex; Baycor; Bayluscide; Baytan, Triadimenol; Bendiocarb; BENEFIN; Benfluralin; Benomyl; Benoxacor; BENSULFURON METHYL; Bensulfuron-methyl; Bensulide; Bentazon; BENTAZON, SODIUM SALT; Benthiavalicarbarb; BENTONITE; Benylate; Benzaldehyde; Benzaldehyde, 4-(1-methylethyl)-; Benzamide, 2-chloro-N-(((4-(trifluoromethoxy)phenyl)amino)carbonyl)-; Benzamide, 2-hydroxy-N-(4-hydroxyphenyl)-; Benzamide, 5-chloro-2-hydroxy-N-phenyl-; Benzamide, N-(((4-(((((4-chlorophenyl)cyclopropylmethylene)amino)oxy)methyl)phenyl)amino)carbonyl)-2,6-difluoro-; Benzamide, N-{{{3,5-dichloro-4-{{3-chloro-5-(trifluoromethyl)-2-pyridinyl}oxy}phenyl}amino}carbonyl}-2,6-difluoro-; Benzenamine, 4-(methylsulfonyl)-2,6-dinitro-N,N-dipropyl-; Benzene; Benzene hexachloride gamma isomer; Benzene, 1-(8-methoxy-4,8-dimethyl(nonyl)-4-(1-methylethyl)-; Benzene, 1,1′-(2,2-dichloroethylidene)bis(4-ethyl-; Benzeneacetamide, 2-?(2,5-dimethylphenoxy)methylU-.alpha.-(methoxyimino)-N-methyl-; Benzeneacetic acid, 2,3,6-trichloro-, compd. with N-methylmethanamine; Benzeneacetic acid, 4-chloro-.alpha.-(1-methylethyl)-, cyano(3-phenoxyphenyl)methyl ester, (R-R*,S*))-; Benzeneethanimidoyl chloride, N,4-dihydroxy-.alpha.-oxo-; Benzenemathanaminium, N-(2-(dodecylamino)-2-oxoethyl)-N,N-dimethyl-, chloride; Benzenemethanaminium, N,N-dimethyl-N-(2-(2-(4-(1,1,3,3-tetramethylbutyl)phenoxy)ethoxy)ethyl)-, chloride; Benzenemethanaminium, N,N-dimethyl-N-(2-(2-(methyl-4-(1,1,3,3-tetramethylbutyl)phenoxy)ethoxy)ethyl)-, chloride; Benzenemethanaminium, N,N-dimethyl-N-(2-(2-(methylbis(2-methylpropyl)phenoxy)ethoxy)ethyl)-, chloride, compd. with (1,1′-biphenyl)-2-ol (1:1); Benzenemethanaminium, N-dodecyl-N,N,2,4,5-pentamethyl-, chloride; Benzenemethanol, 2,4-dichloro-; BENZENESULFONIC ACID, C10-16-ALKYL DERIVATIVES; Benzenesulfonic acid, nonyl-, sodium salt; Benzo(b)thiophene-4-ol, methylcarbamate; BENZOBICYCLON; Benzocaine; BENZOIC ACID; Benzoic acid, 2-((1-naphthalenylamino)carbonyl)-; Benzoic acid, 2,3,5-triiodo-, compd. with N-methylmethanamine (1:1); Benzoic acid, 2-{{{{(4,6-dimethyl-2-pyrimidinyl)amino}carbonyl}amino}sulfonyl}-, 3-oxetanyl ester; Benzoic acid, 2-chloro-5-[3,6-dihydro-3-methyl-2,6-dioxo-4-(trifluoromethyl)-1(2H)-pyrimidinyl]-, 1,1-dimethyl-2-oxo-2-(2-propenyloxy)ethyl ester; Benzoic acid, 2-hydroxy-, compd. with 1-dodecanamine (1:1); Benzoic acid, 3,6-dichloro-2-methoxy-, compd with 2,2′-iminobis(ethanol) (1:1); Benzoic acid, 4-((dichloroamino)sulfonyl)-; Benzoic acid, 4-(butylamino)-, 2-(dimethylamino)ethyl ester, monohydrochloride; BENZOVINDIFLUPYR; Benzoyl peroxide; Benzyl alcohol; Benzyl benzoate; Benzyl bromoacetate; Benzyl diethyl ((2,6-xylylcarbamoyl)methyl) ammonium benzoate; Benzyl tris(2-hydroxyethyl) ammonium chloride; Benzyladenine; Bergamot oil; beta-((1,1′-Biphenyl)-4-yloxy)-alpha-(1,1-dimethyl<BR>ethyl)-1H-1,2,4-triazole-1-ethanol; beta-(Cyanovinyl)-p-tolylsulfone; beta-Bromo-beta-nitrostyrene; BETA-CONGLUTIN; BETA-CYFLUTHRIN; Betadine; beta-Glucuronidase (GUS); beta-Naphthoxyacetic acid; BETA-PINENE POLYMER; Bethoxazin; Bicyclo(2.2.1)heptan-2-ol, 1,7,7-trimethyl-, exo-; Bidrin; BIFENAZATE; Bifenox; Bifenthrin; Bioallethrin; Bioban CS-1135; Biomet; Bioresmethrin; Biosol; Biphenyl; Bis(tributyltin) adipate; Bis(tributyltin) dodecenylsuccinate; Bis(tributyltin) succinate; Bis(tributyltin) sulfide; Bis(trichloromethyl) sulfone; Bis(tripropyltin) oxide; BISPHENOL A; Bispyribac-sodium; Bitumen; Bladex, Cyanazine; Bolstar; Bone oil; Borax; Borax (B4Na2O7.10H2O); Boric acid; Boric acid (H3BO3), polymer with N-decyl-1-decanamine, oxirane and 1,2-propanediol; Boric acid (HBO2), sodium salt; Boric acid, calcium salt; Boric oxide; Bornyl acetate; Boron sodium oxide; Boron sodium oxide (B4Na2O7) (1330-43-4); Boron sodium oxide (B4Na2O7), pentahydrate; Boron sodium oxide (B8Na2O13) (12008-41-2); Boron sodium oxide (B8Na2O13), tetrahydrate (12280-03-4); Boron sodium oxide pentahydrate; Boscalid; Brewer's yeast extract hydrolysate from Saccharomyces cerevisiae; Brodifacoum; Bromacil; BROMACIL, LITHIUM SALT; Bromadiolone; Bromethalin; Bromine; Bromine chloride; Bromochloro-5-ethyl-5-methyl-2,4-imidazolidinedion<BR>e; Bromopropylate; Bromoxynil; BROMOXYNIL HEPTANOATE; Bromoxynil octanoate; Bromoxynil phenol; Bronopol; BTC 1100; Bufencarb; BUFFALO GOURD ROOT POWDER; Buprofezin; Busan 30, Busan 72; Busan 77; Busan 85; Butachlor; Butafenacil; Butanedioic acid, 2,3-dihydroxy-{R-(R*,R*)}-, monopotassium salt; Butanedioic acid, sulfo-, 1,4-bis(2-ethylhexyl) ester, sodium salt; Butanoic acid, 4-(2,4-dichlorophenoxy)-, butyl ester; Butanoic acid, 4-(2,4-dichlorophenoxy)-, isooctyl ester; Butanoic acid, 4-oxo-4-((tributylstannyl)oxy)-, 1-methylethyl ester; Butanoic acid, anhydride; BUTOPYRONOXYL; BUTOXY POLYPROPOXY POLYETHOXY ETHANOL-IODINE COMPLEX; BUTOXY POLYPROPYLENE GLYCOL; Butoxycarboxim; Butoxyethanol 4-(2,4-dichlorophenoxy)butyrate; Butoxyethyl 2-(2,4-dichlorophenoxy)propionate; Butoxyethyl 2,4,5-trichlorophenoxyacetate; Butoxyethyl 2-methyl-4-chlorophenoxyacetate; Butoxypropyl silvex; Butralin; Butyl 2-methyl-4-chlorophenoxyacetate; Butyl 3,4-dihydro-2,2-dimethyl-4-oxo-2H-pyran-6-carboxylate; Butyl 4-hydroxybenzoate; BUTYL ALCOHOL; BUTYL LACTATE; Butylate; Butylated hydroxytoluene; Butyric acid ester of dimethyl (2,2,2-trichloro-1-hydroxyethyl)phosphonate; Butyrolactone; C10-16-Alkylbenzene sulfonic acid; Cacodylic acid; Cacodylic acid, sodium salt; Cadmium carbonate; Cadmium chloride; Cadmium sebacate; Cadmium succinate; Cadmium, (benzenamine)bis(2-hydroxypropanoato-O1,O2)-; Cadre; Cadusafos; CALCIUM ACETATE; CALCIUM CARBONATE; Calcium chlorate; CALCIUM CHLORIDE; Calcium cyanamide; Calcium cyanide; CALCIUM HYDROXIDE; Calcium hydroxide (Ca(OH)2); Calcium hypochlorite; Calcium oxide; Calcium oxytetracycline; Calcium phosphate; Calcium polysulfide; Calcium propionate; CALCIUM SALTS OF PHOSPHOROUS ACID; Calcium silicate; Calcium sulfate; Calcium tetrathiocarbonate; Calcium thiosulfate; CAMA; CAMPHOR; Camphor oil; Canadian balsam; CANOLA OIL; CAPRIC ACID; Capric diethanolamide; Caproic acid; CAPRYLIC ACID; Capsaicin; Capsicum; Capsicum oleoresin; Captafol; Captan; Carbamate; Carbamic acid, ((4-methyl-1,3-phenylene)bis(iminocarbonyl-1H-benzimidazole-1,2-diyl))bis-, dimethyl ester; Carbamic acid, 1H-benzimidazol-2-yl-, methyl ester, monohydrochloride; Carbamic acid, 1H-benzimidazol-2-yl-, methyl ester, phosphate (1:1); Carbamic acid, butyl-, 3-iodo-2-propynyl ester; Carbamic acid, dimethyl-, 1-((dimethylamino)carbonyl)-5-methyl-1H-pyrazol-3-yl ester; Carbamic acid, phenyl-, 1-methylethyl ester; Carbamodithioic acid, cyano-, disodium salt; Carbamodithioic acid, diethyl-, 2-chloro-2-propenyl ester; Carbamothioic acid, bis(1-methylpropyl)-, S-(phenylmethyl) ester; Carbamothioic acid, dipropyl-, S-ethyl ester; CARBARYL; Carbaryl (also Sevin); Carbendazim; CARBO METHOXY ETHER CELLULOSE, SODIUM SALT; Carbofuran; CARBON; CARBON DIOXIDE; Carbon disulfide; Carbon tetrachloride; Carbophenothion; Carbosulfan; Carboxin; Carboxymethyl-1,1-ethylcarboxymethyl-2-undecylimidazolinium hydroxide, disodium salt; Carbyne; Carfentrazone-ethyl; CAS Reg. No. 83542-87-4 (Propanoic acid, 3,3-dichloro-, 2-(2-hydroxyethoxy)ethyl ester); CASEIN; Castor oil; CASTOR OIL ETHOXYLATE; Cedar leaf oil; Cedarwood oil; Cedarwood oils; Cellulose, carboxymethyl ether, sodium salt; Cetiol HE; Cetyl alcohol; Cetyl dimethyl ethyl ammonium bromide; Cetyl pyridinium bromide; Cetyl pyridinium chloride; Cetyl trimethyl ammonium bromide; CheckMate Technical Pheromone; Chenopodium ambrosiodes NEAR AMBROSIODES; Chevron 100; Chitin; Chitinolytic enzymes; CHITOSAN; Chloramben; Chloramine B; Chloramine T; Chloranil; CHLORANTRANILIPROLE; Chlorbromuron; Chlordane; Chlordane, technical; Chlordimeform; Chlordimeform HCL; Chlorethoxyfos; Chlorfenapyr; Chlorfenvinphos; Chlorflurenol; CHLORFLURENOL, METHYL ESTER; CHLORHEXIDINE DIACETATE; CHLORHEXIDINE GLUCONATE; Chloric acid; Chlorimuron; Chlorinated glycoluril (1,3,4,6-Tetrachloroglycoluril and related compounds); Chlorinated isocyanurates; Chlorinated levulinic acids (45% minimum chlorine required); Chlorinated trisodium phosphate; Chlorine; Chlorine dioxide; Chlorite clay; Chlormequat chloride; Chlorobenzene; Chlorobenzilate; Chlorodifluoromethane (HCFC-22); Chloroform; Chloromethoxypropylmercuric acetate; Chloroneb; Chlorophacinone; Chloropicrin; Chloropropylate; Chlorosulfamic acid; Chlorothalonil; Chloroxuron; Chloroxylenol; Chlorpropham; CHLORPYRIFOS; Chlorpyrifos, Dursban; Chlorpyrifos-methyl; Chlorsulfuron; CHLORTHAL-DIMETHYL; Chlropyrifos-methyl; CHOLECALCIFEROL; CHOLINE CHLORIDE; Chromated arsenicals; Chromic acid; Cidial; Cimectacarb; Cinmethylin; CINNAMALDEHYDE; Cinnamon; Cinnamon oil; cis-7,8-Epoxy-2-methyloctadecane; cis-9-Tricosene; Cismethrin; Citral; Citric acid; Citronellol; CLARIFIED HYDROPHOBIC EXTRACT OF NEEM OIL; Clarified hydrophobic neem oil; Classic, Chlorimuron; Clethodim; Clodinafop-propargyl; Clodinafop-propargyl (CAS Reg. No. 105512-06-9); Clofencet; Clofentezine; Clomazone; Clopyralid; Clopyralid potassium; Clopyralid, monoethanolamine salt; Clopyralid, triethanolamine; CLOPYRALID, TRIETHYLAMINE SALT; Cloquintocet mexyl; Cloransulam-methyl; Clothianidin; Clove; CLOVE OIL; Clove, Crushed; Coal tar; Coal tar creosote; Coal tar neutral oils; Coal tar, Creosote; Cobalt naphthenate; Cocamide diethanolamine; Cocoamine acetate; COCONUT DIETHANOLAMIDE; Coconut oil; Cod liver oil; Combustion Product Gas; COMPLEX CARBOHYDRATE POLYMER DERIVATIVE; COMPLEX POLYMERIC POLYHYDROXY ACIDS; Compound 1080; COPPER; Copper-ammonia complex; Copper-zinc-chromate complex; Copper 2-pyridinethio-1-oxide; COPPER 2-PYRIDINETHIOL-1-OXIDE; Copper 8-quinolinolate; COPPER 8-QUINOLINOLEATE; Copper acetoarsenite; Copper ammonium carbonate; COPPER AMMONIUM COMPLEX; Copper arsenate; Copper as elemental; Copper as elemental from copper-etidronic acid complex; Copper as metallic (in the form of chelates of copper citrate and copper gluconate); Copper carbonate; COPPER CARBONATE, BASIC; Copper chloride (dihydrate); COPPER CITRATE; COPPER CITRATE CHELATE; Copper complex with ammonia and ethylene diamine tetraacetate; Copper dehydroabietylammonium 2-ethylhexanoate; COPPER DIAMMONIUM DIACETATE COMPLEX; Copper ethanolamine complex; COPPER ETHANOLAMINE COMPLEXES, MIXED; Copper ethylene diamine complex; COPPER ETHYLENEDIAMINE COMPLEX; COPPER GLUCONATE CHELATE; Copper hydroxide; Copper linoleate; COPPER MONOETHANOLAMINE COMPLEX; Copper naphthenate; Copper nitrate; Copper octanoate; Copper oleate; Copper oxalate; COPPER OXIDE (IC); COPPER OXIDE (OUS); Copper oxychloride; Copper oxychloride (Cu2Cl(OH)3); Copper oxychloride sulfate; Copper salts of fatty and rosin acids; Copper silicate; COPPER SULFATE (ANHYDROUS); COPPER SULFATE (BASIC); COPPER SULFATE (PENTAHYDRATE); Copper sulfate monohydrate; Copper sulfate pentahydrate; Copper thiocyanate; Copper triethanolamine; COPPER TRIETHANOLAMINE COMPLEX; Copper, bis(8-quinolinolato-N1,08)-; Copper, bis[1-cyclohexyl-1,2-di(hydroxy-.kappa.O)diazeniumato(2-)]-; Copper-ammonia complex; Corn Gluten; CORN GLUTEN MEAL; CORN MINT OIL; CORN PRODUCT, HYDROLYZED; CORN STEEP LIQUOR; CORN SYRUP; Cosan 528; COTTONSEED FLOUR; COTTONSEED OIL; Coumaphos; COYOTE URINE; Creosote oil (Note: Derived from any source); Creosote, wood; Cresylic acid, coal tar acids, coal tar phenols, or coal tar cresols; Crotoxyphos; Crufomate; Cry1F derived delta endotoxin of Bacillus thuringiensis(B.t.) encapsulated in killed Pseudomonas fluorescens; CryIC derived delta endotoxin of Bacillus thuringiensis encapsulated in killed Pseudomonas fluorescens; Cryolite; CUBE EXTRACTS; Cube Resins other than rotenone; Cuprammonium zirconyl carbonate; Cupric ferric subsulfate complex; Cupric oxide; Cuprous and cupric oxide, mixed; Cuprous chloride (Cu2Cl2); Cuprous oxide; CUPROUS THIOCYANATE; Cyanamide; CYANAZINE; CYANTRANILIPROLE; CYANURIC ACID; CYANURIC ACID, MONOSODIUM SALT; CYAZOFAMID; Cyclanilide; CYCLANILIPROLE; CYCLOATE; Cyclobutaneethanol, 1-methyl-2-(1-methylethenyl)-, (1R-cis)-; Cyclohexane; Cyclohexanecarboxamide, 1-(4-chloro-1,3-dihydro-1,3-dioxo-2H-isoindol-2-yl)-; Cyclohexanecarboxylic acid, 2,2-dimethyl-4,6-dioxo-5-{1-{(2-propenyloxy)imino}butyl}-, methyl ester, ion(1-), sodium; Cyclohexanone; Cycloheximide; Cyclopentadecatriene; Cyclopropanecarboxylate; Cyclopropanecarboxylic acid, 2,2-dimethyl-3-(2-methyl-1-propenyl)-, 2-methyl-4-oxo-3-(2,4-pentadienyl)-2-cyclopenten-1-yl ester, (1R-(1.alpha.(S*(Z)),3.beta.))-; Cyclopropanecarboxylic acid, 3-(2,2-dichloroethenyl)-2,2-dimethyl_, (3-phenoxyphenyl)methyl ester, cis-(.+−.); Cyclopropanecarboxylic acid, 3-(3-methoxy-2-methyl-3-oxo-1-propenyl)-2,2-dimethyl-, 2-methyl-4-oxo-3-(2,4-pentadienyl)-2-cyclopenten-1-yl ester, (1R-(1.alpha.(S*(Z)),3-.beta.(E)))-; CYFLUFENAMID; CYFLUMETOFEN; Cyfluthrin; Cyhalofop-butyl; Cyhalothrin; Cyhexatin; CYMOXANIL; Cypermethrin; Cyphenothrin; Cyprazine; Cyproconazole; Cyprodinil; Cyromazine; CYTOKININ (AS KINETIN); D & C Red No. 28; Dactylaria brochopaga; Dalapon; D-ALLETHRIN; Daminozide; Danitol, Fenpropathrin; Dantobrom; Dazomet; DBCP; DBNPA; DCNA; DCPA; DCPA (or chlorthal-dimethyl?); DDT; DDVP; Decanoic acid, 3-[[6-deoxy-2-o-(6-deoxy-alpha-L-mannopyranosyl)-alpha-L-mannopyranosyl]oxy]-, 1-(carboxymethyl)octyl ester, mixt. with 1-(carboxymethyl)octyl 3-[(6-deoxy-alpha-L-mannopyranosyl)oxy]decanoate; Decatriene; Decyl isononyl dimethyl ammonium chloride; DECYL PHENOXY BENZENE DISULFONIC ACID, DISODIUM SALT; DEET; DEF; Dehydroabietylammonium phenoxide; Delta endotoxin of Bacillus thuringiensis subsp. san diego encapsulated in killed Pseudomonas fluorescens; Delta endotoxin of Bacillus thuringiensis variety kurstaki encapsulated in killed Pseudomonas fluorescens; Deltamethrin; Denatonium saccharide; DERIVATED NATURAL POLYMERS; Derris resins other than rotenone; Desmedipham; detergent; Dextrin; D-Gluconic acid; D-Gluconic acid, compd with N,N″-bis(4-chlorophenyl)-3,12-diimino-2,4,11,13-tetraazatetradecanediimidamide (2:1); Di(alkyl*oxypropyl)dimethyl ammonium chloride *(60% C8, 40% C10); Diacetone alcohol; Dialifor; Dialkyl* dimethyl ammonium bentonite *(as in fatty acids of tallow); Dialkyl* dimethyl ammonium chloride *(47% C12, 18% C14, 10% C18, 9% C10, 8% C16, 8% C8); Dialkyl* dimethyl ammonium chloride *(48% C12, 17% C14, 10⁰/C18, 9% C16, 8% C8, 7% C1O, 1% C6); Dialkyl* dimethyl ammonium chloride *(50% C12, 20% C14, 15% C10, 10% C16, 5% C18); Dialkyl* dimethyl ammonium chloride *(50% C12, 30% C14, 20% C16); Dialkyl* dimethyl ammonium chloride *(70% C18, 26% C16, 4% C14); Dialkyl* dimethyl ammonium chloride *(as in fatty acids of coconut oil); Dialkyl* methyl benzyl ammonium chloride *(60% C14, 30% C16, 5% C18, 5% C12); Diallate; Diallyl disulfide; Diamidafos; Diammonium ethylenebis(dithiocarbamate); Diarsenic acid, tetrasodium salt; Diatamaceous Earth; Diatomaceous earth; Diazinon; Dibutyl phthalate; Dibutyl succinate; Dicamba; Dicamba with 2,4-D; Dicamba, diethanolamine salt; Dicamba, diglycoamine salt; Dicamba, diglycolamine salt; Dicamba, dimethylamine salt; Dicamba, isopropanolamine salt; Dicamba, isopropylamine salt; DICAMBA, POTASSIUM SALT; Dicamba, sodium salt; Dichlobenil; Dichlofenthion; Dichlorflurenol-methyl; Dichlormid; Dichloro diphenyl trichloroethane (no longer permitted in pesticides) (NO INERT USE); Dichlorodifluoromethane; Dichlorophene; Dichloro-s-triazinetrione; Dichlorprop; Dichlorvos; Dichromic acid, (H2Cr2O7), disodium salt, dihydrate; Diclofop; Diclofop-methyl; DICLORAN; Diclosulam; Dicofol; Dicrotophos; Dicyclopentadiene linseed oil copolymer; DIDECYL DIMETHYL AMMONIUM BICARBONATE; DIDECYL DIMETHYL AMMONIUM CARBONATE; Didecyl dimethyl ammonium carbonate and didecyl dimethyl ammonium bicarbonate; Didecyl dimethyl ammonium chloride; Didecyl methyl benzyl ammonium chloride; Dienochlor; Diethanolamides of the fatty acids of coconut oil; DIETHANOLAMINE; Diethanolamine 2-(2-methyl-4-chlorophenoxy)propionate; Diethanolamine 2-methyl-4-chlorophenoxyacetate; Diethanolamine 3-amino-2,5-dichlorobenzoate; Diethanolamine 4-chlorophenoxyacetate; Diethanolamine dodecylbenzenesulfonate (Data Submitter Rights); Diethatyl ethyl; Diethyl 4,4′-o-phenylenebis(3-thioallophanate); Diethyl toluamide; Diethyl-2-(4-methylbenzyloxy)ethylamine; DIETHYLENE GLYCOL; Diethylene glycol monomethyl ether; Diethylethanolamine 2,4-dichlorophenoxyacetate; Difenacoum; Difenoconazole; Difenzoquat methyl sulfate; Difethialone; Diflubenzuron; Diflufenzopyr; Diflufenzopyr (includes diflufenzopyr sodium salt); DIFLUFENZOPYR, SODIUM SALT; Diflufenzopyr-sodium; DIGLYCERIDES OF FATTY ACIDS; DIGLYCOLAMINE SALT OF 3,6-DICHLORO-O-ANISIC ACID; Dihydroabietylamine acetate; Dihydroazadirachtin; Diiodomethyl p-chlorophenyl sulfone; DIIODOMETHYL P-TOLYL SULFONE; Diisobutyl ketone; Diisobutylphenoxyethanol; Dikegulac; DIKEGULAC SODIUM; Dilauryl dimethyl ammonium bromide; Dimethenamid; dimethenamide-P; DIMETHENAMID-P; Dimethipin; Dimethoate; Dimethomorph; Dimethoxane; Dimethrin; Dimethyl 3-hydroxyglutaconate dimethyl phosphate; DIMETHYL ALKYL TERTIARY AMINES; DIMETHYL DICOCOALKYL AMMONIUM SALT WITH NAPHTHALENESULFONIC ACID, FORMALDEHYDE CONDENSATE; Dimethyl isopropylaminophenanthrene; Dimethyl phthalate; DIMETHYL SILICONE FLUID EMULSION; Dimethyl sulfoxide; Dimethylamine 2-(2,4-dichlorophenoxy)propionate; Dimethylamine 4-(2,4-dichlorophenoxy)butyrate; DIMETHYLPOLYSILOXANE; Diniconazole; Dinitramine; Dinocap; Dinoseb; Dinotefuran; Dioctyl dimethyl ammonium chloride; Dioctyl sodium sulfosuccinate; Dioxathion; Diphacinone; DIPHACINONE, SODIUM SALT; Diphenamid; Diphenylacetonitrile; Diphenylamine; Dipotassium phosphate; Dipropetryn; DIPROPYL ISOCINCHOMERONATE; DIPROPYLENE GLYCOL; DIPROPYLENE GLYCOL METHYL ETHER; Diquat; Diquat dibromide; Disodium 2,2′-oxybis(4-dodecylbenzenesulfonate); Disodium 4-dodecyl-2,4′-oxydibenzenesulfonate; Disodium di(2-hydroxyethyl)ethylenediaminediacetate; Disodium ethylenediaminetetraacetate; DISODIUM LAURYL SULFOSUCCINATE; Disodium monoethanolamine phosphate; Disodium N-(2-hydroxyethyl)iminodiacetate; Disodium n-decyldiphenyl ether disulfonate; DISODIUM OCTABORATE ANHYDROUS; Disodium octaborate tetrahydrate; DISODIUM PHOSPHATE; DISODIUM SALT OF ETHYLENEDIAMINETETRAACETIC ACID DIHYDRATE; Distilled cubeb oil; Disulfoton; Ditalimfos; Dithianon; Dithiopyr; Diuron; D-limonene; D-limonene oil; DMlHMP; DNOC, SODIUM SALT; Dodecanoic acid, 2-thiocyanatoethyl ester; Dodecanoic acid, compd with 2-aminoethanol (1:1); Dodecanoic acid, pentachlorophenyl ester; Dodecen-1-ol, (Z)-; Dodecyl 2-methacrylate; DODECYL BENZENE SULFONIC ACID-IODINE COMPLEX; Dodecyl dimethyl benzyl ammonium bromide; Dodecyl dimethyl benzyl ammonium chloride; Dodecyl dimethyl benzyl ammonium naphthenate; DODECYL DIMETHYL BETAINE; DODECYL GUANIDINE HYDROCHLORIDE; Dodecylamine lactate; Dodecylammonium sulfate; DODECYLBENZENE SULFONIC ACID; DODECYLBENZENE SULFONIC ACID, CALCIUM SALT; Dodecylbenzenesulfonic acid; Dodecylbenzyl trimethyl ammonium chloride; Dodecylguanidine HCl; Dodecylguanidine hydrochloride; Dodine; Dowfax 3B1 (Data Submitter Rights); Dowicil 75/150; Dried blood; Dried fermentation solids & solubles of Myrothecium verrucaria; Dried fermentation solids and solubles resulting from fermentation of Trichoderma harzianum isolate T-39, containing T-39 fungus propagules, as either conidia or mycelia; DSMA; d-trans-.beta.Cypermethrin; E,E-8,10-DODECADIEN-1-OL; E-11-TETRADECEN-1-YL ACETATE; E-8-DODECENYL ACETATE; Ebufos; Econosan Acid Sanitizer; EDTA; EDTA, copper salt; EDTA, TETRASODIUM SALT; Egg solids; Emamectin benzoate; EMULSIFIABLE METHYLATED VEGETABLE OIL; EMULSIFIABLE POLYETHYLENE; Endosulfan; Endothal-dipotassium; Endothall; Endothall dipotassium salt; ENDOTHALL, DIPOTASSIUM SALT; ENDOTHALL, MONO [N,N-DIMETHYL ALKYLAMINE] SALT; Endothall, mono(N,N,-dimethyl alkyl amine) salt; Endothall, mono(N,N-Dimethyl alkyl*; Endrin; Epoxiconazole; Eptam; EPTC; Erbon; Esfenvalerate; Essential oils; Ester gum; Ester, and Acetamide; ETHABOXAM; Ethalfluralin; Ethametsulfuron; Ethanamine, N,N-diethyl-2-(2-((1,7,7-trimethylbicyclo(2.2.1)hept-2-yl)oxy)ethoxy)-; Ethane, 1,1,1,2-Tetrafluoro-; Ethaneperoxoic acid; Ethanol; Ethanol, 2-(2,4-dichlorophenoxy)-, phosphite (3:1); Ethanol, 2-amino-, hydrogen phosphate (ester), monosodium salt; ETHANOLAMINE; Ethanolamine dodecylbenzenesulfonate; Ethanone, 2-bromo-1-(4-hydroxyphenyl)-; Ethephon; Ethephone; Ethiolate; Ethion; Ethofumesate; Ethoprop; Ethoxylated lanolin; Ethoxylated monoethanolamine of lauric acid; Ethoxyquin; Ethyl 1-Naphthaleneactate; Ethyl 1-naphthaleneacetate; Ethyl 4,4′-dichlorobenzilate; Ethyl 4-chloro-2-oxo-3(2H)-benzothiazoleacetate; Ethyl acetate (Fil List); ETHYL ALCOHOL; Ethyl alpha-((dimethoxyphosphinothioyl)thio)benzeneacetate; ETHYL BUTYLACETYLAMINOPROPIONATE; Ethyl formate; Ethyl sulfide; ETHYLENE; Ethylene dibromide; Ethylene dibromide (EDB); ETHYLENE GLYCOL; Ethylene glycol ether of pinene; ETHYLENE GLYCOL MONOMETHYL ETHER; Ethylene oxide; Ethylene thiourea (ETU); Ethylenediaminetetraacetic acid; Ethylenediaminetetraacetic acid (EDTA), trisodium salt; Ethylenediaminetetraacetic acid, sodium salt; Ethylenethiourea; ETOFENPROX; Etofenprox, Ethofenprox; ETOXAZOLE; Etridiazole; Eucalyptus OIL; EUGENOL; Eugenol oil; Express; EXTRACT OF Chenopodium quinoa SAPONINS; FAMOXADONE; Famphur FARNESOL; fatty acid; fatty acid derivative; FATTY ACIDS DERIVED FROM TALLOW; FATTY ACIDS, C16-18 AND C18-UNSATURATED, BRANCHED AND LINEAR; FATTY ACIDS, C16-C18 AND C18-UNSATURATED, METHYL ESTERS; FATTY ACIDS, METHYL ESTERS; FATTY ACIDS, MIXED; Fatty alcohols (079059); Fatty alcohols (54.5% C10, 45.1% C8, 0.4% C6); Fatty alcohols (55.10% C10, 42.88% C8, 1.01% C6, 1.01% C12); Fatty Alcohols 079029; Fenamidone; Fenamiphos; Fenarimol; FENAZAQUIN; Fenbuconazole; FENBUTATIN-OXIDE; Fenhexamid; Fenitrothion; Fenoxaprop; Fenoxaprop-ethyl; Fenoxaprop-p-ethyl; Fenoxycarb; FENPROPATHRIN; Fenpropimorph; FENPYRAZAMINE; Fenpyroximate; Fenridazon; Fensulfothion; Fenthion; Fentin hydroxide; Fenvalerate; Ferbam; Fermentation biomas of Xanthomonas campestris pv. poae; Fermentation Solid; FERRIC SODIUM EDTA; Ferric sulfate; FERRIC SULFATE (ANHYDROUS); Ferrous ammonium sulfate; FERROUS SULFATE (MONOHYDRATE); Ferrous sulfate heptahydrate; Ferrous Sulfate Monhydrate; Ferrous sulfate monohydrate; Fipronil; Fir Needle Oil; FISH OIL; FLAZASULFURON; Flonicamid; Florasulam; FLORPYRAUXIFEN-BENZYL; Flowers of Chamomile (Matricaria chamomilla and/or Anthemidis nobilis); Fluazifop; Fluazifop-butyl; Fluazifop-p-butyl; Fluazinam; Flucarbazone-sodium; Fluchloralin; Flucythrinate; FLUDIOXONIL; FLUENSULFONE; Flufenacet; Flufenpyr-ethyl; FLUMETHRIN; Flumetralin; Flumetsulam; Flumiclorac; Flumiclorac pentyl; FLUMICLORAC-PENTYL; Flumioxazin; Fluometuron; FLUOPICOLIDE; FLUOPYRAM; Fluorodifen; Fluoroglycofen-ethyl; FLUOXASTROBIN; FLUPYRADIFURONE; FLURECOL-METHYL; Fluridone; Fluroxypyr; Fluroxypyr 1-methylheptyl ester; FLUROXYPYR, 1-METHYLHEPTYL ESTER; Fluroxypyr-meptyl; Flurprimidol; Flusilazole; Fluthiacet-methyl; FLUTIANIL; Flutolanil; FLUTRIAFOL; Fluvalinate; FLUXAPYROXAD; Folpet; Fomesafen; Fonofos; Foramsulfuron FORCHLORFENURON; Formaldehyde; Formaldehyde, compd. with 1-ethenyl-2-pyrrolidinone homopolymer; Formetanate; Formetanate HCL; FORMETANATE HYDROCHLORIDE; FORMIC ACID; Fortress; Fosamine; Fosamine ammonium; FOSETYL-AL; Fospirate; Fosthiazate; Fosthietan; FOX URINE; FREE FATTY ACIDS AND/OR AMINE SALTS; Fuel oil #2; Fumaric acid; Fumarin; Furfural; Furilazole; Gamma-aminobutyric acid; gamma-Cyhalothrin; gamma-Undecalactone; Gardona (cis-isomer); Garlic; Garlic oil; Gas cartRidge (as a device for burrowing animal control); Gentamicin; GERANIOL; Geraniol oil; German cockroach pheromone; Gibberellic acid; Gibberellic acid, monopotassium salt; Gibberellin; Gibberellin A4 mixt. with Gibberellin A7; Gibberellin A4/A7; GIBBERELLINS; Glufosinate; GLUFOSINATE-AMMONIUM; Glutaraldehyde; Glutens, corn; GLYCERINE; GLYCEROL; GLYCERYL DIACETATE; GLYCIDYL ETHER; Glycine, hydriodide (4:1), compd. with iodine (4:5); Glycine, N-(hydroxymethyl)-, monosodium salt; Glycine, N-(phosphonomethyl)-potassium salt; Glycine, N-(phosphonomethyl)-, sodium salt (2:3); Glycine, N,N′-(1-hydroxy-1,2-ethanediyl)bis(N-(carboxymethyl)-, monosodium salt; Glycine, N,N′-1,2-ethanediylbis(N-(carboxymethyl)-, compd. with 2-aminoethanol (1:4); Glycine, N,N′-1,2-ethanediylbis(N-(carboxymethyl)-, tetrapotassium salt; Glycine, N,N-bsi(2-hydroxyethyl)-, sodium salt; Glycolic Acid; Glyophosate; GLYPHOSATE; Glyphosate (ANSI); Glyphosate ethanolamine salt; Glyphosate, ammonium salt; GLYPHOSATE, DIAMMONIUM SALT; GLYPHOSATE, DIMETHYLAMINE SALT; Glyphosate, isopropylamine salt; GLYPHOSATE, MONOAMMONIUM SALT; GLYPHOSATE, POTASSIUM SALT; Glyphosate, sesquisodium salt; Glyphosate-isopropylammonium; Glyphosine; GONADOTROPIN RELEASING HORMONE; Green alder bark shavings; Grotan; Ground corn cobs; GS-OMEGA/KAPPA-HXTX-HV1A (VERSITUDE PEPTIDE); GUAR GUM; Gum Resins; Gum Thus; Gypsum (Ca(SO4).2H2O); Hallcomid M-8-10; Halofenozide; Halosulfuron, MON 12000; HALOSULFURON-METHYL; Haloxyfop; Hardwood oil; Harmony; HARPIN PROTEIN; Harvade; HD-1 Protein as encoded by Bacillus thuringiensis subsp. kurstaki gene and produced in corn; Heavy aromatic naphtha; Heptachlor; Heptadecyl hydroxyethyl imidazoline; HEPTAMETHYLTRISILOXANE ETHOXYLATED; HEPTAMETHYLTRISILOXANE-1,3-PROPANEDIOL ETHER, ETHOXYLATED PROPOXYLATED; HEPTYL BUTYRATE; Hexachloroacetone; Hexachlorobenzene; Hexachlorocyclopentadiene; Hexaconazole; Hexadecanal; Hexaflumuron; HEXAHYDRO-1,3,5-TRIS (2-HYDROXYETHYL)-S-TRIAZINE; Hexahydro-1,3,5-tris(2-hydroxyethyl)-s-triazine; Hexamethyltetracosane; HEXANOIC ACID; Hexanoic acid, 2-ethyl-, copper salt; Hexazinone; HEXYLENE GLYCOL; HEXYTHIAZOX; Hi-Tor/Quanto; Hoelon, Diclofop-methyl; HOMOBRASSINOLIDE; Horticultural Oil; HPMTS; HUMIC ACID; Hyamine 2389; HYDRAMETHYLNON; Hydriodic acid; Hydrochloric acid; Hydrocortisone; Hydrocyanic acid; Hydrofluoric acid; Hydrogen chloride; Hydrogen cyanamide; Hydrogen cyanide; Hydrogen peroxide; Hydrogenated castor oil; Hydrolysate; Hydroprene; HYDROXYMETHYL-5,5-DIMWETHYL HYDANTOIN; Hymexazol; HYPOCHLOROUS ACID; IBA; Imazalil; IMAZALIL SULFATE; Imazalil sulphate; Imazamethabenz; Imazamox; IMAZAMOX, AMMONIUM SALT; Imazapic; Imazapic (includes Imazapic ammonium and Cadre); IMAZAPIC, AMMONIUM SALT; Imazapic-ammonium; Imazapyr; Imazapyr and Imazapyr salts; IMAZAPYR, ISOPROPYLAMINE SALT; Imazaquin; Imazethapyr; IMAZETHAPYR, AMMONIUM SALT; IMAZOSULFURON; Imidacloprid; Imiprothrin; INDAZIFLAM; Indian meal moth granulosis virus and larval parts on milled wheat bran carrier; INDOLE; Indole-3-acetic acid; Indole-3-butyric acid; Indoxacarb; Inorganic arsenicals (see Arsenic acid); Inorganic bromide; Iodine; Iodine, compd. with methyloxirane polymer with oxirane; Iodomethane; Iodosulfuran; IODOSULFURON-METHYL-SODIUM; Ipconazole; Iprodione; Iprovalicarb; IR-23, Bacillus thuringiensis subspecies tenebrionis delta endotoxin as produced in potato by an expression enhancer-CryIIIA fusion product and its controlling sequences and found in the following construct:PV-STBT05; Irgarol; IRON HEDTA; Iron oxide (Fe2O3); IRON PHOSPHATE; Isazofos; Isobornyl acetate; Isobornyl thiocyanoacetate; Isobutyl 2-methyl-4-chlorophenoxyacetate; Isobutyric acid; Isocil; ISODECYL ALCOHOL; Isofenphos; ISOFETAMID; Isooctyl 2-(2,4-dichlorophenoxy)propionate; ISOOCTYL PHTHALATE; Isooctyl(2-ethyl-4-methylpentyl) 2,4-dichlorophenoxyacetate; Isooctyl* silvex * 2-ethyl-4-methylpentyl; Isooctyl* silvex * 2-ethylhexyl; Isooctyl* silvex * 2-octyl; Isooctylphenoxypolyethoxyethanol; Isoparaffinic hydrocarbons; Isopropalin; Isopropanol; Isopropyl 2-methyl-4-chlorophenoxyacetate; Isopropyl acetate; ISOPROPYL ALCOHOL; Isopropyl lanolin; ISOPROPYL MYRISTATE; Isopropyl-2-cresol; ISOPROPYLAMINE DODECYLBENZENE SULFONATE; Isothymyl 2-chloroethyl ether; Isoxaben; Isoxaflutole; Jeffrey pine bark shavings; Jojoba oil; Juniper tar oil; KAOLIN; Kaolin clay; Karbutilate; KASUGAMYCIN HYDROCHLORIDE; Kerosene (petroleum) hydrodesulfurized; Kinoprene; Komeen; Kresoxim-methyl; Lactic acid; Lactofen; LACTOSE; Lambda-Cyhalothrin; LAMINARIN; Landrin; Lanolin; LAURIC ACID; Lauric diethanolamide; LAURYL ALCOHOL; LAURYL DIMETHYLAMINE OXIDE; LAURYL SULFATE; Lavandin oil; LAVANDULYL SENECIOATE; Lead acetate; Lead arsenate hydroxide (Pb5(AsO4)3(OH)); Leaves of Eucalyptus; Leaves of Pennyroyal (Mentha pulegium); Lecithin; Lemon peel oil; Lemongrass; Lemongrass oil; L-Glutamic acid; Lime sulfur; LIME-SULFUR; Limonene; Linalool; Lindane; Linseed oil; Linuron; Listeria specific Bacteriophages; Lithium (perfluorooctane)sulfonate; Lithium chloride; LITHIUM HYPOCHLORITE; Lithium stearate; Live Chlamydospores of Phytophthora palmivora MWV; L-Lactic acid; LOW MOLECULAR WEIGHT PARAFFINIC OIL; Lufenuron; Lysophosphatidylethanolamines, egg yolk; MAGNESIUM CHLORIDE; Magnesium dalapon (2,2-dichloropropionic acid); Magnesium lauryl sulfate; Magnesium oxide (MgO); Magnesium phosphide; Magnesium sulfate anhydrous; Malathion; Maleic hydrazide; Maleic hydrazide, potassium salt; Malic acid; Mancozeb; MANDESTROBIN; MANDIPROPAMID; Maneb; MANGANESE SULFATE; Manganese, dichlorotetrakis(N-propyl-N-(2-(2,4,6-trichlorophenoxy)ethyl)-1H-imidazole-1-carboxamide)-; Manganous benzothiazylmercaptide; Manganous dimethyldithiocarbamate; MARGOSA OIL; Maxim, Fludioxonil; MCPA; MCPA, 2-ETHYL HEXYL ESTER; MCPA, 2-ethylhexyl ester; MCPA, DIMETHYLAMINE SALT; MCPA, isooctyl ester; MCPA, sodium salt; MCPB; MCPB (and salts); MCPB, sodium salt; MCPP; MCPP, DIMETHYLAMINE SALT; MCPP-P; MCPP-P, 2-ethylhexyl ester; MCPP-P, DIMETHYLAMINE SALT; MCPP-P, DMA salt; MCPP-P, POTASSIUM SALT; m-Cresol; Meat meal; Mecoprop; Mecoprop-dimethylammonium; Mecoprop-isoctyl; MECOPROP-P; Mecoprop-potassium; Mecoprop-P-potassium; Mefenoxam; Mefenpyr-diethyl; MEFENTRIFLUCONAZOLE; Mefluidide; Mefluidide, diethanolamine salt; MENTHOL; Mepanipyrim; Mepiquat chloride; Mepiquat pentaborate; Merck 3535; Mercurate(1-), (acetato-O)amidophenyl-, hydrogen; Mercurate(1-), amidophenyl(propanoato-O)-, hydrogen; Mercuric chloride; Mercurous chloride; Mercury, (.mu.-(orthoborato(2-)-O:O′))diphenyldi-; Mercury, (2-hydroxypropanoato)phenyl-; Mercury, (9-octadecenoato-O)phenyl-, (Z)-; Mercury, (nitrato-O)phenyl-; Mercury, diphenyl(.mu.-((tetrapropenyl)butanedioato(2-)-O:O′))di-; Merphos; Mesosulfuron-methyl; Mesotrione; META-CRESOL; Metaflumizone; Metalaxyl; Metalaxyl-M; Metaldehyde; METALLIC SILVER; Metam-Potassium; Metam-sodium; Metasystox-R, Oxydemeton-methyl; Metconazole; Methamidophos; Methanaminium, 1-carboxy-N,N,N-trimethyl-, inner salt; Methanaminium, N-(4-((4-(dimethylamino)phenyl)phenylmethylene)-2,5-cyclohexadien-1-ylidene)-N-methyl-, chloride; Methane, iodo-; Methane, isothiocyanato-; Methanearsonic acid, monosodium salt (see MSMA); Methanesulfonamide, 1-chloro-N-(4,5-dichloro-2-(2,4,5-trichlorophenoxy)phenyl)-, sodium salt; Methanesulfonothioic acid, S-(2-hydroxypropyl) ester; Methanimidamide, N′-(4-chloro-o-tolyl)-N,N-dimethyl-, monohydrochloride; Methanol, (((1-methyl-2-(5-methyl-3-oxazolidinyl)ethoxy)methoxy)methoxy)-; Methazole; Methidathion; Methiocarb; Methomyl; Methoprene; Methoxychlor; METHOXYFENOZIDE; Methyl 2,3-dibromopropionate; Methyl 4-hydroxybenzoate; Methyl 9-hydroxyfluorene-9-carboxylate; Methyl acifluorfen; Methyl alcohol; Methyl alpha-eleostearate (methyl ester of (E,Z,E)-9,11,13-octadecatrienoic acid); Methyl anthranilate; Methyl bromide; Methyl bromide (NO INERT USE); Methyl bromide w/chloropicrin; Methyl chloroform; METHYL ESTERS OF COTTONSEED OIL; Methyl esters of fatty acids; Methyl esters of fatty acids (100% C8-C12); METHYL EUGENOL; Methyl isohexenyl ketone; Methyl isothiocyanate; METHYL MERCAPTAN; Methyl N-benzoyl-N-(3-chloro-4-fluorophenyl)-L-alaninate; Methyl nonyl ketone; Methyl parathion; METHYL SALICYLATE; METHYL SILICONE RESINS; METHYL-2,7-DICHLORO-9-HYDROXYFLUORENE-9-CARBOXYLATE; Methylammonium N-methyldithiocarbamate; METHYLATED FATTY ACIDS FROM CANOLA OIL; Methylated naphthalenes; METHYLATED SILICA; METHYLATED SOYBEAN OIL; Methyldodecylbenzyl trimethyl ammonium chloride 80% and methyldodecylxylylene bis(trimethyl ammonium chloride) 20%; Methylene bis(thiocyanate); Methylene blue; Methylene chloride; Methyleugenol; Metiram; Metobromuron; Metofluthrin; Metolachlor; METRAFENONE; Metribuzin; Metsulfuron; Metsulfuron-methyl; Mevinphos; Mexacarbate; MGK 264; MGK 326; MGK 326, Dipropyl isocinchomeronate; MGK R-11; Milbemectin (A mixture of >=70% Milbemcin A4, & <=30% Milbemycin A3); Milbemycin B, 5-O-demethyl-28-deoxy-6,28-epoxy-25-ethyl-,(6R,25R)-; Mineral Oil; Mineral oil—includes paraffin oil from 063503; Mineral spirits; Mint Herbs; Mint oil; Mirex; Modified Cry3A protein and the genetic material necessary for its production (via elements of pZM26) in Event MIR604 corn; MODIFIED PHTHALIC GLYCEROL ALKYD RESIN; Molinate; MOMFLUOROTHRIN; MON 21200 and MON 21250; MON 4660; Mono- and di-potassium salts of phosphorous acid; Monoammonium methanearsonate; Monoethanolamine 3,6-dichloro-o-anisate; Monosodium 2,2′-methylenebis(3,4,6-trichlorophenate); Monosodium phosphate; Monuron; Morestan; MORPHOLINE; Morpholine, 4,4′-(2-ethyl-2-nitro-1,3-propanediyl)bis-; MSMA; MSMA (and salts); MSMA/MAA; MSMA, calcium salt; Muscalure; Myclobutanil; Myrica cerifera, extract; MYRISTYL ALCOHOL; N-(2,4-Dimethyl-5-(((trifluoromethyl)sulfonyl)amino)phenyl)acetamide, potassium salt; N-(2,6-Dimethylphenyl)-N-(phenylacetyl)-DL-alanine, Methyl ester; N-(2-Cyanoethyl)-N′-alkyl*-1,3-diaminopropane*(100% C6-18); N-(2-Quinoxalinyl)sulfanilamide; N-(3-Chloro-4-methylphenyl)acetamide; N-(coco alkyl)trimethylenediamine; N-(Phenylmethyl)-9-(tetrahydro-2H-pyran-2-yl)-9H-p<BR>urin-6-amine; N,N-BIS-(2-(OMEGA-HYDROXYPOLY(OXYETHYLENE)/POLY(OXYPROPYLENE))ETHYL)ALKYL (C8-C18) AMINE N,N-BIS-(2-OMEGA-HYDROXYPOLY(OXYETHYLENE)ETHYL)ALKYLAMINE, ALKYL DERIVED FROM TALLOW FATTY ACIDS; N,N-BIS(3-AMINOPROPYL)LAURYLAMINE; N,N-Diallyl-2-chloroacetamide; N,N-Didecyl-N-methyl-3-(trimethoxysilyl)propanaminium chloride; N,N-Dimethyldecanamide (See Hallcomid M-8-10); N,N-DIMETHYL-N-[3-(TRIMETHOXYSILYL)PROPYL]-1-TETRADECANAMINIUM CHLORIDE; N,N-METHYLENEBISMORPHOLINE; N6-BENZYL ADENINE; NAA; NAA, AMMONIUM SALT; NAA, ETHYL ESTER; NAA, POTASSIUM SALT; NAA, SODIUM SALT; Nabam; Naled; n-Alkyl (68% C12, 32% C14) dimethyl dimethylbenzyl ammonium chloride; N-Alkyl* dimethyl benzyl ammonium chloride *(57% C12, 18% C14, 8% C16, 6% C10-C18, 5% C8); N-Alkyl*-N-ethyl morpholinium ethyl sulfate *(66% C18, 25% C16, 8% C18′,1% C14); N-Alkyl*-N-ethyl morpholinium ethyl sulfate *(92% C18, 8% C16); Naphthalene; Naphthalene, 1,4-dimethyl-; Naphthalene,2,6-bis(1-methylethyl)-; Naphthaleneacetic Acid, Its Salts, Ester, and Acetamide (case #0379); NAPHTHALENESULFONIC ACID, FORMALDEHYDE CONDENSATE, SODIUM SALT; Napropamide; Naptalam, sodium salt; NATAMYCIN; N-BUTYL-1,2-BENZISOTHIAZOLIN-3-ONE; N-Butylacetanilide; N-Cetyl-N-ethylmorpholinium ethyl sulfate; N-Chloroacetyl-N-(2,6-diethylphenyl)glycine, ethyl ester; N-CYCLOPROPYL-N′-(1,1-DIMETHYLETHYL)-6-(METHYLTHIO)-1,3,5-TRIAZINE-2,4-DIAMINE; N-DIALKYL (60% C14, 30% C16, 5% C12, 5% C18) METHYL BENZYL AMMONIUM CHLORIDE; Neburon; Neem; Neem oil; picrin, sialin, nimbolinin, nimbin, nimbidin, nimbidol, sodium nimbinate, gedunin, salannin, quercetin, azadiradione, fraxinellone, salannol, vepinin, vilasinin; Neodecanamide, N-methyl-; Neodecanoic acid, copper salt; Neodecanoic acid, zinc salt; Neomycin sulfate; Nepeta cataria oils; NEROLIDOL; NICARBAZIN; Nickel sulfate hexahydrate; Niclosamide; NICOSULFURON; Nicotine; Nicotine sulfate; Nicotinic acid; Nifluridide; NITHIAZINE; Nitrapyrin; Nitrilotriacetic acid, trisodium salt; Nitrobenzene; Nitrocellulose; Nitrofen; Nitrogen, Liquid; N-Lauryldiethylenetriamine; N-meta-Tolylphthalamic acid; N-METHYL-N-OLEOYLTAURINE, SODIUM SALT; Nobleite; N-OCTYL BICYCLOHEPTENE DICARBOXIMIDE; NONANOIC ACID; Nonanoic acid, sulfophenyl ester, sodium salt; NONYL PHENOXY POLYOXYETHYLENE ETHANOL-IODINE COMPLEX; Nonylphenoxypolyethoxyethanol; Nonylphenoxypolyethoxyethanol-iodine complex; Norea; Norflurazon; NOVALURON; Noviflumuron; n-Pentyl valerate; N-Polyethoxylated oleylamine; N-Polyoxyethylated stearylamine; n-Propyl isome; Nuarimol; NURANONE; O-(2-(Ethylthio)ethyl) 0,0-dimethyl phosphorothioate and S-(2-(ethylthio)ethyl) 0,0-dimethyl phosphorothioate; O-(2,5-Dichloro-4-(methylthio)phenyl) 0,0-diethyl phosphorothioate; O-(2-Chloro-1-(2,5-dichlorophenyl)vinyl) 0,0-diethyl phosphorothioate; O-(2-Chloro-4-nitrophenyl) 0,0-dimethyl phosphorothioate; 0,0,0,0-Tetrapropyl dithiopyrophosphate; O,O-Bis(p-chlorophenyl) acetimidoylphosphoroamidothioate; O,O-Diethyl O-(4-(methylsulfinyl)phenyl) phosphorothioate; O,O-Diethyl O-(and S-x2-(ethylthio)ethyl) phosphorothioate (mixed isomers); O,O-Diethyl O-2-pyrazinyl phosphorothioate; O,O-Dimethyl O-(1-isopropyl-5-chloro-1,2,4-triazol-3-yl) phosphorothioate; O,O-Dimethyl O-(p-sulfamoylphenyl) phosphorothioate; o-Benzyl-p-chlorophenol; OBPA; Octachloro-4,7-methanotetrahydroindane; Octadecanoic acid; OCTADECANOIC ACID, 12-HYDROXY-, HOMOPOLYMER, ESTER WITH ALPHA,ALPHA′,ALPHA″-1,2,3-PROPANETRIYLTRIS[OMEGA-HYDROXYPOLY(OXY-1,2-ETHANEDIYL)] (3:1); Octanoic acid, copper salt; Octanoic acid, ester with 1,2-propanediol; Octhilinone; Octyl decyl dimethyl ammonium chloride; Octylammonium methanearsonate; Octylphenol; O-Ethyl O-(p-nitrophenyl) phenylphosphonothioate; Oil of anise; OIL OF BLACK PEPPER; Oil of camphor sassafrassy; OIL OF CEDARWOOD; OIL OF CITRONELLA; Oil of citronella, Citronella; Oil of cloves; Oil of Eucalyptus; OIL OF GERANIUM; Oil of jasmine; OIL OF JOJOBA; Oil of lavender; OIL OF LEMON EUCALYPTUS; OIL OF LEMONGRASS; OIL OF NEPETA CATARIA; OIL OF ORANGE; Oil of Pennyroyal; OIL OF PEPPERMINT; Oil of rosemary; OIL OF SPEARMINT; Oils, black pepper; Oils, rue; Oils, tea-tree; OLEIC ACID; OLEIC ACID, ETHYL ESTER; OLEIC ACID, METHYL ESTER; Omadine-sodium; Omadine-zinc; o-Phenylphenol (NO INERT USE); o-Phenylphenol, potassium salt; o-Phenylphenol, sodium salt; Orange; Orange oil; ORGANO/MODIFIED POLYSILOXANE; Organochlorine; Organophosphate; Organophosphates; ORGANOSILICONE, POLY OXYALKYLENE ETHER COPOLYMER; Oriental mustard seed (Brassica juncea); ORTHO-BENZYL-PARA-CHLOROPHENOL; ORTHO-BENZYL-PARA-CHLOROPHENOL, POTASSIUM SALT; Orthodichlorobenzene; ORTHO-PHENYLPHENOL; Orthophenylphenol, o-Phenylphenol; ORTHO-PHENYLPHENOL, SODIUM SALT; ortho-Phthalaldehyde; ORTHOSULFAMURON; Oryzalin; Oust, Sulfometuron methyl; Ovex; Oxadiazon; Oxadixyl; Oxalic acid; Oxamyl; OXATHIAPIPROLIN; Oxazolidine-E; OXIRANE, 2-METHYL-, POLYMER WITH OXIRANE, MONO(2-ETHYLEHEXYL) ETHER; Oxirane, methyl-, polymer with oxirane, monobutyl ether, compd. with iodine; Oxycarboxin; Oxydemeton-methyl; OXYDIETHYLENE BIS (ALKYL DIMETHYL AMMONIUM CHLORIDE), ALKYL DERIVED FROM COCONUT OIL FATTY ACIDS; Oxydiethylenebis(alkyl* dimethyl ammonium chloride) *(as in fatty acids of coconut oil); Oxyethylated tert-Butylphenol; Oxyfluorfen; Oxypurinol; Oxytetracycline; OXYTETRACYCLINE HYDROCHLORIDE; OXYTETRACYCLINE, CALCIUM COMPLEX; Oxythioquinox; p-(Dimethylamino)benzenediazo sodium sulfonate; Paclobutrazol; p-Allylanisole; PALMITAMINE OXIDE; Paloja; Parachloroaniline; PARA-CHLORO-META-CRESOL; Paraclox; Paradichlorobenzene; PARA-DICHLOROBENZENE; Paraformaldehyde; Paranitrophenol; Paraquat; Paraquat dichloride; PARA-TERT-AMYLPHENOL; Parathion; Parinol; Pay-Off; p-Chloro-m-cresol, Parachlorometacresol; PCNB; Pebulate; Pelargonic acid Pendimethalin; PENFLUFEN; PENOXSULAM; Penoxulam; Pentac; Pentachloronitrobenzene; Pentachlorophenol; Pentachlorophenol, potassium salt; Pentachlorophenol, sodium salt; Pentachlorophenol, zinc salt; Pentane; Pentanoic acid, 3-hydroxy-4-(4-((5-(trifluoromethyl)-2-pyridinyl)oxy)phenoxy)-, methyl ester; Pentasodium diethylenetriaminepentaacetate; PENTHIOPYRAD; Peppermint; Peppermint oil; Perboric acid, (HBO(02)), sodium salt, monohydrate; Perchlorobenzene; Perfluidone; Periplanone B; Permethrin; Peroxyacetic acid; Petrolatum; PETROLEUM DISTILLATES; Petroleum resins; Petromyzonol sulfate; Phenmedipham; PHENOL; Phenol, 2-(((tributylstannyl)oxy)carbonyl)-4-(((tributylstannyl)oxy)sulfonyl)-; Phenol, 2-(1-methylpropyl)-4,6-dinitro-, sodium salt; Phenol, 2-(2-chloro-1-methoxyethoxy)-, methylcarbamate; Phenol, 2,2′-thiobis(4,6-dichloro-; Phenol, 2,2′-thiobis(4,6-dichloro-, disodium salt; Phenol, 2,2′-thiobis(4-chloro-; Phenol, 2,6-bis(1,1-dimethylethyl)-4-methyl-, methylcarbamate; Phenol, 2-methoxy-5-nitro-, sodium salt; Phenol, 2-methyl-4,6-dinitro-; Phenol, 3-(1-methylethyl)-, methylcarbamate; Phenol, 4-(1,1-dimethylethyl)-, potassium salt; Phenol, 4-chloro-2-cyclopentyl-, sodium salt; Phenol, 4-chloro-5-methyl-2-(1-methylethyl)-; Phenol, pentachloro-, compd. with (1R-(1.alpha.,4a.beta.,10a.alpha.))-1,2,3,4,4a,10,10a-octahydro-1,4-a-dimethyl-7-(1-methylethyl)-1-phenanthrenemethanamine (1:1); Phenolic—tung oil varnish; Phenothiazine; PHENOTHRIN; PHENYLETHYL PROPIONATE; Phenylmercuric 2-ethylhexanoate; Phenylmercuric acetate; Phenylmercuritriethanolammonium lactate; Phorate; Phosalone; Phosmet; Phosphamidon; Phosphine; Phospholipid; Phosphonic acid, bis(2-(2,4-dichlorophenoxy)ethyl) ester; Phosphoramidothioic acid, (1-methylethyl)-, O-(2,4-dichlorophenyl) O-methyl ester; Phosphoric acid; Phosphoric acid, bis(2-ethylhexyl) ester, compd. with 2,2′-(coco alkylimino)bis(ethanol); Phosphoric acid, dimethyl 1-methyl-3-(methylamino)-3-oxo-1-propenyl ester, (E)-; Phosphoric acid, dioctyl ester. compd. with 2,2′-(dodecylimino)bis(ethanol) (1:1); Phosphoric acid, disodium salt, dihydrate; Phosphoric acid, iron(3+) salt (1:1); PHOSPHORIC ACID, MONO (2-ETHYLHEXYL) ESTER; Phosphoric acid, mono(2-ethylhexyl) ester; Phosphoric acid, mono(2-ethylhexyl) ester, compds. with diethanolamine N-coco alkyl derivs. (1:1); Phosphoric acid, monooctyl ester, compd. with 2,2′-(dodecylimino)bis(ethanol) (1:1); PHOSPHORIC ACID, MONOPOTASSIUM SALT; Phosphorodithioic acid, O,O-diethyl S-((4-oxo-1,2,3-benzotriazin-3(4H)-yl)methyl) ester; Phosphorodithioic acid, O-ethyl O-(4-(methylthio)phenyl)S-propyl ester; Phosphorodithioic acid, S-(((4-chlorophenyl)thio)methyl) O,O-dimethyl ester; Phosphorothioic acid, O-(2-(1,1-dimethylethyl)-5-pyrimidinyl O,O diethyl ester; Phosphorothioic acid, O-(4-((dimethylamino)sulfonyl)phenyl) O,O-dimethyl ester; Phosphorothioic acid, O-(4-bromo-2,5-dichlorophenyl) O,O-dimethyl ester; Phosphorothioic acid, S-{(6-chloro-2-oxooxazolo(4,5-b}pyridin-3(2H)-yl}methyl} O,O-dimethyl ester; Phosphorotrithious acid, tributyl ester; Phosphorous acid; Phosphorus; Phostebupirim; Phytelene of marigold; PICARBUTRAZOX; Picaridin; Picloram; Picloram (005102); Picloram (005104); Picloram, picloram salts; Picloram, triisopropanolamine salt; Picloram-potassium; PICOXYSTROBIN; Pindone; Pindone, sodium salt; Pine oil; Pine tar; Pine tar oil; Pinene; PINOXADEN; PIPERALIN; Piperazine-carbon disulfide complex; Piperazine dihydrochloride; Piperidine, 2-propyl-, (S)-; PIPERINE; Piperonal bis(2-(2-butoxyethoxy)ethyl) acetal; Piperonyl butoxide; Pirimicarb; Pirimiphos-ethyl; Pirimiphos-methyl; Plant essences composition (Litsea-Pinus-Cinnamomum-Cymbopogon); Plant extract* (*Derived from Quercus falcata, Opuntia lindheimer, Rhus aromatica, and Rhizophoria mangle tissues); Plant pesticide Bacillus thuringiensis Cry1A(b) delta-endotoxin and the genetic material necessary for its production (plasmid Vector pCIB4431) in corn; Plant pesticide Bacillus thuringiensis CryA(b) delta-endotoxin and the genetic material necessary for its production (plasmid Vector pCIB4431) in corn; Plant-Incorporated-Protectants (PIPs); Plantvax; Plictran, Cyhexatin p-Menthane-3,8-diol POE isooctadecanol; Poly(hydroxyethylene(dimethyliminio)ethylene(dimethyliminio)methylene) dichloride; Poly(iminoimidocarbonyliminoimidocarbonyliminohexamethylene) hydrochloride; Poly(oxy(methyl-1,2-ethanediyl)), .alpha.-(1-oxo-2-(2,4,5-trichlorophenoxy)propyl)-.omega.-propoxy-; Poly(oxy(methyl-1,2-ethanediyl)), alpha-hydro-omega-hydroxy-; Poly(oxy-1,2-ethanediyl(dimethylimino)-1,2-ethanediyl(dimethylimino)-1,2-ethanediyl dichloride); Poly(oxy-1,2-ethanediyl), .alpha.-((1,1,3,3-tetramethylbutyl)phenyl) .omega.-hydroxy-; Poly(oxy-1,2-ethanediyl), .alpha.-(2-(4-morpholinyl)ethyl)-.omega.-hydroxy-; Poly(oxy-1,2-ethanediyl), .alpha.-(4-(1,1,3,3-tetramethylbutyl)phenyl)-.omega.-hydroxy-, compd. with iodine; Poly(oxy-1,2-ethanediyl), .alpha.-hydro-.omega.-hydroxy-, ester with 5(or 6)-carboxy-4-hexyl-2-cyclohexene-1-octanoic acid, compd. with iodine; Poly(oxy-1,2-ethanediyl), .alpha.-sulfo-.omega.-(dodecyloxy)-, sodium salt; Poly(oxy-1,2-ethanediyl), .alpha.-tridecyl-.omega.-hydroxy-, compd. with iodine; Poly(oxy-1,2-ethanediyl), alpha-hydro-omega-hydroxy-; POLY(OXY-1,2-ETHANEDIYL), ALPHA-HYDRO-OMEGA-HYDROXY-, MONO-C11-14-ISOALKYL ETHERS, C13-RICH, PHOSPHATES; POLY(OXY-1,2-ETHANEDIYL), ALPHA-ISODECYL-OMEGA-HYDROXY-PHOSPHATE, POTASSIUM SALT; Poly(oxy-1,2-ethanediyl),.alpha.,.alpha.′-((((1,2,3,4,4a,9,10,10a-octahydro-1,4a-dimethyl-7-(1-methylethyl)-1-phenanthrenyl)methyl)imino)di-2,1-ethanediyl)bis(.omega.-hydroxy-, (1R-(1-.alpha.,4a.beta.,10a.alpha.))-; POLY(OXY-1,2-ETHANEDIYL),ALPHA-2-PROPENYL-OMEGA-HYDROXY-; POLY(OXYETHYLENE) (DIMETHYLIMINO) ETHYLENE (DIMETHYLIMINO) ETHYLENE DICHLORIDE; POLY(OXYETHYLENE) POLY(OXYPROPYLENE) GLYCOL MONOALLYL ETHER; POLYACRYLAMIDE POLYMER; POLYACRYLAMIDE, POLYETHYLENE GLYCOL MIXTURE; POLYACRYLIC POLYMER; POLYALKENE OXIDE MODIFIED HEPTAMETHYL TRISILOXANE; POLYALKYLENEOXIDE MODIFIED POLYDIMETHYL-SILOXANE; Polyamidohygrostreptin; Polybromide form of trimethylbenzyl ammonium resin; Polybutene; POLYBUTENES; Polychlorinated terphenyls; Polychlorobicyclopentadiene isomers (Chlorine content 60/6-62% or 62%-64%); POLYETHER MODIFIED POLYSILOXANE; POLYETHOXY POLYPROPOXY POLYETHOXY ETHANOL-IODINE COMPLEX; POLYETHOXYLATED CASTOR OIL; Polyethoxypolypropoxypolyethoxyethanol-n-alkyl (54% C12, 18% C14, 9% C16, 9% C18, 5% C1O, 5% C8) di(beta-hydroxyethyl) benzyl ammonium chloride-iodine complex; Polyethylene; POLYETHYLENE GLYCOL; Polyethylene glycol distearate; POLYETHYLENE GLYCOL DITALLATE; POLYETHYLENE GLYCOL MONO(3-(TETRAMETHYL-1-(TRIMETHYLSILOXY)DISILOXANYL)PROPYL)ETHER; Polyethylene glycol monoesters of mixed fatty and rosin acids; POLYETHYLENE GLYCOL OLEATE; POLYETHYLENE GLYCOL STEARATE; POLYHEDRAL INCLUSION BODIES OF DOUGLAS FIR TUSSOCK MOTH NUCLEAR POLYHEDROSIS VIRUS; Polyhedral inclusion bodies of Douglas fir tussock moth nucleopolyhedrosis virus; Polyhedral inclusion bodies of gypsy moth nucleopolyhedrosis virus; Polyhedral inclusion bodies of n. sertifer; Polyhedral occlusion bodies (OBs) of the nuclear polyhedrosis virus of Autographa californica (alfalfa looper); Polyhedral occlusion bodies (OBs) of the nuclear polyhedrosis virus of Helicoverpa zea (corn earworm); POLYHEDRAL OCCLUSION BODIES (OB'S) OF THE NUCLEAR POLYHEDROSIS VIRUS OF Helicoverpa zea (CORN EARWORM); POLYHEDRAL OCCLUSION BODIES (OBS) OF THE NUCLEAR POLYHEDROSIS VIRUS OF Spodoptera exigua; Polyhedral occlusion bodies of the beet armyworm nuclear polyhedrosis virus; POLYHEXAMETHYLENE BIGUANIDINE; POLY-1-PARA-MENTHENE; Polyisobutylene; Polymeric betaine; POLYMERIC TERPENES; POLYMERIZED ACRYLIC ACID; POLYMERIZED PINENE; Polymerized resin acids; Polyoxin D zinc salt; POLYOXIN D, ZINC SALT; POLYOXYETHYLENE (6) TRIDECYL ALCOHOL; POLYOXYETHYLENE CETYL-STEARYL ETHER; Polyoxyethylene condensate with abietylamine; POLYOXYETHYLENE DIOLEATE; POLYOXYETHYLENE MIXED FATTY ACID ESTER; POLYOXYETHYLENE POLYOL FATTY ACID ESTERS; POLYOXYETHYLENE POLYOXYPROPYLENE; POLYOXYETHYLENE SORBITAN MIXED FATTY ACID ESTERS; POLYOXYETHYLENE SORBITAN MONOLAURATE; POLYOXYETHYLENE SORBITAN MONOOLEATE; POLYOXYETHYLENE SORBITAN TRIOLEATE; Polyoxyethylene sorbitol oleate-laurate; POLYOXYETHYLENE SORBITOL, MIXED ETHER ESTER; POLYOXYETHYLENE SOYBEAN OIL FATTY ACID ESTER; POLYOXYETHYLENE TALL OIL FATTY ACID ESTER; POLYPROPYLENE GLYCOL; POLYSACCHARIDE POLYMER; POLYSILOXANE; POLYSORBATE 65; POLYSTYRENE DIVINYL BENZENE QUATERNARY AMMONIUM ANION EXCHANGE RESIN WITH IODINE; POLYVINYL ALCOHOL; Polyvinylpyrrolidone; Polyxylenol tetrasulfide; POTASH SOAP; Potassium 1-naphthaleneacetate; Potassium 2,2′-methylenebis(3,4,6-trichlorophenate); Potassium 2,4,5-trichlorophenate; Potassium 2,4,6-trichlorophenate; Potassium 2,4-dichlorophenoxyacetate; Potassium 2-benzyl-4-chlorophenate; Potassium 2-chloro-4-phenylphenate; POTASSIUM BICARBONATE; Potassium bifluoride; Potassium bisulfate; Potassium bromide; POTASSIUM CARBONATE; Potassium chromate; POTASSIUM CITRATE; Potassium cresylate; Potassium cyanate; Potassium cyanide; Potassium dichloro-s-triazinetrione; Potassium dichromate (NO INERT USE); POTASSIUM DIMETHYL DITHIO CARBAMATE; Potassium dimethyldithiocarbamate; Potassium dodecylbenzenesulfonate; POTASSIUM ETHYL XANTHATE; Potassium ethylenediaminetetraacetate; Potassium fish oil soap; POTASSIUM HYDROXIDE; Potassium hydroxide (K(OH)); POTASSIUM HYPOCHLORITE; Potassium iodate; Potassium iodide; Potassium N-hydroxymethyl-N-methyldithiocarbamate; POTASSIUM NITRATE; POTASSIUM N-METHYLDITHIOCARBAMATE; Potassium oleate; oleic acid; Potassium laurate; potassium laureate; lauric acid; Dodecanoic acid; Potassium myristate; Myristic acid; Tetradecanoic acid; Potassium ricinoleate; Ricinoleic acid; Palmitic acid; Hexadecanoic acid; Stearic acid; stearidonic acid; Octadecanoic acid; Linoleic acid; Linolenic acid (ALA and GLA); Arachidonic acid; Eicosapentaenoic acid; Docosahexaenoic acid; Capric acid; Decanoic acid; Undecylic acid; Undecanoic acid; Tridecylic acid; Tridecanoic acid; Pentadecylic acid; Pentadecanoic acid; Margaric acid; Heptadecanoic acid; Potassium permanganate; Potassium peroxymonosulfate; Potassium persulfate; POTASSIUM PHOSPHATE, DIBASIC; Potassium phosphate, monobasic; Potassium phosphate, tribasic; POTASSIUM PHOSPHITE; Potassium polysulfide; POTASSIUM SALT OF HOP BETA ACIDS; Potassium Salts of Fatty acids; Potassium Salts of Fatty acids long-chain fatty acids (10-18 carbon atoms); Potassium Salts of Fatty acid potassium/coconut oil soap; Potassium Salts of Fatty acid potassium/animal fat oil soap; Potassium Salts of Fatty acid potassium/palm oil soap; Potassium Salts of Fatty acid potassium/olive oil soap; Potassium Salts of Fatty acid potassium/castor oil soap; Potassium Salts of Fatty acid potassium/cottonseed oil soap; Potassium Salts of Fatty acid potassium/palm kernel oil soap; Potassium Salts of Fatty acid potassium/wheat germ oil soap; Potassium Salts of Fatty acid potassium/soybean oil soap; Potassium Salts of Fatty acid potassium/corn oil soap; Potassium Salts of Fatty acid potassium/sunflower oil soap; Potassium Salts of Fatty acid potassium/safflower oil soap; Potassium Salts of Fatty acid potassium/hemp oil soap; Potassium Salts of Fatty acid potassium/canola/rapeseed oil soap; Potassium Salts of Fatty acids long-chain fatty acids (12-18 saturated carbons); Potassium Salts of Fatty acids long-chain fatty acids (12-18 saturated carbons); Potassium Salts of Fatty acids long-chain fatty acids (18 carbons with one or more double bonds (unsaturated)); Potassium salts of phosphorous acid; POTASSIUM SILICATE; POTASSIUM SORBATE; Potassium tetrathionate; Potassium thiosulfate; Potassium toluene sulfonate; Potassium triiodide; Potassium xylene sulfonate; p-Propenylanisole; PRALLETHRIN; Premicide; Prime Plus, Flumetralin; Primisulfuron-methyl; Primisulfuron-methyl, Beacon; Prochloraz; Procyanazine; Procymidone; Prodiamine; Profenofos; Profluralin; Prohexadione calcium; PROHEXADIONE-CALCIUM; Promalin; Prometon; Prometryn; Promexal X50; Pronamide; Propachlor; Propamocarb; Propamocarb hydrochloride; Propanal, 2,3-dibromo-; Propanil; Propanoic acid, 2-(2,4,5-trichlorophenoxy)-, compd. with N-methylmethanamine (1:1); Propanoic acid, 2-(2,4-dichlorophenoxy)-, 2-ethylhexyl ester; Propanoic acid, 2-(4-((3-chloro-5-(trifluoromethyl)-2-pyridinyl)oxy)phenoxy)-, methyl ester; Propanoic acid, 2,2-dichloro-, sodium salt; Propanoic acid, 2-methyl-, decyl ester; Propargite; Propazine; Propetamphos; PROPICONAZOLE; PROPIONIC ACID; Propionic acid, phenethyl ester; Propoxur; Propoxycarbazone-sodium; Propyl 4-hydroxybenzoate; Propyl alcohol; Propylene glycol; Propylene glycol isobutyl ether 2,4,5-trichlorophenoxyacetate; Propylene glycol monolaurate; PROPYLENE GLYCOL N-PROPYL ETHER; PROPYLENE GLYCOL, METHYL ETHER; Propylene oxide; PROPYLENEGLYCOL MONOLAURATE; PROPYZAMIDE; Prosulfuron; PROTHIOCONAZOLE; Proxel; p-tert-Amylphenol; p-tert-Amylphenol, potassium salt; p-tert-Amylphenol, sodium salt; p-tert-Butylphenol, sodium salt; PUTRESCENT WHOLE EGG SOLIDS; PYDIFLUMETOFEN; Pydrin, Asana, Fenvalerate; Pymetrozine; Pyraclostrobin; Pyraflufen-ethyl; Pyrasulfotole; Pyrazon; Pyrethrin coils; Pyrethrins; Pyrethroid; Pyrethrum flowers; Pyrethrum powder other than pyrethrins; Pyridaben; PYRIDALYL; Pyridate; Pyridine; Pyridine, 2-((1-(2,5-dimethylphenyl)ethyl)sulfonyl)-, 1-oxide; Pyridine, 2,3,5,6-tetrachloro-4-(methylsulfonyl)-; Pyridine, 4-chloro-, 1-oxide; PYRIDINE, 4-ETHENYL-, POLYMER WITH ALPHA-(2-METHYL-1-OXO-2-PROPEN-1-YL)-OMEGA-METHOXYPOLY(OXY-1,2-ETHANEDIYL), COMPOUNDED WITH 1-BROMOHEXANE; Pyridinium, 1-dodecyl-, salt with 5-chloro-2(3H)-benzothiazolethione (1:1); Pyridylmercuric acetate; PYRIFLUQUINAZON; Pyrimethanil; PYRIOFENONE; Pyriproxyfen; PYRITHIOBAC-SODIUM; PYROXASULFONE; Pyroxsulam; Pyroxyfur; QUILLAJA; QUINCLORAC; QUINCLORAC, DIMETHYLAMINE SALT; Quinclorac, Facet; Quinone; QUINOXYFEN; Quizalofop; Quizalofop-p-ethyl; Randox; RAPESEED METHYL ESTER; RED CABBAGE COLOR; Red pepper; Red squill; Reserpic acid methyl ester 3,4,5-trimethoxybenzoate (ester); Resins, oleo-, capsicum; Resmethrin; Reynoutria sachalinensis extract; Extract from the cotyledons of lupine plantlets (“BLAD”) C108, Rimsulfuron; Rizolex; Ro-Neet; Ronnel; Ronnell; Rosemary; Rosemary Herbs; ROSEMARY OIL; Rosin oil; Rotenone; Ryania Speciosa, powdered stems of; Ryanodine; S-(1,1-Dimethylethyl) O-ethyl ethylphosphonothioate; S-(2,3-Dichloroallyl) diisopropylthiocarbamate; S,S,S-TRIBUTYL PHOSPHOROTRITHIOATE; S-23031; Sabadilla alkaloids; S-ABSCISIC ACID; Safer Soap; SAFLUFENACIL; Salicylanilide; SALICYLIC ACID; Saponin; Sawdust; S-Bioallethrin; SDDC; sec-Butanol; sec-Butylamine; SEDAXANE; Sesame; SESAME OIL; Sesame plant, ground; Sethoxydim; SIDURON; SILICA AEROGEL; SILICA FILLED POLYDIMETHYLSILOXANE; Silica gel; Silicate(2-), hexafluoro-, aluminum sodium (4:1:5); Silicate(2-), hexafluoro-, magnesium (1:1); Silicon dioxide; SILICONE; SILICONE DEFOAMER; Silver; Silver (as elemental); Silver carbonate; Silver chloride; Silver copper zeolite; Silver fluoride; Silver nitrate; Silver oxide; Silver oxide (Ag4O4); Silver sodium hydrogen zirconium phosphate; Silver sodium hydrogen zirconium phosphate (Ag0.18Na0.57H0.25Zr2(PO4)3); Silver zinc zeolite; SILVER, IONIC; Silvex; Silvex*, 2-Butoxyethyl ester *(2-(2,4,5-trichlorophenoxy)propionic acid); Silvex*, Diethanolamine salt *(2-(2,4,5-trichlorophenoxy)propionic acid); Silvex*, Potassium salt *(2-(2,4,5-trichlorophenoxy)propionic acid); Silvex*, Triethanolamine salt *(2-(2,4,5-trichlorophenoxy)propionic acid); Silvex*, Triethylamine salt *(2-(2,4,5-trichlorophenoxy)propionic acid); Simazine; Sinesto B; s-Methoprene; s-Metolachlor; SOAP; Soap salts; Sodium 1-naphthaleneacetate; Sodium 2-(2,4-dichlorophenoxy)ethyl sulfate; Sodium 2,2′-methylenebis(4,6-dichlorophenate); Sodium 2,2′-methylenebis(4-chlorophenate); Sodium 2,4,5-trichlorophenate; Sodium 2-benzyl-4-chlorophenate; Sodium 2-chlorophenate; Sodium 3-amino-2,5-dichlorobenzoate; Sodium 4-(2,4-dichlorophenoxy)butyrate; Sodium 4,6-dinitro-o-cresylate Sodium 5-chloro-2-(4-chloro-2-(3-(3,4-dichlorophenyl)ureido)phenoxy)benzenesulfonate; Sodium acifluorfen; SODIUM ALPHA-OLEFIN (C14-C16) SULFONATE; Sodium arsenate; Sodium arsenite; Sodium azide; Sodium bentazon; SODIUM BENZOATE; SODIUM BICARBONATE; SODIUM BISULFATE; Sodium bisulfite (NaHSO3); Sodium bromide; SODIUM BROMOSULFAMATE, SODIUM CHLOROSULFAMATE, POTASSIUM BROMOSULFAMATE, POTASSIUM CHLOROSULFAMATE; Sodium carbonate; SODIUM CARBONATE PEROXYHYDRATE; Sodium chlorate; Sodium chloride; Sodium chlorite; Sodium chromate; SODIUM CYANIDE; SODIUM DECYL SULFATE; Sodium decylbenzene sulfonate; Sodium diacetate; Sodium dichloroisocyanurate dihydrate; Sodium dichloro-s-triazinetrione; SODIUM DICHLORO-S-TRIAZINETRIONE DIHYDRATE; Sodium dichromate (NO INERT USE); SODIUM DIHYDROGEN PHOSPHATE; SODIUM DIISOOCTYLSULFOSUCCINATE; SODIUM DIMETHYL DITHIO CARBAMATE; Sodium dimethyldithiocarbamate; SODIUM DIOCTYLSULFOSUCCINATE; SODIUM DODECYLBENZENE SULFONATE; Sodium dodecylbenzene sulfonic acid; Sodium dodecylbenzenesulfonate; Sodium ferric ethylenediaminetetraacetate; Sodium fluoride; Sodium fluoroacetate; Sodium fluosilicate; Sodium glycolate; Sodium hexametaphosphate; Sodium hydrogen sulfate; SODIUM HYDROXIDE; SODIUM HYDROXYMETHYLGLYCINATE; Sodium hypochlorite; Sodium laurate; SODIUM LAUROAMPHO ACETATE; SODIUM LAURYL ETHER SULFATE; Sodium lauryl sulfate; Sodium lauryl sulfate (as an inert); SODIUM METABISULFITE; Sodium metaborate tetrahydrate; Sodium metasilicate; Sodium methylundecyl benzenesulfonate; Sodium mono and dimethyl naphthalene sulfonate; SODIUM N-CYCLOHEXYL-N-PALMITOYL TAURATE-IODINE COMPLEX; SODIUM NITRATE; Sodium nitrite; Sodium N-lauroylsarcosinate; Sodium N-methyl-N-oleoyltaurate; SODIUM NONYLPHENYL POLYOXYETHYLENE SULFATE (4-5 MOLES); Sodium octylbenzene sulfonate; Sodium oleate; Sodium o-nitrophenolate; Sodium ortho phenyl phenate; SODIUM PARA-TERT-AMYLPHENATE; Sodium p-chloro-m-cresolate; Sodium percarbonate; SODIUM PERSULFATE; Sodium petroleum sulfonate; SODIUM PHENATE; Sodium p-nitrophenolate; SODIUM POLYACRYLATE; Sodium polysulfide; Sodium propionate; SODIUM PYRITHIONE; Sodium salt of fomesafen; Sodium sesquicarbonate; Sodium silicate; Sodium silver thiosulfate; Sodium sulfate; SODIUM TETRABORATE (PENTAHYDRATE); Sodium tetrahydro-3,5-dimethyl-2H-1,3,5-thiadiazine-2-thione; Sodium tetrathiocarbonate; Sodium thiocyanate; Sodium thiosulfate; Sodium toluene sulfonate; Sodium trichloroacetate; SODIUM TRIPOLYPHOSPHATE; SODIUM XYLENE SULFONATE; Sodium xylenesulfonate; Sorbic acid; Sorbic acid, potassium salt; SORBITAN FATTY ACID ESTERS; SORBITAN MONOOLEATE; SORBITAN TRIOLEATE; SORBITOL; Sorbitol octanoate; Soy Hydrolysate; SOYBEAN OIL; SPHAGNUM MOSS; Spinetoram; Spinosad; Spiro(isobenzofuran-1(3H),9′-(9H)xanthen)-3-one, 3′,6′-dihydroxy-, disodium salt; Spirodiclofen; SPIROMESIFEN; SPIROTETRAMAT; Spiroxamine; Sporicidin; Stabilene; Stannane, (acetyloxy)tributyl-; Stannane, tributyl((1-oxo-9,12-octadecadienyl)oxy)-, (Z,Z)-; Stannane, tributyl((1-oxoneodecyl)oxy)-; Stannane, tributyl((2-((tributylstannyl)oxy)benzoyl)oxy)-; Stannane, tributyl(2-methyl-1-oxo-2-propenyl)oxy-; Stannane, tributylfluoro-; Starlicide; Stibine, ((2-ethyl-1-oxohexyl)oxy)diphenyl-; Stirrup-M; Stoddard solvent; Streptomycin; Streptomycin sulfate; s-Triazinetriol; Strychnidin-10-one, sulfate (2:1); Strychnine; STYRENE BUTADIENE COPOLYMER; Sucrose; Sucrose octanoate; SUGAR; Sulfacetamide; Sulfamic acid; Sulfamic acid, chloro-, monosodium salt; Sulfentrazone; Sulfluramid; Sulfometuron; SULFOMETURON-METHYL; Sulfonated cresol; Sulfonated oleic acid, sodium salt; Sulfone, diiodomethyl p-tolyl; Sulfonic acids; Sulfonic acids, C14-16-alkane hydroxy and C14-16-alkene, sodium salts; Sulfosate; Sulfosulfuron; Sulfotepp; SULFOXAFLOR; SULFUR; Sulfur dioxide; Sulfuric acid; Sulfuric acid, monooctyl ester, compd. with iodine and 2,2′,2″-nitrilotris(ethanol); Sulfurous acid, sodium salt; SULFURYL FLUORIDE; Sumithrin; Suttocide A; Swinglea glutinosa EXTRACT; TALL OIL; TALL OIL FATTY ACIDS; Tall oil fatty acids, potassium salts; TALLOW BIS(2-HYDROXYETHYL)AMINE; TAMARIND SEED GUM; Tannic acid; Tar; TARTRAZINE; TAU-FLUVALINATE; TBTO, Tributyltin oxide; TCA; TCMTB; TEA TREE OIL; Teatree; Teatree oil; Tebuconazole; Tebufenozide; Tebufenpyrad; Tebuthiuron; Tefluthrin; Tektamer 38; Telone; TEMBOTRIONE; Temephos; Tepraloxydim; Terbacil; Terbufos; Terbuthylazine; Terbutryn; Terephthalic acid, compd. with dodecylguanidine (1:2); Terpineols (unspec.); Terrazole; tert-Alkyl* amine *(100% C18-C22); tert-Butanol; tert-Butyl dimethyltrithioperoxycarbamate; tert-Butyl hydroperoxide; Tertiary butylamine pyridinethiol-1-oxide; TETRA ETHYLENE PENTAMINE; TETRAACETYLETHYLENEDIAMINE; Tetrachloroethylene; Tetrachlorophenols; Tetrachlorophenols, alkyl* amine salt *(as in fatty acids of coconut oil); Tetrachlorophenols, potassium salt; Tetrachlorophenols, sodium salt; Tetrachlorvinphos; Tetraconazole; Tetradecanoic acid, compd. with 2,2′iminobis(ethanol) and iodine; TETRADECYL DIMETHYL BETAINE; TETRADECYLBENZENESULFONIC ACID; Tetradifon; Tetraethyl pyrophosphate; Tetraglycine hydroperiodide; Tetrahydroabietylamine acetate; Tetraiodoethylene; TETRAKIS (HYDROXYMETHYL) PHOSPHONIUM SULFATE; Tetrakis 129058; Tetrakis(hydroxymethyl)phosphonium sulphate (THPS); Tetralin; Tetramethrin; TETRAPOTASSIUM PYROPHOSPHATE; Tetrasodium EDTA; Tetrasodium pyrophosphate; TFM; Thiabendazole; Thiabendazole hypophosphite; THIABENDAZOLE, HYPOPHOSPHITE SALT; Thiacloprid; Thiafluamide; Thiamethoxam; Thiazopyr; Thidiazuron; THIENCARBAZONE-METHYL; Thifensulfuron; Thiobencarb; Thiocyanic acid, 1-chloro-1,2-ethanediyl ester; Thiocyanic acid, oxydi-2,1-ethanediyl ester; Thiocyclam hydrogen oxalate; Thiodicarb; Thioimidodicarbonic diamide ((H2N)C(S))2NH; Thioperoxydicarbonic acid ((HO)C(S))2S2), diethyl ester; Thiophanate; Thiophanate-methyl; Thiophene, 3,3,4,44-tetrachlorotetrahydro-, 1,1-dioxide; Thiophene, 5-(4-chlorophenyl)-2,3-diphenyl-; Thiophene, tetrachloro-; Thiourea, monosilver(1+) salt, polymer with 2-propenoic acid; Thiram; Thuringiensin; Thyme; Thyme Herbs; THYME OIL; Thymol; Tilt, Propiconazole; Tobacco Dust; Tolclofos-methyl; TOLFENPYRAD; Toluene; Toluene sulfonic acid; Topramezone; Toxaphene (Technical chlorinated camphene (67-69% chlorine)); TPTH; Tralkoxydim; Tralomethrin; TRALOPYRIL; trans-1,2-Bis(propylsulfonyl)ethylene; Triadimefon; Triadimenol; Triallate; Triasulfuron; Triazamate; triazole fungicide; Triazole metabolites; Triazolyl acetic acid (A metabolite); Triazolylpyruvate; TRIBENURON-METHYL; Tribufos; Tributyl (2,4-dichlorobenzyl) phosphonium chloride; TRIBUTYL TETRADECYL PHOSPHONIUM CHLORIDE; Tributyltin acrylate; Tributyltin benzoate; Tributyltin chloride; Tributyltin chloride complex of ethylene oxide condensate of abietylamine; Tributyltin maleate; Tributyltin methacrylate; Tributyltin methacrylate co-methacrylate polymer; Tributyltin oxide; Tributyltin resinate; Trichlorfon; Trichloroacetic acid; Trichlorobenzyl chloride; Trichloroethylene; Trichlorofluoromethane; Trichloromelamine; Trichloro-s-triazinetrione; Triclopyr; Triclopyr Buthoxyethyl Ester (BEE); TRICLOPYR CHOLINE; TRICLOPYR, BUTOXYETHYL ESTER; Triclopyr, triethylamine salt; Triclosan; Triclosan, Irgasan; Tricyclazole; Tridecenyl acetates; Tridiphane; TRIETHANOLAMINE; Triethanolamine 2-(2,4-dichlorophenoxy)propionate; Triethanolamine dinoseb (2-sec-Butyl-4,6-dinitrophenol); Triethanolamine dodecylbenzenesulfonate; Triethanolamine dodecylbenzenesulfonate (Data Submitter Rights); Triethanolamine laurate; Triethanolamine lauryl sulfate; Triethanolamine myristate; TRIETHANOLAMINE OLEATE; Triethanolamine sulfonate tridecylpolyoxyethyleneethanol-bromine complex; Triethylene glycol; Trifloxystrobin; TRIFLOXYSULFURON-SODIUM; Triflumizole; Trifluralin; TRIFLUSULFURON-METHYL; Triforine; Triisopropylamine; Trimethacarb; Trimethoxysilyl quats; TRIMAETHYLAMINE; Tri-n-butyl tetradecyl phosphonium chloride; TRINEXAPAC-ETHYL; Triphenyltin fluoride; Tripotassium ethylenediaminetetraacetate; Tripropyltin methacrylate; TRIPTOLIDE; Tris(2-hydroxypropyl)amine; Trisodium (2-hydroxyethyl)ethylenediaminetriacetate; Trisodium phosphate; Triticonazole; Troysan KK-108A; Trypsin Modulating Oostatic Factor (TMOF); Turkey red oil; Turkey red oil, sodium salt; Turpentine; UNDECYLENIC ACID; Uniconazole; UNICONIZOLE-P; Urea; UREA DIHYDROGEN SULFATE; UREA INCLUSION ADDUCT OF POLYOXY(ETHYLENE)/POLYOXY(PROPYLENE) BLOCK COPOLYMER; Urea, N-((4-chlorophenyl)methyl)-N-cyclopentyl-N′-phenyl-; Urea, N-(1,3-bis(hydroxymethyl)-2,5-dioxo-4-imidazolidinyl)-N,N′-bis(hydroxymethyl)-; Urea, N′-(4-((3,4-dihydro-2-methoxy-2,4,4-trimethyl-2H-1-benzopyran-7-yl)oxy)phenyl)-N-methoxy-N-methyl-; Urea, N-(5-(ethylsulfonyl)-1,3,4-thiadiazol-2-yl)-N,N′-dimethyl-; Urea, sulfate (1:1); Vancide TH; VEGETABLE OIL; Vegetable wax; Vendex; Verbenone; Vermicasts; Vernam; Vernolate; Vikane, Sulfuryl fluoride; Vinclozolin; Vinegar; VINYL ESTER POLYMER; VINYL POLYMER; Vinylene bisthiocyanate; Vitamin D2; Vorlex; Warfarin; Warfarin, sodium salt; Wheat germ agglutinin; with 2-methyl-4-isothazolin-3-one calcium chloride; Xanthan gum; Xanthine; Xylene; Xylene range aromatic solvent; Xylenol (unspec. or mixed from 086804); Xylitol; YEAST; YEAST EXTRACT HYDROLYSATE FROM Saccharomyces cerevisiae; Yellow mustard seed (Brassica hirta); Yucca schidigera; Z,E-9,12-TETRADECADIEN-1-YL ACETATE; Z-11-TETRADECEN-1-YL ACETATE; Z-7-TETRADECEN-2-ONE; Z-8-DODECENOL; Z-8-DODECENYL ACETATE; ZETA-CYPERMETHRIN; Zinc; ZINC 2-PYRIDINETHIOL-1-OXIDE; Zinc Borate; Zinc borate (3ZnO, 2B03, 3.5H2O; mw 434.66); Zinc chloride; Zinc dimethyldithiocarbamate-cyclohexylamine complex; Zinc ethylenebis(dithiocarbamate); Zinc fluosilicate; Zinc naphthanate; Zinc naphthenate; Zinc oxide; Zinc phenol sulfonate; Zinc phosphide; Zinc phosphide (Zn3P2); Zinc pyrithione; Zinc silicate; Zinc stearate; ZINC SULFATE; Zinc sulfate monohydrate; Zinc sulfate, basic; Zineb; Zinophos; Ziram; Zirconium oxide (ZrO2); and ZOXAMIDE.

In some embodiments, the nutrient may include acidulated fish tankage, activated sewage product, alfalfa meal, ammonium citrate, ammoniated calcium nitrate, ammonium calcium nitrate double salt, ammoniated superphosphate, ammonium oxalate, ammonium phosphate, ammonium phosphite, ammonium polysulfide, ammonium sulfate nitrate, ammonium thiosulfate, anhydrous ammonia, aqua ammonia, bat guano, brewers grain, brewers yeast, calcium ammonium nitrate, corn gluten meal, corn steep liquor, cottonseed meal, dicyandiamide, dimethylenetriurea, distillers grain, dried blood, ferric ammonium sulfate, feather meal, ferrous ammonium sulfate, dry fish tankage, dry fish scrap, dry ground fish, dry fish meal, dry fish emulsion, dry garbage tankage, hoof meal, horn meal, isobutylidene diurea, kapok seed meal, melamine, methylene urea, methylenediurea, nitrophosphate, oilseed meal, oxamide, polymer coated urea, sheep manure, wool waste, soybean meal, sulfur coated urea, triazone, urea phosphite, ureaform fertilizer material, urea-formaldehyde product, urea-triazone solution, wheat middling, and combinations thereof.

In some embodiments, the nutrient may include acidulated bone, ammonium phosphate sulfate, ammonium polyphosphate, basic lime phosphate, basic phosphate slag, bone meal, calcined phosphate, calcium metaphosphate, citrate soluble phosphate, dicalcium phosphate, dried whey sludge, ground raw bone, hydroxylapatite, magnesium ammonium phosphate, magnesium potassium phosphate, monoammonium phosphate, phosphate rock, polyphosphate, orthophosphate, pyrophosphate, tripolyphosphate, tetrapolyphosphate, potassium polyphosphate, precipitated phosphate, soft phosphate with colloidal clay, superphosphate, superphosphoric acid, urea phosphate, ammonium metaphosphate, ammonium phosphate-nitrate, spent bone black, phosphatic limestone, magnesium phosphate, nitric phosphate, superphosphate enriched, potassium phosphate, monopotassium phosphite, phosphite, sodium phosphite pentahydrate, hydrogenphosphonate, organic esters of hydrogen phosphite, pyrophosphite, inorganic phosphite, phosphite (Phi; H2PO3-), phosphorous acid, potassium phosphite, fosetyl-A1, calcium phosphite, and combinations thereof.

In some embodiments, the nutrient may include double sulfate of potash and magnesia, greensand, kainit, kelp, laminariales, phaeophyceae, potassium acetate, potassium citrate, monopotassium citrate, potassium hydrogen phosphate dihydrate, potassium hydroxide, dipotassium phosphite, potassium sulphite, potassium thiosulfate, potassium metaphosphate, metaphosphoric acid, sulfate of potash-magnesia, tobacco stem, and combinations thereof.

In some embodiments, the nutrient may include calcium thiosulfate, calcium oxide, magnesium oxide, magnesium nitrate hexahydrate, magnesium thiosulfate, sodium tetraborate, potassium tetraborate, sodium borate, potassium borate, calcium borate, dipotassium octaborate, anhydrous disodium octaborate, sodium pentaborate, cobalt, cobalt sulfate, copper (I) oxide, copper (II) oxide, anhydrous copper (II) sulfate, copper (II) chelate of ethylenediaminetetraacetic acid, iron (III) nitrate, iron (III) sulfate, iron citrate, iron (III) chelate of ethylenediaminetetraacetic acid, ferrous citrate, manganese (II) nitrate, manganese (II) sulfate, manganese (II) chelate of ethylenediaminetetraacetic acid, ammonium molybdate, ammonium molybdenum, zinc chelate of ethylenediaminetetraacetic acid, zinc oxide, alignate, Ascophyllum nodosum, brown algae, chitin, corn steep liquor powder, chitosan, vermicompost extract, worm castings, and combinations thereof.

In some embodiments, the nutrient may include one of a hydrolysate, a hydrolyzed extract, a digestate, a digested extract, a fermentation, and a fermented extract selected from the group of alfalfa, blood, bone, bonito fish, brewers grain, canola, cod fish, corn, cottonseed, distillers grain, feather, fish, garbage, hoof, horn, kapok, kelp, mackerel fish, manure, meat, oilseed, rapeseed, sardine fish, sewage, soy, soy protein concentrate, soy protein isolate, cruciferin, napin, tobacco stem, wheat middling, whey, white fish, wool waste, zean, and combinations thereof.

In some embodiments, the biostimulant may include GA1, GA3, GA4, GA7, Vitamin B, fulvic acid, humate, humic acid, a humic substance, humin, humus, leonardite, Fenneliformis spp., Gibberella spp., Gigaspora spp., Glomus spp., Laccaria spp., Paraglomus spp., Pisolithus spp., Rhizoglomus spp., Rhizophagus spp., Rhizopogon spp., Scleroderma spp., Suillus spp., Azospirillum spp., Azotobacter spp., Bradyrhizobium spp., Burkholderia spp., Geobacillus spp., Gluconacetobacter spp., Herbaspirillum spp., Lactobacillus spp., Lactococcus spp., Mesorhizobium spp., Mycobacterium spp., Paenibacillus spp., Pantoea spp., Pseudomonas spp., Rhizobium spp., Rhodopseudomonas spp., Streptomyces spp., Bacillus amyloliquefaciens, Bacillus azotoformans, Bacillus cereus, Bacillus coagulans, Bacillus flexus, Bacillus licheniformis, Bacillus megaterium, Bacillus pasteurii, Bacillus polymyxa, Bacillus pumilus, Bacillus safensis, Bacillus subtilis subsp. Inaquosorum, Bacillus subtilis subsp. Spizizenii, Bacillus subtilis subsp. Subtilis, Bacillus subtilis FZB24, Bacillus thuringiensis Btk ATCC 33679, Bacillus thuringiensis Btk HD73, Bacillus velezensis, Trichoderma afroharzianum, Trichoderma alboviride, Trichoderma anaharzianum, Trichoderma anisohamatum, Trichoderma asperellum, Trichoderma atroviride, Trichoderma aureoviride, Trichoderma brunneoviride, Trichoderma caeruleoviride, Trichoderma citrinoviride, Trichoderma gamsii, Trichoderma hamatum, Trichoderma harzianum, Trichoderma inhamatum, Trichoderma koningii, Trichoderma longibrachiatum, Trichoderma nigrovirens, Trichoderma paratroviride, Trichoderma paraviride, Trichoderma paraviridescens, Trichoderma perviride, Trichoderma polysporum, Trichoderma pseudonigrovirens, Trichoderma reesei, Trichoderma subviride, Trichoderma virens, Trichoderma viride, Trichoderma viridescens, Trichoderma zeloharzianum, and combinations thereof.

In some embodiments, the biostimulant may include Trichoderma asperellum strain ICC 012, Trichoderma asperellum strain T-34, Trichoderma atroviride strain SC1, Trichoderma gamsii strain ICC 080, Trichoderma hamatum strain TH382, Trichoderma harzianum Rifai strain T22, Trichoderma harzianum Rifai strain T-39, Trichoderma harzianum Rifai strain Ths97, Trichoderma harzianum Rifai strain IBT 9385 [T3], Trichoderma harzianum Rifai strain T334, Trichoderma harzianum Rifai strain KRL-AG2, Trichoderma harzianum Rifai strain (L04), Trichoderma harzianum Rifai strain Th-R16, Trichoderma harzianum Rifai strain T-78, Trichoderma polysporum strain ATCC 20475, Trichoderma reesei strain Rut-C30, Trichoderma reesei strain RL-P37, Trichoderma reesei strain QM6a, Trichoderma reesei strain MCG-80, Trichoderma reesei strain 1391A, Trichoderma reesei strain P59G, Trichoderma reesei strain P210A, Trichoderma reesei strain P345A, Trichoderma virens strain G-41, Trichoderma virens strain GL-21, Trichoderma virens strain T-1, Trichoderma virens strain R42, Trichoderma viride strain ATCC 20476, Trichoderma viride sensu Bisby, and combinations thereof.

In some embodiments, the pesticide may include diatomaceous earth, ethyl alcohol, neem oil, clarified hydrophobic extract of neem oil, picrin, sialin, nimbolinin, nimbin, nimbidin, nimbidol, sodium nimbinate, gedunin, salannin, quercetin, azadiradione, fraxinellone, salannol, vepinin, vilasinin, extract of Swinglea glutinosa, extract of Reynoutria sachalinensis, extract from the cotyledons of lupine plantlets C108, 2-phenethyl propionate, potassium laurate, potassium laureate, lauric acid, dodecanoic acid, potassium myristate, myristic acid, tetradecanoic acid, potassium ricinoleate, ricinoleic acid, palmitic acid, hexadecanoic acid, stearic acid, stearidonic acid, octadecanoic acid, linoleic acid, linolenic acid ALA, linolenic acid GLA, arachidonic acid, eicosapentaenoic acid, docosahexaenoic acid, capric acid, decanoic acid, undecylic acid, undecanoic acid, tridecylic acid, tridecanoic acid, pentadecylic acid, pentadecanoic acid, margaric acid, heptadecanoic acid, potassium salts of fatty acids, and combinations thereof.

In some embodiments, the pesticide may include potassium salts of fatty acids including long-chain fatty acids of 10 to 18 carbon atoms, long-chain fatty acids of 12 to 18 saturated carbons, long-chain fatty acids of 18 carbons with one or more double bonds unsaturated, potassium-coconut oil soap, potassium-animal fat oil soap, potassium-palm oil soap, potassium-olive oil soap, potassium-castor oil soap, potassium-cottonseed oil soap, potassium-palm kernel oil soap, potassium-wheat germ oil soap, potassium-soybean oil soap, potassium-corn oil soap, potassium potassium-sunflower oil soap, potassium-safflower oil soap, potassium-hemp oil soap, potassium-canola oil soap, potassium-rapeseed oil soap, and combinations thereof.

In some embodiments, the pesticide may include Bacillus firmus strain 1582 spores, Bacillus firmus strain I-1582, Bacillus lentimorbus, Bacillus mycoides, Bacillus sphaericus 2362 serotype H5a5b strain Abts 1743 fermentation solids, Bacillus sphaericus 2362 serotype H5a5b strain Abts 1743 insecticidal toxins, Bacillus sphaericus 2362 serotype H5a5b strain Abts 1743 spores, Bacillus subtilis strain GB03, Bacillus subtilis strain IAB/BS03, Bacillus subtilis strain MBI 600, Bacillus subtilis strain QST 713, Bacillus subtilis var. Amyloliquefaciens strain FZB24, Bacillus thuringiensis Aizawai, Bacillus thuringiensis Aizawai Cry1F protein, Bacillus thuringiensis Aizawai GC-91 protein, Bacillus thuringiensis Cry1F protein, Bacillus thuringiensis Cry1A.105 protein, Bacillus thuringiensis Cry1Ab protein, Bacillus thuringiensis Cry1F protein, Bacillus thuringiensis Cry2Ab protein, Bacillus thuringiensis Cry2Ab2 protein, Bacillus thuringiensis Cry34Ab1 protein, Bacillus thuringiensis Cry35Ab1 protein, Bacillus thuringiensis Cry3B1 protein, Bacillus thuringiensis Cry3Bb protein, Bacillus thuringiensis Cry3Bb1 protein, Bacillus thuringiensis CryIA(b) delta-endotoxin, Bacillus thuringiensis Cry1A(c) delta-endotoxin, Bacillus thuringiensis CryiC delta-endotoxin, Bacillus thuringiensis Galleriae strain SDS-502 fermentation solids, Bacillus thuringiensis Galleriae strain SDS-502 insecticidal toxins, Bacillus thuringiensis Galleriae strain SDS-502 spores, Bacillus thuringiensis Israelensis, Bacillus thuringiensis Israelensis strain BMP 144 insecticidal toxins, Bacillus thuringiensis Israelensis strain BMP 144 solids, Bacillus thuringiensis Israelensis strain BMP 144 spores, Bacillus thuringiensis kurstaki, Bacillus thuringiensis kurstaki (Btk)—DiPel DF, Bacillus thuringiensis kurstaki Cry1Ac protein, Bacillus thuringiensis kurstaki CryIA (c) delta-endotoxin, Bacillus thuringiensis kurstaki delta endotoxin encapsulated in killed Pseudomonas fluorescens, Bacillus thuringiensis kurstaki delta endotoxin protein as produced by the Cry1A(c) gene, Bacillus thuringiensis kurstaki delta endotoxin protein as produced by the CryIIA gene, Bacillus thuringiensis kurstaki delta-endotoxin as produced by an HD-1 gene, Bacillus thuringiensis kurstaki strain EG7673 Coleopteran active toxin, Bacillus thuringiensis kurstaki strain EG7673 Lepidopteran active toxin, Bacillus thuringiensis kurstaki strain EG7841 Lepidopteran active toxin, Bacillus thuringiensis kurstaki strain HD1 delta-endotoxin as produced by a cry1A(b), Bacillus thuringiensis kurstaki strain M-200 protein toxin, Bacillus thuringiensis Morrisoni lepidopteran active toxin, Bacillus thuringiensis San Diego, Bacillus thuringiensis serovar Japonensis strain Buibui, Bacillus thuringiensis Tenebrionis, Bacillus thuringiensis Tenebrionis IR-23 delta endotoxin, Bacillus thuringiensis Tenebrionis delta endotoxin as produced by Cry IIIA gene, Bacillus thuringiensis Tolworthi Cry9C protein, Bacillus thuringiensis VIP3A protein, Chromobacterium spp., Gliocladium spp., Isaria spp., Saccharomyces cerevisiae hydrolysate, Saccharomyces cerevisiae var. Boulardii, Ulocladium spp., and combinations thereof.

In some embodiments, the pesticide may include Bacillus thuringiensis Aizawai strain ABTS-1857, Bacillus thuringiensis Aizawai strain GC-91, Bacillus thuringiensis Aizawai strain NB200, Bacillus thuringiensis Israelensis serotype H-14, Bacillus thuringiensis Israelensis strain AM 65-52, Bacillus thuringiensis Israelensis strain EG2215, Bacillus thuringiensis Israelensis strain SUM-6218, Bacillus thuringiensis kurstaki serotype 3A 3B, Bacillus thuringiensis kurstaki strain ABTS-351, Bacillus thuringiensis kurstaki strain BMP123, Bacillus thuringiensis kurstaki strain EG 2348, Bacillus thuringiensis kurstaki strain EG2371, Bacillus thuringiensis kurstaki strain EG2424, Bacillus thuringiensis kurstaki strain EG7826, Bacillus thuringiensis kurstaki strain EVB 113 19, Bacillus thuringiensis kurstaki strain SA-11, Bacillus thuringiensis kurstaki strain SA-12, and combinations thereof.

In some embodiments, the CEBNP may include iron (II) sulfate, zinc sulfate, butyric acid, mannitol, Trichoderma spp., Saccharomyces spp., Saccharomyces cerevisiae, and combinations thereof.

In some embodiments, the CEBNP may include animal manure, cyanamide, peat, protein hydrolysate, urea, diammonium phosphate, dipotassium phosphate, tripotassium phosphate, phosphonate, seaweed, manure salt, borax, boric acid, copper (II) sulfate, copper oxychloride, potassium silicate, sodium silicate, succinic acid, malic acid, algae, Bacillus spp., Bacillus firmus, Bacillus popilliae, Bacillus sphaericus, Bacillus subtilis, Bacillus thuringiensis, phosphoric acid, azadirachtin, potassium oleate, oleic acid, and combinations thereof.

In some embodiments, the CEBNP may include essence, extract, color, or oil of passionfruit, mango, kiwi, watermelon, tangerine, blueberry, blackberry, cranberry, key lime, melon, cucumber, and combinations thereof. In some embodiments, the CEBNP may include sodium lauroyl glutamate, guarana, green tea, Camellia sinensis, coffee, Coffea arabica, Coffea canephora, ginger, Zingiber officinale, tea tree oil, frankincense oil, aloe vera, Aloe barbadensis, Aloe barbadensis extract, chlorella algae, blue algae, green, algae, blue green algae, sodium cyclamate, spirulina, yerba mate, Ilex paraguariensis, methylcobalamin, amylase enzyme, mannanase enzyme, pectate lyase enzyme, 1-carnitine, keratin, melatonin, luo han guo, monk fruit, Siraitia grosvenorii, rapadura, sucanat, hydroxypropyl methylcellulose, hydroxypropyl cellulose, saccharose palmitate, xylooligosaccharides, fructo-oligosaccharides, galacto-oligosaccharides, trans-galacto-oligosaccharides, cyanocobalamin, Acacia senegal gum, acacia gum, milk, sodium polyitaconate, sodium stearoyl glutamate, trisodium dicarboxymethyl alaninate, phthalimidoperoxycaproic acid, sodium cocoyl alaninate, sodium gluconate, phenylpropyl ethyl methicone, simethicone, trimethylisiloxysilicate, ethylhexyl stearate, lauroyl methyl glucamide, sorbitan caprylate, sodium methyl cocoyl taurate, benzotriazole, avocado oil, keratin, glucose, shilajit powder, avobenzone, homosalate, octinoxate, octisalate, octocrylene, oxybenzone, titanium dioxide, SD alcohol 40-B, cyclopentasiloxane, panthenol, tocopherol, steartrimonium chloride, sodium cumenesulfonate, tetrasodium glutamate diacetate, methyl di-t-butyl hydroxyhydrocinnamate, diethylester dimethyl ammonium chloride, pentasodium pentetate, polyquaternium-33, stannous chloride, isotridecanol ethoxylated, cetrimonium chloride, myristamidopropylamine oxide, dimethyl myristamine, lipase, lactase, sucrase, alpha-galactosidase enzyme, Vitamin A (retinol, beta-carotene), Thiamin (vitamin B1), Riboflavin (vitamin B2), Niacin (vitamin B3, nicotinic acid), Pantothenic Acid (vitamin B5), Vitamin B6 (pyridoxal, pyridoxine, pyridoxamine), Biotin (vitamin B7), Folate (Folic acid, vitamin B9), Vitamin B12 (cyanocobalamin), Vitamin C (ascorbic acid), Choline, Vitamin D (calciferol, cholecalciferol), Vitamin E (alpha-tocopherol, tocopherols), Vitamin K (phylloquinone, menadione), and combinations thereof.

In some embodiments, the CEBNP may include Bifidobacterium spp. In some embodiments, the species of Bifidobacterium spp. may include B. actinocoloniiforme, B. adolescentis Reuter, B. aemilianum Alberoni, B. aerophilum Michelini, B. aesculapii, B. amazonense, B. angulatum, B. animalis, B. anseris, B. apousia, B. apri, B. aquikefiri, B. asteroides, B. avesanii, B. biavatii, B. bifidum, B. bohemicum, B. bombi, B. bourn, B. breve, B. callimiconis, B. callitrichidarum, B. callitrichos, B. canis, B. castoris, B. catenulatum, B. catulorum, B. cebidarum, B. choerinum, B.choladohabitans, B. choloepi, B. colobi, B. commune, B. criceti, B. crudilactis, B.cuniculi, B. dentium, B. dolichotidis, B. eriksonii, B. erythrocebi, B. eulemuris, B. faecale, B. felsineum, B. gallicum, B. gallinarum, B. globosum, B. goeldii, B. hapali, B. lugli, B. indicum, B. italicum, B. jacchi, B. lemurum, B. leontopitheci, B. longum, B. magnum, B. margollesii, B. merycicum, B. miconis, B. miconisargentati, B. minimum, B. mongoliense, B. moraviense, B. moukalabense, B. myosotis, B. oedipodis, B. olomucense, B. panos, B. parmae, B. platyrrhinorum, B. pluvialisilvae, B. polysaccharolyticum, B. pongonis, B. porcinum, B. primatium, B. pseudocatenulatum, B. pseudolongum, B. psychraerophilum, B. pullorum, B. ramosum, B. reuteri, B. rousetti, B. ruminale, B. ruminantium, B. saguini, B. saguinibicoloris, B. saimiriisciurei, B. samirii, B. santillanense, B. scaligerum, B. scardovii, B. simiarum, B. simiiventris, B. stellenboschense, B. subtile, B. thermacidophilum, B. thermophilum corrig., B. tibiigranuli, B. tissieri corrig., B. tsurumiense, B. urinalis, B. vansinderenii, B. vespertilionis, B. xylocopae, and combinations thereof.

In some embodiments, the CEBNP may include hops (Humulus lupulus) or Ginseng (Panax ginseng).

In some embodiments, the CEBNP may include Psilocybin, Psilocin, Psilocybe, Psilocybe cubensis, Psilocybe semilanceata, Psilocybe baeocystis, Psilocybe cyanescens, Psilocybe azurescens, Psilocybe zapotecorum, Psilocybe hispanica, Psilocybe mexicana, Psilocybe bohemica, Panaeolus, Panaeolus subbalteatus, Panaeolus cyanescens, Copelandia, Amanita, Amanita muscaria, Gymnopilus, Pluteus, Inocybe, Pholiotina, Galerina, Cyclocybe, Hygrophorus, norpsilocin, baeocystin, norbaeocystin, aeruginascin, and combinations thereof.

In some embodiments, the CEBNP may include Inonotus, Inonotus obliquus, Cordyceps, Cordyceps militaris, Cordyceps sinensis, Hericium, Hericium erinaceus, Grifola, Grifola frondose, Phellinus, Phellinus linteus, Wolfiporia, Wolfiporia extensa, Ganoderma, Ganoderma lucidum, Lentinula, Lentinula edodes, Tremella, Tremella fuciformis, Trametes, Trametes versicolor, Coriolus, Coriolus versicolor, Ophiocordyceps, Ophiocordyceps sinensis, Pleurotus, Pleurotus ostreatus, Ganoderma, Ganoderma lingzhi, and combinations thereof.

The foregoing description of the preferred embodiments of the present invention has been presented for purposes of illustration and description. It is not intended to be exhaustive or to limit the invention to the precise form or to the exemplary embodiments disclosed. Obviously, many modifications and variations will be apparent to practitioners skilled in this art. Similarly, any process steps described might be interchangeable with other steps in order to achieve the same result. The embodiment was chosen and described in order to best explain the principles of the invention and its best mode practical application, thereby to enable others skilled in the art to understand the invention for various embodiments and with various modifications as are suited to the particular use or implementation contemplated. It is intended that the scope of the invention be defined by the claims appended hereto and their equivalents. Reference to an element in the singular is not intended to mean “one and only one” unless explicitly so stated, but rather means “one or more.” Moreover, no element, component, nor method step in the present disclosure is intended to be dedicated to the public regardless of whether the element, component, or method step is explicitly recited in the following claims. No claim element herein is to be construed under the provisions of 35 U.S.C. Sec. 112, sixth paragraph, unless the element is expressly recited using the phrase “means for”

Furthermore, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way. It is also to be understood that the steps and processes recited in the claims need not be performed in the order presented.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. A composition, comprising:
An acid, at least one selected from the group of potassium bicarbonate, sodium bicarbonate, and combinations thereof, and Humulus lupulus.

13. A composition, comprising:
An acid, at least one selected from the group of potassium bicarbonate, sodium bicarbonate, and combinations thereof, and at least one selected from the group of psilocybin, psilocin, and combinations thereof.

14. A composition, comprising:
An acid, at least one selected from the group of potassium bicarbonate, sodium bicarbonate, and combinations thereof, and at least one selected from the group of Inonotus obliquus, Cordyceps militaris, Cordyceps sinensis, Hericium erinaceus, Grifola frondose, Phellinus linteus, Wolfiporia extensa, Ganoderma lucidum, Lentinula edodes, Tremella fuciformis, Trametes versicolor, Coriolus versicolor, Ophiocordyceps sinensis, Pleurotus ostreatus, Ganoderma lingzhi, and combinations thereof.
